(19) United States
(12) Patent Application Publication
(10) Pub. No.: US 2026/0320489 A1
(43) Pub. Date: Oct. 15, 2026

(54) Systems and Methods for Dynamic Memory Management for Evolving Problem Solving

(71) Applicant: Tucuxi, Inc., Sunnyvale, CA (US)

(72) Inventor: Kevin Eugene KELLER, Sunnyvale, CA (US)

(73) Assignee: Tucuxi, Inc., Sunnyvale, CA (US)

(21) Appl. No.: 19/467,468

(22) Filed: Feb. 2, 2026

Related U.S. Application Data
(60) Provisional application No. 63/752,806, filed on Feb. 2, 2025.

(51) Int. Cl. G06N 20/00

(52) U.S. Cl. CPC G06N 20/00

(57) ABSTRACT

A system is disclosed comprising an artificial intelligence (AI) model that receives a prompt, and is configured with a decision logic executed by a decision-logic runtime to generate a response to the prompt. The decision logic is in a current state represented by a machine-readable state vector. The system comprises an agent configured to generate a stimulant and further configured to apply the stimulant to the decision-logic runtime to transition the decision logic from the current state to a next state. The stimulant comprises: (i) a state-transition directive identifying at least one transition rule of the decision logic, and (ii) a scoring rubric specifying at least one measurable criterion for evaluating alignment of the response with a learning goal. The transition updates the state vector without updating parameters of the AI model. The decision logic in its next state is used to generate the response to the prompt.

### PRIORITY DATA

This application claims the benefit of and priority to U.S. Provisional Patent Application No. 63/752,806, titled “ADAPTIVE COGNITIVE SYSTEM: INTEGRATING EMOTIONAL FEEDBACK, REINFORCEMENT LEARNING, AND DYNAMIC MEMORY MANAGEMENT FOR EVOLVING PROBLEM-SOLVING,” filed on Feb. 2, 2025 (Attorney Docket No. KEEK1000USP01). The priority provisional application is incorporated herein by reference in its entirety and for all purposes as if completely and fully set forth herein.

### FIELD OF THE TECHNOLOGY DISCLOSED

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. Specifically, the technology disclosed relates to dynamic memory management for use in artificial intelligence systems.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Large language model (LLM) based systems and other Artificial Intelligence (AI) assistants increasingly support complex problem solving, decision making, and interactive dialogues across many domains. Users often rely on these systems to produce responses that reflect consistent reasoning across iterations and that incorporate relevant context from prior interactions. However, conventional AI assistants frequently generate responses without preserving an explicit record of the reasoning process that led to the response.

In many deployments, an AI system receives diverse prompt types, including user queries, probing inputs, context adding inputs, and adversarial inputs. These prompts can shift the direction of reasoning during a session or across sessions. Without a persistent representation of decision logic and its evolution, the system can struggle to explain why it generated a particular response, to reconstruct contextual lineage across prior interactions, or to reuse effective strategies when similar prompts reappear. This limitation can also make it difficult to manage stored reasoning information over time, especially when the system must operate under compute and memory constraints.

An opportunity arises to develop systems and methods that improve how an AI system determines, records, and manages information about reasoning processes across prompt response iterations under resource constraints.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 presents an example environment in which a stimulant is applied to transition a decision logic from a current state to a next state for use in generation of a response to a prompt.

FIGS. 2A and 2B present an example process flow for generation of the decision logic in the next state by application of the stimulant to the decision logic in the current state.

FIG. 3 presents an example decision trace data structure that can be generated and updated using the technology disclosed.

FIG. 4 presents an example hierarchical memory architecture and memory management operations provided by the technology disclosed.

FIG. 5 is a schematic representation of an encoder-decoder architecture.

FIG. 6 shows an overview of an attention mechanism added onto a Recurrent Neural Network (RNN) encoder-decoder architecture.

FIG. 7 is a schematic representation of the calculation of self-attention showing one attention head.

FIG. 8 is a depiction of several attention heads in a Transformer block.

FIG. 9 is an illustration that shows how one can use multiple workers to compute the multi-head attention in parallel, as the respective heads compute their outputs independently of one another.

FIG. 10 is a portrayal of one encoder layer of a Transformer network.

FIG. 11 shows a schematic overview of a Transformer model.

FIG. 12 is a depiction of a Vision Transformer (ViT).

FIG. 13 illustrates a processing flow of the Vision Transformer (ViT).

FIG. 14 shows example software code that implements a Transformer block.

FIG. 15 illustrates a comparison between responses generated by a large language model (LLM) when provided with a basic prompt and when provided with a more sophisticated, engineered prompt.

FIG. 16 presents a high-level overview of a Retrieval-Augmented Generation (RAG) workflow.

FIG. 17 presents an overview of artificial intelligence (AI) agents.

FIG. 18 presents an inference hardware structure used to perform inferencing operations in an example artificial intelligence system.

FIG. 19 presents an example schematic of an edge-device inference system.

FIG. 20 presents an example schematic of a data center that can execute inference operations.

FIG. 21 presents an example system architecture diagram illustrating the Model Context Protocol (MCP) architecture.

FIG. 22 presents an example system architecture illustrating Model Context Protocol (MCP) workflow.

FIG. 23 presents an example artificial intelligence (AI) system architecture that integrates multiple technological components to enhance language-model performance.

FIG. 24 illustrates an example configuration of a computing device that can be used to implement the systems and techniques described herein.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

### Indicia of Novelty, Inventiveness, Non-Obviousness, and Subject-Matter Eligibility

Modern Artificial Intelligence (AI) models process prompts and generate responses with impressive fluency. Yet these models leave users blind to the reasoning path that produced the response. An AI model receives inputs ranging from user queries and system generated questions to probing inputs, context adding inputs, and adversarial inputs. The decision logic that governs how the AI model arrives at its output remains hidden within the model's architecture. This opacity creates a specific technical problem rooted in how computing systems process and store information. The system cannot reliably reuse prior reasoning. The system cannot reconstruct contextual lineage. The system cannot control how inputs reshape the decision process over time. As a result, the system repeats mistakes, loses valuable context, and spends compute to rediscover strategies it already used successfully.

Conventional AI memory architectures compound this opacity problem by storing everything and remembering nothing useful. These systems treat all stored information with equal weight regardless of its relevance to learning goals or its association with successful outcomes. They lack mechanisms to distinguish between memories that contributed to effective problem solving and memories that represent irrelevant reasoning patterns. Without differentiation, memory systems accumulate data indiscriminately. They consume computational resources while failing to preserve the specific reasoning strategies that produce high quality outputs.

Existing AI architectures further suffer from static decision logic that does not adapt based on contextual probing or iterative refinement. The decision logic within these systems exists in a fixed state. It processes each prompt without the benefit of structured transitions driven by specialized cognitive perspectives. Without mechanisms to probe the decision logic from distinct reasoning perspectives and transition the decision logic through refined states, AI systems produce responses that lack the depth and reliability that multi-perspective analysis would provide.

The technology disclosed herein addresses these technical deficiencies by treating reasoning as a living structure that the system can identify, update, and store as the system works. The system introduces the technical concept of a stimulant. A stimulant comprises a system generated input object that a stimulant generator creates and applies to select a decision logic from a plurality of decision logics stored in memory. The stimulant generator applies the stimulant to the selected decision logic to transition the decision logic from a current state to a next state. The AI model then uses the decision logic in its next state to generate the response to the prompt. This architecture turns reasoning into an operational mechanism rather than an after the fact narrative.

This approach becomes especially powerful because the system records what it did, not just what it said. A decision trace generator produces a decision trace, implemented as a decision trace data structure, that identifies the strategy adopted by the AI model to generate the response. The decision trace comprises the corresponding state of the decision logic at the time the response was generated. The decision trace further comprises a cognitive strategy vector that identifies the specific strategy applied by the AI model. An emotional inference engine infers an associated emotional state from the stimulant and records this state within the decision trace. This associated emotional state may comprise a positive state, an altered state, a neutral state, or a cautious state. Through the decision trace, the system makes its reasoning process durable, inspectable, and reusable across prompt response iterations.

The decision trace further comprises referenced memory identifiers that identify prior decision traces consulted during generation of the response. These referenced memory identifiers enable reconstruction of contextual lineage. They link the current response to the historical reasoning that informed it. The decision trace additionally comprises a causal chain linking the response to one or more prior decision operations that contributed to generation of the response. This causal chain enables reinforcement of effective early decisions when a positive outcome is delayed.

The multi-agent architecture improves the quality of reasoning updates by engineering the source of stimulants. A plurality of agents includes role-based agents configured to generate role-based stimulants that probe the decision logic from distinct reasoning perspectives. The plurality also includes context-based agents configured to generate context-based stimulants that provide contextual information to the decision logic. An orchestrator agent coordinates the plurality of agents. The orchestrator agent combines stimulants generated by the role-based agents and the context-based agents for application to the decision logic. The plurality of agents iteratively generates stimulants and applies the stimulants to the decision logic until a convergence condition is satisfied. The convergence condition may be based on a resource constraint, an iteration threshold, or a quality metric. This design avoids unbounded recursion by enforcing explicit convergence logic.

The emotional inference engine provides a principled way to tune the stimulant generation process. The emotional inference engine modulates agent behavior through a temperature parameter that adjusts based on the associated emotional state. A higher temperature parameter increases randomness and creativity in generation of the stimulant. A lower temperature parameter enforces coherence in generation of the stimulant. This temperature parameter creates a technical bridge between stimulus generation, reasoning updates, and memory retention policies. Decision traces associated with positive emotional states receive increased storage duration through this integrated mechanism.

The memory module addresses the long term reliability problem through explicit, computer implemented memory management mechanisms. The memory module implements multiple memory tiers that store decision trace data structures with distinct lifecycle rules. A short-term memory stores decision traces from recent interactions. A mid-term memory stores decision traces that have been boosted from the short-term memory based on relevance to a learning goal or association with a positive outcome. A long-term memory stores decision traces that have been boosted from the mid-term memory. Decision traces progress from the short-term memory to the mid-term memory to the long-term memory based on reinforcement. Decision traces not reinforced remain in the short-term memory and undergo decay.

The memory module applies an exponential decay function to decision traces that lack association with positive outcomes. Decision traces not reinforced by positive outcomes are removed from memory over time. Memory reorganization logic groups related decision traces based on emotional and thematic similarity. The memory module amplifies decision traces that share emotional and thematic connections through increased retention weights, thereby reinforcing effective cognitive pathways. Experience replay logic periodically replays decision traces associated with positive outcomes by retrieving and reprocessing stored decision trace data structures. These mechanisms describe concrete memory operations, record lifecycle rules, and tiered storage behavior that a computing system performs to manage context under resource constraints.

The technology disclosed integrates human mentorship to guide cognitive evolution based on expert feedback. The stimulant generator receives input from a human user and generates the stimulant in dependence upon the input from the human user. A user profile builder constructs a dynamic profile of the human user's problem-solving approach based on interactions with the human user. The decision logic adapts based on the dynamic profile to mirror the human user's problem-solving approach.

The technology disclosed enables trust calibration without relying on abstract labels alone. In one implementation, a second AI model generates a second response to the prompt based on a second decision logic. The decision trace generator produces a second decision trace identifying a second strategy adopted by the second AI model. A decision trace comparator compares the decision trace with the second decision trace to determine which of the response and the second response is more trustworthy. This comparative step relies on stored decision traces, associated states, and trace metadata rather than on an ungrounded assertion that one answer feels better than another.

The technology disclosed achieves specific technical improvements to computer-based AI processing. The stimulant generator enables iterative refinement of decision logic by generating stimulants that transition decision logic from a current state to a next state. The decision trace generator creates decision traces that record the cognitive strategy vector, the emotional state, the referenced memory identifiers, and the causal chain for each generated response. The hierarchical memory module stores decision traces in memory tiers and applies decay functions to unreinforced traces while boosting reinforced traces between tiers. The orchestrator agent coordinates the plurality of agents and combines stimulants from role-based agents and context-based agents for application to decision logic.

The system addresses the technical problems of AI opacity, static reasoning, and undifferentiated memory through specific technical solutions. The integration of the stimulant generator, the decision trace generator, the hierarchical memory module, the orchestrator agent, and the emotional inference engine creates a self-improving cognitive architecture. Each component performs defined computational operations on specific data structures with explicit state transitions and lifecycle rules. The claimed inventions provide novel, non-obvious, and technically grounded improvements to the functioning of AI systems. They deliver traceable reasoning, controlled iteration, and memory that retains what matters and discards what does not.

### System Overview

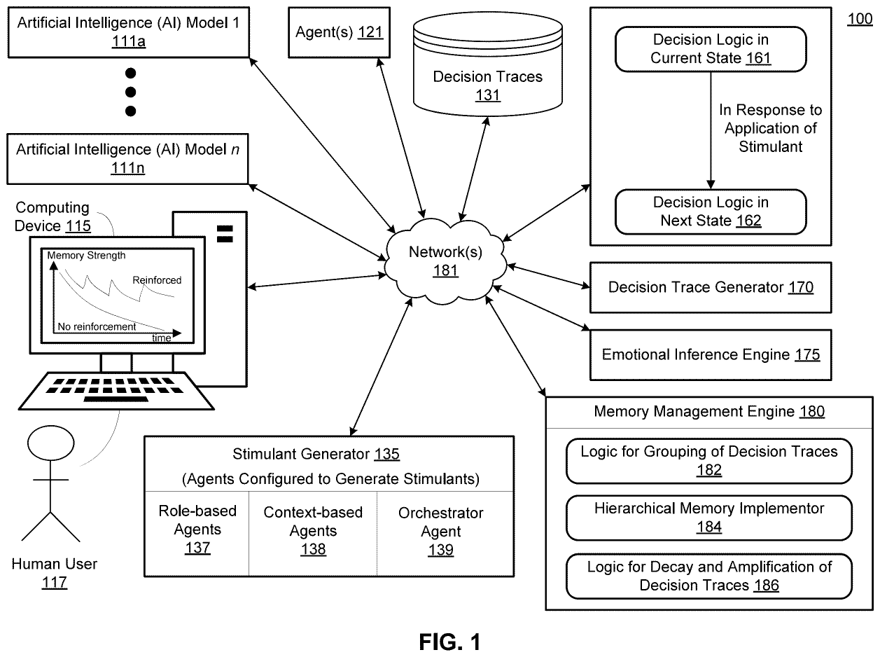

Various implementations of the technology disclosed are presented with reference to FIGS. 1 to 24. FIG. 1 presents an example high-level schematic of a system in accordance with an implementation. Because FIG. 1 is an architectural diagram, certain details are intentionally omitted to improve the clarity of the description. The discussion of FIG. 1 is organized as follows. First, the elements of the figure will be described, followed by their interconnections. Then, the use of the elements in the system will be described in greater detail.

FIG. 1 includes a plurality of Artificial Intelligence (AI) models. The AI models can comprise AI Model 1 (111a) through AI Model n (111n). Examples of AI models that can be used with the technology disclosed include, without limitation, Claude for AI-assisted content creation, ChatGPT for conversational AI, Cursor for AI-powered integrated development and code completion, and other LLM-based systems configured for task-specific or general purpose applications. Each AI model receives a prompt and generates a response to the prompt based on a decision logic. The prompt can comprise one or more of a user query, a system-generated query. Prompts can also include additional information such as context regarding the query. In one implementation, the system 100 can include multiple AI models to enable comparison of responses generated by different AI models. It is understood that the AI models illustrated in FIG. 1 do not represent a comprehensive list of AI models supported by the technology disclosed. The AI models connect to a network(s) 181 to communicate with other components of the system 100.

FIG. 1 includes a human user 117 who interacts with the system 100 through a computing device 115. The human user 117 provides input to the system 100 and receives responses generated by the AI models. The system 100 can receive input from the human user 117 and generate stimulants in dependence upon the input from the human user. The system 100 can build a dynamic profile of the human user's problem-solving approach based on interactions with the human user 117. The decision logic can adapt based on the dynamic profile to mirror the human user's problem-solving approach. The computing device 115 comprises a user interface that displays a visualization of memory strength over time, illustrating how reinforced decision traces maintain memory strength while decision traces without reinforcement undergo decay. This visualization corresponds to the memory management functions performed by the memory management engine 180.

In one implementation, the system builds the dynamic profile by tracking reinforcement patterns across prompt-response iterations with the human user. The system identifies features of decision traces that are associated with positive feedback from the human user, including preferred cognitive strategies recorded in cognitive strategy vectors, preferred stimulant types generated by the role-based agents, and preferred analytical frameworks reflected in the decision logic states. The system constructs the dynamic profile as a weighted representation of these features, wherein features associated with more frequent or more recent positive feedback receive higher weights. The system adapts the decision logic based on the dynamic profile by weighting stimulant generation toward cognitive strategies and analytical approaches that align with the higher-weighted features in the dynamic profile. The dynamic profile is updated in response to new interactions with the human user, and feature weights are adjusted based on subsequent positive or negative feedback.

FIG. 1 illustrates the decision logic state transition mechanism disclosed by the technology disclosed. The decision logic exists in a current state 161 before receiving a stimulant. In response to application of a stimulant, the decision logic transitions from the current state 161 to a next state 162. The AI model uses the decision logic in its next state 162 to generate the response to the prompt. A state of the decision logic can comprise one or more of a rule, a condition, or a causal path identifying a reason the response was generated by the AI model. A state of the decision logic can comprise information identifying how the AI model generated the response, including one or more reasoning approaches applied by the AI model. Conditions can identify success or failure criteria and rules can be used to evaluate these conditions to determine success or failure. A state of a decision logic identifies how an AI model (such as an LLM) arrives at a specific conclusion, action, or output. The technology disclosed provides as evolving (or living) decision logic that evolves over time as it changes its current state to a next state. The evolution of the decision logic continues in response to receipt of stimulants from agents.

FIG. 1 illustrates one or more agents 121 that are configured with logic to generate a stimulant. Agents 121 are further configured to apply the stimulant to the decision logic to transition the decision logic from the current state to a next state. As used herein, an agent (also referred to as a cognitive agent) refers to a component or module configured with logic to generate stimulants for application to the decision logic. Each agent can operate with specialized reasoning capabilities and can be configured to probe the decision logic from a distinct perspective or to provide contextual information to the decision logic. Agents can be implemented using one or more machine learning or AI models. As used herein, a “stimulant” refers to an input that causes a transition in decision logic from a current state to a next state. A stimulant may include, but is not limited to a probing input, context-adding input, an adversarial input, a clarifying input, an emotional signal or an emotional input, or other inputs that modify the decision logic.

Agents can comprise role-based agents and context-based agents. Role-based agents are configured to perform a distinct cognitive function or role, such as decision-making, pattern recognition, strategic planning, practical assessment, risk evaluation, or ethical oversight. Role-based agents can generate role-based stimulant. Role-based stimulants refers to stimulants that are generated according to a specific role or purpose, including probing stimulants, context-adding stimulants, adversarial stimulants, and clarifying stimulants. For example, a prudence agent can generate stimulants that probe risk and/or safety related aspects. An oracle agent can generate stimulants that probe from strategic aspects. A seer agent can generate stimulants that probe from pattern recognition aspect. A conscience agent can generate stimulants related to ethical boundaries. A house agent can generate stimulants that are related to practical and feasibility related aspects. A cortex agent can generate stimulants that are related to integration aspect. It is understood that the above examples of role-based agents are provided for illustrative purposes and the technology disclosed can comprise hundreds of different types of role-based agents that generate stimulants based on their respective roles. Context-based agents are configured to generate context-based stimulants to provide contextual information to the decision logic. The contextual information can comprise background information, clarifying details, or relevant prior knowledge. Context-based stimulant or context-adding stimulant refers to a stimulant configured to provide additional contextual information to the decision logic, such as background information, clarifying details, or relevant prior knowledge.

The technology disclosed comprises a stimulant generator 135 that generates stimulants for application to the decision logic. A stimulant is a system-generated input that an agent creates and applies to the decision logic to transition the decision logic from a current state to a next state. The stimulant generator 135 can generate stimulants in dependence upon the prompt and in dependence upon one or more prior decision traces retrieved from memory. The stimulant generator 135 comprises a plurality of agents configured to generate stimulants. The plurality of agents includes role-based agents 137 configured to generate role-based stimulants that probe the decision logic from distinct reasoning perspectives. The plurality of agents also includes context-based agents 138 configured to generate context-based stimulants that provide contextual information to the decision logic. An orchestrator agent 139 coordinates the plurality of agents and combines stimulants generated by the role-based agents 137 and the context-based agents 138 for application to the decision logic. In one implementation, the stimulant generator 135 can be implemented as a component within the agents 121. The agents 121 can comprise the stimulant generator 135 and the individual role-based agents 137, context-based agents 138, and orchestrator agent 139 that operate within the stimulant generator 135.

The plurality of agents can iteratively generate stimulants and apply the stimulants to the decision logic until a convergence condition is satisfied. The convergence condition can be based on one or more of a resource constraint, an iteration threshold, or a quality metric.

The quality metric can measure one or more attributes of the decision logic state or the stimulants generated by the plurality of agents. In one implementation, the quality metric measures response coherence, indicating whether the decision logic in its evolving state produces internally consistent rules, conditions, and causal paths. In one implementation, the quality metric measures topic coverage, indicating whether the stimulants generated by the plurality of agents have addressed a threshold proportion of identified aspects of the prompt. For example, if the prompt involves analysis of a contract clause, the quality metric can measure whether the stimulants have addressed risk assessment, regulatory considerations, and strategic alternatives. In one implementation, the quality metric measures consistency across stimulants, indicating whether the stimulants generated by different agents in the plurality of agents produce convergent rather than contradictory modifications to the decision logic. The convergence condition is satisfied when the quality metric meets or exceeds a predetermined threshold.

In one implementation, the system monitors performance of each agent in the plurality of agents across multiple prompt-response iterations and computes an agent performance score for each agent based on outcomes associated with stimulants generated by the agent. The system dynamically adjusts an influence weight of each agent based on the agent performance score. The influence weight modulates a contribution of the agent to stimulant generation in subsequent prompt-response iterations. For example, an agent whose stimulants consistently contribute to decision traces associated with positive outcomes receives a higher influence weight, increasing that agent's contribution to combined stimulants generated by the orchestrator agent 139. An agent whose stimulants are associated with less favorable outcomes receives a lower influence weight, reducing that agent's contribution in subsequent iterations.

The technology disclosed comprises a decision trace generator 170 that generates decision traces identifying strategies adopted by the AI model to generate responses. A decision trace comprises the corresponding state of the decision logic at the time the response was generated. The decision trace can further comprise a cognitive strategy vector identifying the strategy applied by the AI model. The decision trace can comprise one or more referenced memory identifiers identifying prior decision traces consulted during generation of the response. These referenced memory identifiers enable reconstruction of contextual lineage. They link the current response to the historical reasoning records that informed it.

The system 100 retrieves prior decision traces from memory and uses them as context when generating responses to new prompts. When a new prompt is similar to a prior prompt, the technology disclosed is configured with logic to identify the prior decision trace and determine, using the decision trace, how the AI model arrived at the prior decision. The system can add the prior decision trace as additional context while reasoning through the new prompt. The stimulant generator 135 can generate stimulants in dependence upon one or more prior decision traces retrieved from memory. The decision trace can further comprise a causal chain linking the response to one or more prior decision operations that contributed to generation of the response. This causal chain enables reinforcement of effective early decisions when a positive outcome is delayed.

The technology disclosed comprises an emotional inference engine 175 that infers an associated emotional state from the stimulant. The associated emotional state can comprise at least one of a positive state, an altered state, a neutral state, or a cautious state. The emotional inference engine 175 modulates the behavior of the agents through a temperature parameter that adjusts based on the associated emotional state. A higher temperature parameter increases randomness and creativity in generation of the stimulant. A lower temperature parameter enforces coherence in generation of the stimulant. In one implementation, a lower temperature parameter reduces randomness by constraining the agent to generate stimulants based on higher-probability outputs, while a higher temperature parameter increases randomness by broadening the distribution of stimulant outputs to include lower-probability associations. The emotional inference engine 175 records the associated emotional state within the decision trace generated by the decision trace generator 170.

FIG. 1 includes a decision traces database 131 that stores decision traces generated by the decision trace generator 170. The system 100 can retrieve prior decision traces from the decision traces database 131 for use in generating stimulants and responses to new prompts. The decision traces database 131 enables the system 100 to make its reasoning process durable, inspectable, and reusable across prompt response iterations.

The technology disclosed comprises a memory management engine 180 that manages retention and organization of decision traces stored in the decision traces database 131. The memory management engine 180 comprises a logic for grouping of decision traces 182 that reorganizes decision traces stored in memory by grouping related decision traces based on emotional and thematic similarity. The memory management Engine 180 further comprises a hierarchical memory implementor 184 that stores decision traces in a plurality of memory tiers. The plurality of memory tiers comprises a short-term memory storing decision traces from recent interactions, a mid-term memory storing decision traces that have been boosted from the short-term memory based on relevance to a learning goal or association with a positive outcome, and a long-term memory storing decision traces that have been boosted from the mid-term memory. Decision traces progress from the short-term memory to the mid-term memory to the long-term memory based on reinforcement. Decision traces not reinforced remain in the short-term memory and are subject to decay.

The memory management engine 180 further comprises a logic for decay and amplification of decision Traces 186. The logic for decay and amplification 186 applies an exponential decay function to decision traces that are not associated with a positive outcome. Decision traces not reinforced by positive outcomes are removed from memory over time. The logic for decay and amplification 186 amplifies decision traces that share emotional and thematic connections through increased retention weights, thereby reinforcing effective cognitive pathways. The logic for decay and amplification 186 can increase storage duration for decision traces that comprise a positive associated emotional state. The logic for decay and amplification 186 can periodically replay decision traces associated with positive outcomes, thereby strengthening cognitive pathways associated with the replayed decision traces.

Completing the description of FIG. 1, the components, engines, AI models, and databases described above are all coupled in communication with the network 181. The actual communication path can be point-to-point over public and private networks. The communications can occur over a variety of networks such as private networks, VPN, MPLS circuit, or Internet, and can use appropriate application programming interfaces (APIs) and data interchange formats such as Representational State Transfer (REST), JavaScript Object Notation (JSON), Extensible Markup Language (XML), Simple Object Access Protocol (SOAP), Java Message Service (JMS), and Java Platform Module System. All of the communications can be encrypted. The communication is generally over a network such as LAN (local area network), WAN (wide area network), telephone network (Public Switched Telephone Network (PSTN), Session Initiation Protocol (SIP)), wireless network, point-to-point network, star network, token ring network, hub network, or Internet, inclusive of the mobile Internet, via protocols such as EDGE, 3G, 4G LTE, Wi-Fi, and WiMAX. The engines or system components of FIG. 1 are implemented by software running on varying types of computing devices. Example devices are a workstation, a server, a computing cluster, a blade server, and a server farm. Additionally, a variety of authorization and authentication techniques such as username and password, Open Authorization (OAuth), Kerberos, SecurID, digital certificates, and more can be used to secure the communications.

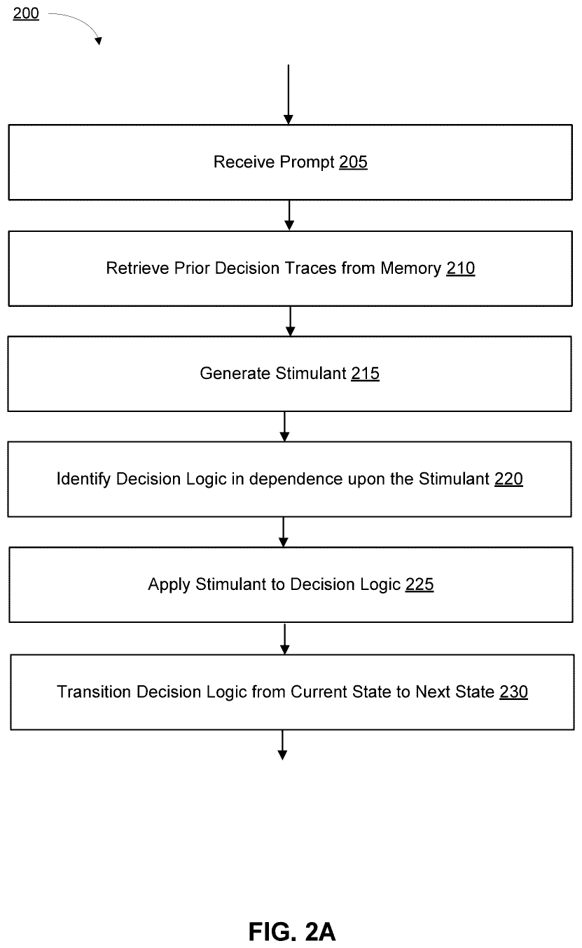

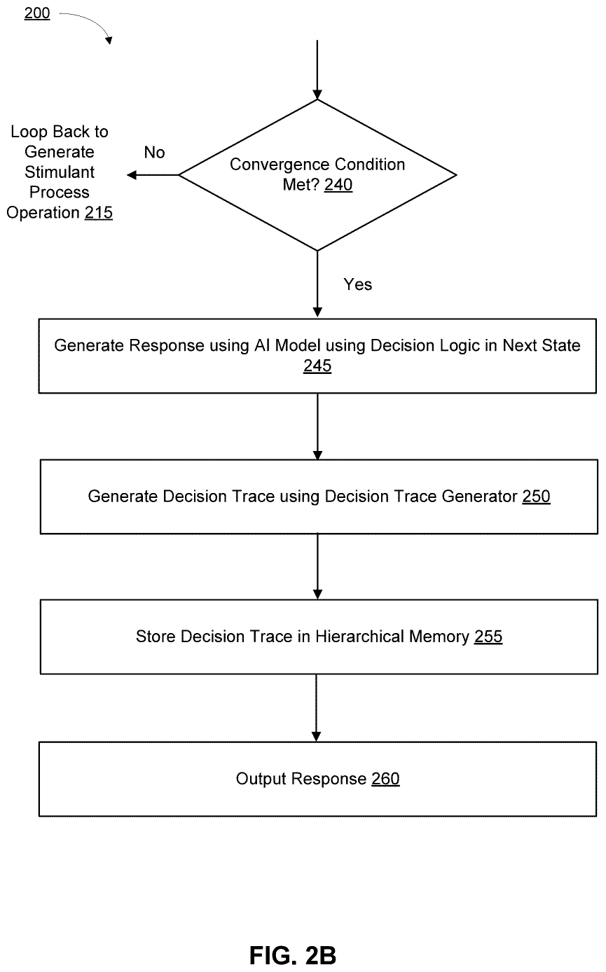

FIGS. 2A and 2B present a process flowchart that illustrates the operations performed by the system disclosed in FIG. 1 to transition decision logic from a current state to a next state.

Process Flow for Transitioning Decision Logic from Current State to Next State

FIGS. 2A and 2B present process flowcharts illustrating an example method implemented by the technology disclosed. As with all flowcharts (of process flow diagrams) herein, it will be appreciated that many of the operations, presented in the flowcharts, can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the flowcharts herein show only operations that are pertinent to an understanding of the technology, and it will be understood that numerous additional operations for accomplishing other functions can be performed before, after and between those shown.

FIGS. 2A and 2B present an example flowchart 200 illustrating process operations for transitioning decision logic from a current state to a next state and generating corresponding decision traces. The process starts at an operation 205 with receiving a prompt at an artificial intelligence (AI) model. The prompt can comprise one or more of a user query, a system-generated query, etc.

The process includes retrieving prior decision traces from memory (operation 210). A prior decision trace identifies a strategy adopted by the AI model to generate a response in a prior prompt-response iteration. The prior decision trace further comprises a corresponding state of the decision logic at the time the prior response was generated.

The process includes generating a stimulant (operation 215). An agent can generate the stimulant. The agent can generate the stimulant in dependence upon the prompt received at operation 205 and in dependence upon one or more prior decision traces retrieved at operation 210. The agent can be selected from a plurality of agents including one or more role-based agents configured to generate role-based stimulants that probe the decision logic from distinct reasoning perspectives, and one or more context-based agents configured to generate context-based stimulants that provide contextual information to the decision logic. The selected agent can individually or by working with other agents can select a reasoning approach (or strategy) apply it systematically to probe.

The process includes identifying a decision logic in dependence upon the stimulant (operation 220). In one implementation, the technology disclosed uses the stimulant to identify a decision logic in a plurality of decision logics stored in memory. Each decision logic in the plurality of decision logics can have a respective associated state. A state of the decision logic can comprise one or more of a rule, a condition, or a causal path identifying a reason a response was generated by the AI model.

The process includes applying the stimulant to the decision logic (operation 225). The agent applies the stimulant to the identified decision logic to modify the decision logic.

The process includes transitioning the decision logic from a current state to a next state (operation 230). In response to application of the stimulant at operation 225, the decision logic transitions from the current state to the next state.

Referring now to FIG. 2B, which continues the process of FIG. 2A, the process proceeds from operation 230 to a convergence evaluation. The process includes determining whether a convergence condition is met (operation 240). The convergence condition can be based on one or more of a resource constraint, an iteration threshold, or a quality metric. If the convergence condition is not met, the process loops back to operation 215 to generate another stimulant. If the convergence condition is met, the process in flowchart 200 proceeds to operation 245.

The process includes generating a response using the AI model using the decision logic in its next state (operation 245). The AI model applies the decision logic in its next state to the prompt to generate the response.

The process includes generating a decision trace using a decision trace generator (operation 250). The decision trace identifies a strategy adopted by the AI model to generate the response. The decision trace comprises the next state of the decision logic. The decision trace can further comprise a cognitive strategy vector identifying the strategy applied by the AI model to generate the response. The decision trace can also comprise one or more referenced memory identifiers identifying prior decision traces consulted during generation of the response, enabling reconstruction of contextual lineage. The decision trace can further comprise a causal chain linking the response to one or more prior decision operations that contributed to generation of the response.

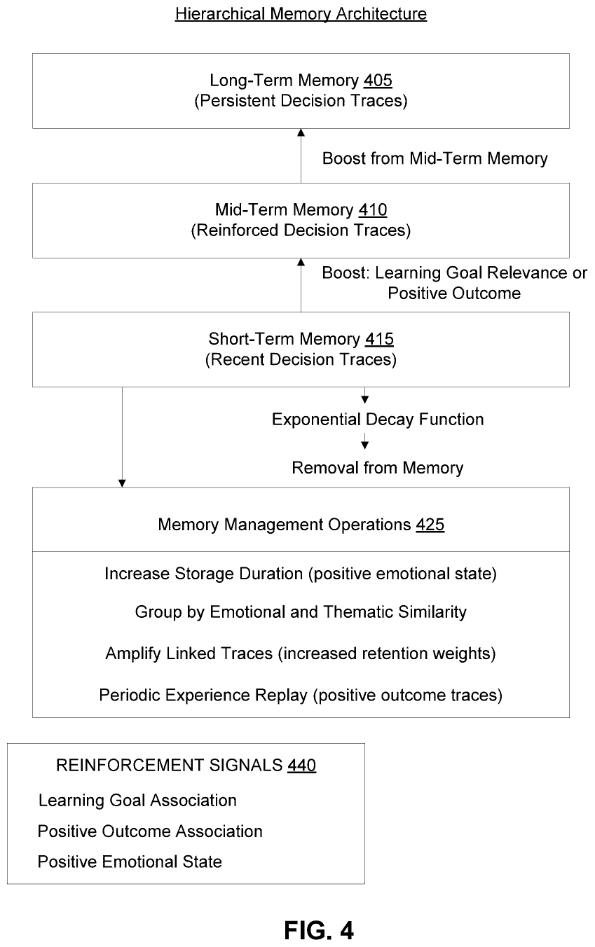

The process includes storing the decision trace in hierarchical memory (operation 255). The hierarchical memory stores decision traces in a plurality of memory tiers. Further details of the hierarchical memory are presented with reference to FIG. 4.

The process includes outputting the response (operation 260). The response is provided to the human user or to another system component that initiated the prompt.

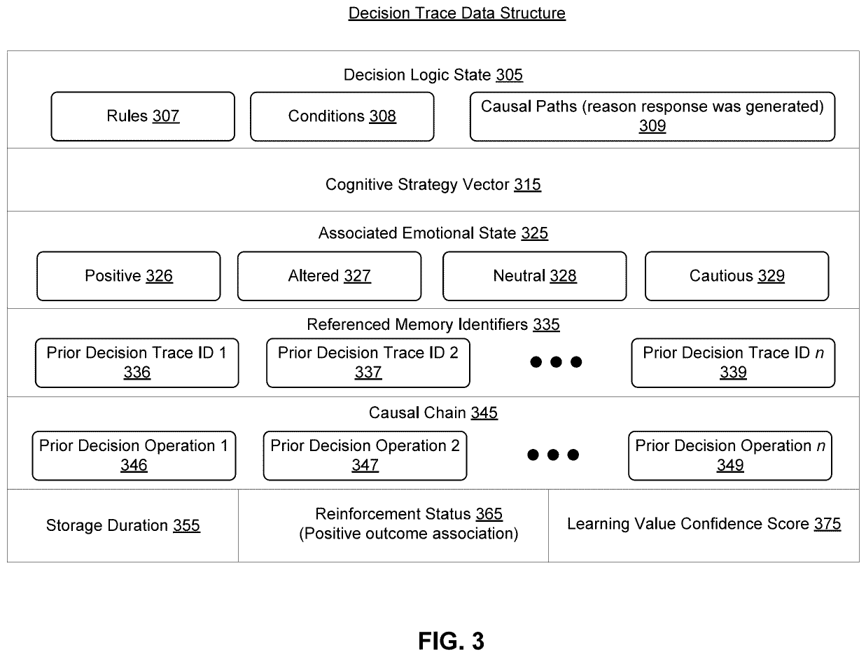

FIG. 3 presents an example data structure diagram illustrating the components of a decision trace generated at operation 250.

### Decision Trace Data Structure

FIG. 3 presents an example data structure diagram illustrating the components of a decision trace. The decision trace data structure comprises the following parts. A decision logic state 305 records the state of the decision logic at the time the AI model generated the response. A cognitive strategy vector 315 identifies the strategy applied by the AI model to generate the response. An associated emotional state 325 records the emotional state inferred from the stimulant. Referenced memory identifiers 335 identify prior decision traces associated with generation of the response. A causal chain 345 links the response to prior decision operations that contributed to generation of the response. A storage duration 355 specifies a retention period for the decision trace. A reinforcement status 365 indicates whether the decision trace is associated with a positive outcome. A learning value confidence score 375 identifies whether the decision trace comprises a positive associated learning value or a negative associated learning value. The confidence score value can be used to increase or decrease the storage duration for the decision trace. In some implementations, the decision trace can further comprise one or more additional fields for data values such as an intent classification, a temporal confidence score, a superseded status, annotations, a ground truth designation, contextual applicability metadata, and outcome data. These data values in these fields provide governance metadata that controls reuse, lifecycle management, and quality monitoring of the decision trace during subsequent prompt-response iterations.

The decision logic state 305 records the state of the decision logic at the time the AI model generated the response. The decision logic state 305 can comprise one or more of rules 307, conditions 308, or causal paths 309. Rules 307 represent decision-making principles that the AI model applied to generate the response. For example, a rule might specify that the AI model should recommend a particular approach when certain criteria are satisfied. Conditions 308 represent logical predicates that the AI model evaluated to generate the response. For example, a condition might evaluate whether a user has previously expressed a preference for a particular type of output. Causal paths 309 identify reasons the response was generated by the AI model. For example, a causal path might indicate that the AI model recommended a particular solution because prior decision traces indicated successful outcomes when similar solutions were recommended in comparable situations.

The cognitive strategy vector 315 identifies the strategy applied by the AI model to generate the response. The cognitive strategy vector 315 can represent one or more reasoning approaches that the AI model applied. For example, the cognitive strategy vector 315 might indicate that the AI model applied deductive reasoning to derive a conclusion from established premises. Another example strategy might involve analogical reasoning where the AI model identified similarities between the current problem and prior problems recorded in decision traces. The cognitive strategy vector 315 can also indicate other reasoning approaches such as inductive reasoning or exploratory analysis. By recording the cognitive strategy in the decision trace, the system enables reconstruction of how the AI model approached the problem and enables future prompts to leverage successful strategies.

In one implementation, the cognitive strategy vector 315 comprises a machine-readable representation of a selected cognitive strategy, including a one-hot or multi-hot encoding over a strategy taxonomy, weighted strategy scores, or a learned dense vector generated from logged decision operations, decision trace fields, or internal model signals. In some implementations, the cognitive strategy vector 315 is stored as a numeric array and is usable to compare strategy selections across prompt-response iterations.

The associated emotional state 325 records the emotional state inferred from the stimulant. The associated emotional state 325 can comprise at least one of a positive state 326, an altered state 327, a neutral state 328, or a cautious state 329. A positive state 326 indicates that the stimulant reflected favorable feedback or a successful outcome. For example, a positive state 326 might be inferred when a human user provides affirming feedback after working through a problem with the system. An altered state 327 indicates that the stimulant reflected a non-default operational mode. For example, an altered state 327 might be inferred during brainstorming sessions where the system operates with increased randomness and free association. A neutral state 328 indicates that the stimulant reflected a standard query without strong emotional signals. A cautious state 329 indicates that the stimulant reflected risk-averse or boundary-enforcing considerations. For example, a cautious state 329 might be inferred when the prompt involves decisions requiring careful assessment.

In one implementation, the associated emotional state 325 further comprises an intensity value indicating the strength of the emotional state. The associated emotional state 325 can also comprise a context summary providing a textual description of the context in which the emotional state was inferred. The associated emotional state 325 can be used to influence processing parameters for future responses.

The referenced memory identifiers 335 identify prior decision traces associated with generation of the response. The referenced memory identifiers 335 can comprise one or more prior decision trace identifiers such as prior decision trace ID 1 (336), prior decision trace ID 2 (337), through prior decision trace ID n (339). Each referenced memory identifier points to a prior decision trace stored in memory. The prior decision traces can include traces that were retrieved, ranked, linked, or otherwise used for contextual lineage during response generation. For example, if the AI model referenced a prior decision trace about problem-solving strategies when generating a response about a similar problem, the referenced memory identifiers 335 would include the identifier of that prior decision trace. The referenced memory identifiers 335 enable reconstruction of contextual lineage by linking the current decision trace to the historical reasoning records associated with it.

The causal chain 345 links the response to one or more prior decision operations that contributed to generation of the response. The causal chain 345 can comprise one or more prior decision operations such as prior decision operation 1 (346), prior decision operation 2 (347), through prior decision operation n (349). Each prior decision operation represents an intermediate reasoning step that contributed to the final response. For example, if the AI model first identified relevant criteria, then analyzed the input against those criteria, and then generated a recommendation, each of these steps would be recorded as a prior decision operation in the causal chain 345. The causal chain 345 enables reinforcement of effective early decisions when a positive outcome is delayed. For example, if a user provides positive feedback on a final recommendation, the system can use the causal chain 345 to identify and reinforce the earlier decision operations that contributed to that successful outcome.

The storage duration 355 specifies a retention period for the decision trace. The storage duration 355 can be increased when the decision trace comprises a positive associated emotional state. For example, a decision trace associated with a positive state 326 might receive an extended storage duration 355 to ensure that successful reasoning patterns remain available for future reference. Conversely, decision traces not associated with positive outcomes may receive shorter storage durations and become subject to decay over time. The storage duration 355 enables the system to prioritize retention of decision traces that have demonstrated value in prior interactions.

The reinforcement status 365 indicates whether the decision trace is associated with a positive outcome. The reinforcement status 365 can record a positive outcome association when the response generated using the decision logic received favorable feedback or achieved an observed result. The associated emotional state 325 is an inferred signal based on the stimulant, while the reinforcement status 365 can be based on explicit feedback or observed results. These two fields may correlate but need not match in all cases. For example, a reinforcement status 365 might indicate a positive outcome association when a human user affirms the quality of the response or when the response achieves a desired result. Decision traces with a positive reinforcement status 365 are candidates for promotion from short-term memory to longer-term memory. Decision traces without a positive reinforcement status 365 may remain subject to a decay function and may be removed from memory over time. By tracking reinforcement status 365, the system can selectively retain decision traces that reflect effective reasoning patterns.

The learning value confidence score 375 identifies whether to increase (positive confidence score) or decrease (negative confidence score) the storage duration for the decision trace. The technology disclosed can use the learning value confidence score in isolation or in combination with other signals to adjust the decay or permanence of a decision trace. For example, a single agent or a group of agents working together can use learning value confidence score with or in lieu of inferred emotional signal. In one implementation, the inference of emotion can be derived from a stimulus such as, “how do you think a human would if they realize that their learning is misaligned with their learning goals”. Such an input can be used to build an emotional inference signal to adjust decay and permanence of decision traces. The system can use knowledge and/or learning gap to generate inferred emotion at hitting and/or missing goals to adjust decay and permanence of decision traces.

In some implementations, the decision trace further comprises governance metadata that controls reuse, lifecycle management, and quality monitoring of the decision trace during subsequent prompt-response iterations. The governance metadata can be stored as fields within the decision trace or can be stored in association with the decision trace in memory. The governance metadata can comprise one or more of an intent classification, a temporal confidence score, a superseded status, annotations, a ground truth designation, contextual applicability metadata, and outcome data. The system can use the governance metadata during retrieval to filter, weight, or qualify decision traces before the decision traces are used in stimulant generation or response generation. The following paragraphs describe each governance metadata field.

In one implementation, the decision trace comprises an intent classification indicating a reuse scope for the decision trace. The intent classification specifies how the reasoning recorded in the decision trace is intended to be applied in subsequent prompt-response iterations. The intent classification can comprise one or more of the following classification types. An illustrative classification indicates the decision trace represents example reasoning not intended as binding precedent, such as a tutorial walkthrough or a demonstration of a particular analytical approach. A matter-specific classification indicates the decision trace is limited to a particular transaction, context, or set of circumstances, such as reasoning tied to a specific contract, client engagement, or regulatory filing. A preferred-approach classification indicates the decision trace represents an organizational or user default reasoning pattern, such as a standard analytical framework that the human user has validated through repeated positive feedback. A provisional classification indicates the decision trace represents experimental reasoning subject to subsequent validation, such as reasoning applied in a novel context where the system has not yet received feedback on effectiveness. A deprecated classification indicates the decision trace represents formerly valid reasoning that is no longer applicable, such as reasoning based on a regulatory requirement that has since been amended or a client preference that has changed. The system can assign the intent classification based on input from a human user, an administrative policy, an automated rule, outcomes associated with prior uses of the decision trace, or a combination of these inputs.

In one implementation, the decision trace comprises a temporal confidence score that degrades based on elapsed time since the decision trace was generated. The temporal confidence score is distinct from the storage duration 355. The storage duration 355 controls whether a decision trace is retained in or removed from memory. The temporal confidence score modulates a weight given to the decision trace when the decision trace is retrieved for use in subsequent prompt-response iterations. A decision trace with a high temporal confidence score receives greater weight during stimulant generation and response generation than a decision trace with a low temporal confidence score. The temporal confidence score can degrade over time according to a degradation function, such as a linear degradation function, an exponential degradation function, or a step function that reduces the score at defined time intervals. The rate of degradation can be domain-specific, wherein decision traces in rapidly evolving domains degrade faster than decision traces in stable domains.

In one implementation, the system computes the temporal confidence score based on one or more of the following factors. A first factor is elapsed time since the decision trace was generated. A second factor is elapsed time since the decision trace was last validated. The validation can be performed by one or more of a human user through explicit feedback, an AI model through automated evaluation, or an automated validation system through programmatic assessment. A third factor is frequency of reuse of the decision trace in subsequent prompt-response iterations. Decision traces that are reused more frequently can receive higher temporal confidence scores. A fourth factor is consistency between outcomes when the decision trace is consulted and outcomes when the decision trace is not consulted. Consistent positive outcomes maintain the score. Inconsistent outcomes reduce the score. A fifth factor is a domain-specific decay rate associated with a category of the decision trace. For example, decision traces in regulatory domains where rules change frequently can have a higher decay rate. Decision traces in foundational analytical domains can have a lower decay rate. In one implementation, the system stores an age of the decision trace as elapsed time since generation and uses the age to compute or update the temporal confidence score.

In one implementation, the decision trace comprises a status field indicating whether the decision trace has been superseded by a subsequent decision trace. The decision trace further comprises a supersession reference that identifies the superseding decision trace. When the system receives input indicating that reasoning in a first decision trace is superseded by reasoning in a second decision trace, the system marks the first decision trace with a superseded status and stores a reference to the second decision trace within the first decision trace. The input can be provided by a human user, by the AI model, or by an automated system (such as an external system) that detects changes in underlying conditions such as updated regulations or revised organizational policies. The superseded status and supersession reference establish a link between formerly valid reasoning and its replacement, enabling reconstruction of reasoning evolution over time.

In one implementation, the decision trace comprises one or more annotations indicating disagreement with, limitation of, or qualification of reasoning recorded in the decision trace. An annotation can be provided by one or more of a human user, an AI model, or an automated system such as a compliance monitoring system or a regulatory update service. The system stores each annotation in association with the decision trace, including an identifier of the source of the annotation and a timestamp indicating when the annotation was created. For example, a human user can annotate a decision trace with a notation that a particular regulatory interpretation has been revised since the decision trace was generated, or an automated system can annotate a decision trace when it detects that an underlying data source has been updated.

In one implementation, the decision trace comprises a ground truth designation. The ground truth designation indicates that the reasoning in the decision trace has been validated as authoritative and should be treated as a reference standard for subsequent prompt-response iterations. The system applies the ground truth designation in response to input from a human user designating the decision trace as ground truth. For example, a human user can designate a decision trace as ground truth because it reflects an authoritative interpretation of a regulatory requirement, a validated organizational policy, or a reasoning pattern that has been confirmed through external verification.

In one implementation, the decision trace comprises contextual applicability metadata specifying the contexts in which the decision trace is applicable. The contextual applicability metadata can comprise one or more of the following fields. A first field is a client identifier or client category. The client identifier or client category identifies one or more clients or client types for which the decision trace is applicable. A second field is a regulatory regime or jurisdiction. The regulatory regime or jurisdiction identifies one or more legal or regulatory frameworks under which the reasoning in the decision trace is valid. A third field is a temporal validity window. The temporal validity window specifies start and end dates during which the decision trace is applicable. For example, the temporal validity window can correspond to a regulatory period or a contract term. A fourth field is a transaction type or deal category. The transaction type or deal category identifies one or more types of transactions for which the decision trace is applicable. A fifth field is an exclusion list. The exclusion list specifies one or more contexts in which the decision trace should not be applied. For example, the exclusion list can specify jurisdictions where the reasoning does not apply or client categories with different requirements.

In one implementation, the system stores outcome data in association with the decision trace. The outcome data can comprise one or more of the following fields. A first field is an outcome classification indicating success, failure, or partial success of the response generated using the decision trace. A second field is an outcome timestamp recording when the outcome was observed. A third field is contextual metadata describing the circumstances of the outcome. For example, the contextual metadata can describe the domain, client, or transaction type associated with the response. A fourth field is a downstream consequence identifier linking the outcome to a subsequent event. For example, the downstream consequence identifier can link a contract recommendation to the resulting contract terms. The downstream consequence identifier can also link a risk assessment to the actual risk outcome. The system appends outcome data to the decision trace each time the decision trace is used in generation of a response. The system can aggregate outcome data across multiple instances in which the decision trace was applied. The system can compute an outcome-weighted value score for the decision trace based on the aggregated outcome data. The outcome-weighted value score reflects the overall effectiveness of the reasoning recorded in the decision trace across multiple applications.

In one implementation, the system can store the decision trace in an associative memory as a structured record of a past interaction. The associative memory can store a key experience together with the associated emotional state 325 and the cognitive strategy vector 315 that the system used to generate the response. This bundled storage can preserve both what happened and how the system approached the prompt. The bundled storage can support later reuse and inspection of the reasoning process.

In one implementation, the system can manage retention of the decision trace by applying memory decay to unreinforced traces and by slowing decay when emotional reinforcement indicates success. The system can apply a decay function and update the storage duration 355 and reinforcement status 365 in the decision trace so that the memory subsystem can preferentially retain traces that the system associates with positive outcomes or emotionally reinforcing feedback. In one implementation, the system can further refine stored decision traces during consolidation operations by reorganizing stored traces and grouping related traces by thematic or emotional similarity. FIG. 4 provides additional detail regarding the hierarchical memory architecture and memory lifecycle operations.

FIG. 4 presents an example diagram illustrating the hierarchical memory architecture that stores decision traces generated by the decision trace generator.

### Hierarchical Memory Management

FIG. 4 presents an example diagram illustrating the hierarchical memory architecture that stores decision traces generated by the decision trace generator. The hierarchical memory architecture comprises three memory tiers. A long-term memory 405 stores persistent decision traces. A mid-term memory 410 stores reinforced decision traces. A short-term memory 415 stores recent decision traces. The hierarchical memory architecture further comprises memory management operations 425 and reinforcement signals 440 that govern transitions between the memory tiers.

The short-term memory 415 stores recent decision traces generated during user interactions. When the decision trace generator of FIG. 2A generates a new decision trace, the system initially stores the decision trace in the short-term memory 415. The short-term memory 415 is subject to an exponential decay function. Under the exponential decay function, decision traces in the short-term memory 415 that do not receive reinforcement are progressively removed from memory over time. The exponential decay function can help the system manage memory usage by removing decision traces that have not demonstrated value in prior interactions.

The mid-term memory 410 stores reinforced decision traces that have been boosted from the short-term memory 415. A decision trace is boosted from short-term memory 415 to mid-term memory 410 based on at least one of learning goal relevance or positive outcome. Learning goal relevance indicates that the decision trace is associated with achieving a learning goal defined for the system. Positive outcome indicates that the decision trace is associated with favorable feedback or a successful result. Decision traces in the mid-term memory 410 have demonstrated value and are retained for longer periods than decision traces in the short-term memory 415.

The long-term memory 405 stores persistent decision traces that have been boosted from the mid-term memory 410. In one implementation, a decision trace is boosted from mid-term memory 410 to long-term memory 405 when the decision trace has received sustained reinforcement over time. Decision traces in the long-term memory 405 represent persistent reasoning patterns that the system has validated through successful application. The long-term memory 405 provides stable context that the system can reference across extended temporal periods.

For example, when a user interacts with the system to solve a problem, the system generates a decision trace recording the decision logic state, cognitive strategy, and associated emotional state for that interaction. The system stores the decision trace in the short-term memory 415. If the user provides positive feedback indicating a successful outcome, the reinforcement signals 440 trigger a boost and the system promotes the decision trace from short-term memory 415 to mid-term memory 410. Over subsequent interactions, if the system successfully applies the reasoning patterns from that decision trace to similar problems and receives continued positive feedback, the system can promote the decision trace from mid-term memory 410 to long-term memory 405. The decision trace then becomes part of the system's persistent knowledge that informs future responses.

The reinforcement signals 440 govern transitions between memory tiers. The reinforcement signals 440 comprise learning goal association, positive outcome association, and positive emotional state. Learning goal association indicates that a decision trace contributed to achieving a learning goal defined for the system. Positive outcome association indicates that a decision trace is associated with a response that received favorable feedback or achieved a desired result. Positive emotional state indicates that a decision trace is associated with an emotional state inferred from a stimulant that reflected favorable conditions. These reinforcement signals may correlate but need not match in all cases. When a decision trace receives one or more reinforcement signals 440, the system evaluates whether the decision trace should be boosted to a higher memory tier.

The memory management operations 425 manage decision traces across the hierarchical memory architecture. The memory management operations 425 comprise operations to increase storage duration, group by emotional and thematic similarity, amplify linked traces, and perform periodic experience replay. The increase storage duration operation extends the retention period for decision traces that comprise a positive emotional state. The group by emotional and thematic similarity operation reorganizes stored decision traces by clustering related traces that share emotional and thematic connections. The amplify linked traces operation increases retention weights for decision traces that are linked to other decision traces through the referenced memory identifiers 335 or the causal chain 345. The periodic experience replay operation replays past positive outcome traces to strengthen effective cognitive pathways.

In one implementation, the system determines thematic similarity using similarity measures such as cosine similarity, dot product similarity, Euclidean distance, or set-based Jaccard similarity over sets of extracted terms or tags. The system determines emotional similarity using distances or similarities computed over emotional-state features such as valence and arousal values or categorical emotional labels. The system can cluster decision traces using clustering techniques including k-means clustering, hierarchical clustering, or density-based clustering.

For example, during periodic experience replay, the system can retrieve decision traces from the mid-term memory 410 that are associated with positive outcomes. The system replays these decision traces by using information recorded in each trace, including the cognitive strategy vector and associated emotional state. This replay reinforces the connection between the reasoning approach and the successful outcome. Decision traces that receive reinforcement through experience replay can have their storage duration extended and their retention weights increased. The experience replay operation can strengthen effective reasoning patterns even when the user is not actively interacting with the system.

The hierarchical memory architecture of FIG. 4 enables the system to develop contextual expertise over time by selectively retaining decision traces that demonstrate value through positive outcomes and learning goal achievement. The combination of exponential decay for unreinforced traces and boost mechanisms for reinforced traces creates a memory ecosystem that prioritizes effective reasoning patterns.

### Examples of Hierarchical Memory Management

In one implementation, the hierarchical memory architecture can support cross-referenced vector storage that preserves contextual lineage across memory tiers. When the system stores a decision trace in the mid-term memory 410, the system can store not only the decision trace content but also embedding representations of the mid-term and long-term memories that were referenced during generation of the response. This combination can record which prior memories and embedding representations participated in the decision and can allow the system to later point to the chained references as a concrete explanation for why it produced the response.

In one implementation, the system generates embedding representations using an embedding model, such as a transformer encoder, a sentence embedding model, or a word embedding model. The system can store embeddings in a vector store and can retrieve related decision traces using approximate nearest neighbor search, locality-sensitive hashing, hierarchical navigable small world indexing, hybrid lexical and vector retrieval, or other indexing techniques.

The cross-referenced vector storage can enable compound contextual recall. When the system retrieves a decision trace from mid-term memory 410, the system can bring the embedded references forward so the contextual lineage is preserved. For example, an initial query about a technical topic might form a decision trace with cross-references to specific knowledge vectors. A follow-up query about a related topic would then include the original context plus additional topic-specific vectors. This can result in more contextually-aware responses that build on previous learning.

The system can perform consolidation operations during designated consolidation periods. During consolidation periods, the system can reorganize the memory network by grouping related decision traces and amplifying traces that share emotional and thematic connections. Where decision traces are not individually deemed highly relevant but over time multiple related decision traces exist, the system can consolidate the related decision traces and provide a relevance boost to the consolidated group.

In one implementation, the hierarchical memory architecture can employ indexing techniques to improve retrieval efficiency across the memory tiers. The system can search multiple memory tiers based on similarity to a current query. The hierarchical structure can enable the system to prioritize retrieval from the mid-term memory 410 when contextual relevance is high while falling back to the long-term memory 405 for foundational knowledge.

In one implementation, the system can provide (such as an output on a display as shown in FIG. 1) decision trace candidates to the user (117) for validation feedback before promoting traces between memory tiers. The user can provide feedback on whether a decision trace should be promoted from short-term memory 415 to mid-term memory 410. The system can collect this feedback to refine its promotion decisions over time.

In one implementation, the system comprises a retrieval engine configured to evaluate governance metadata when retrieving decision traces from one or more memory tiers. The retrieval engine filters decision traces during retrieval based on one or more of an intent classification, a superseded status, contextual applicability metadata, annotations, a temporal confidence score, or a combination of these. The retrieval engine excludes decision traces with a deprecated intent classification from retrieval for use in generating responses unless explicitly requested by a human user. The retrieval engine evaluates contextual applicability metadata against the context of the current prompt, such that when the current prompt relates to a specific client in a specific jurisdiction, the retrieval engine filters to retrieve decision traces whose contextual applicability metadata matches the client identifier and jurisdiction. Decision traces with a provisional intent classification can be retrieved but can be presented with an indication that the reasoning is subject to validation. Decision traces with a preferred-approach intent classification can receive priority weighting during retrieval, increasing the likelihood that the system applies validated reasoning patterns. The retrieval engine can apply filtering rules based on combinations of governance metadata fields to narrow the set of candidate decision traces to those most applicable to the current prompt context.

In one implementation, the system comprises a confirmation processor configured to compare a temporal confidence score of a retrieved decision trace to a staleness threshold. When the temporal confidence score falls below the staleness threshold, the confirmation processor requires confirmation before the system applies the decision trace to generation of a response. The confirmation processor presents the decision trace and an age of the decision trace to one or more of a human user, a supervisory AI model, or an automated validation system. The recipient evaluates the decision trace and provides input indicating whether the decision trace should be applied, updated, or excluded from the current prompt-response iteration. The system applies the decision trace only after receiving confirmation. In one implementation, the confirmation processor routes the confirmation request based on a configuration setting. The configuration setting can specify that confirmation requests are routed to a human user, to a supervisory AI model, or to an automated validation system based on one or more of the domain of the decision trace, the risk level of the current prompt, or a user preference. The staleness threshold can be configured per domain, per user, or per decision trace category.

In one implementation, the system comprises a trace versioning engine configured to manage supersession of decision traces during retrieval. When a decision trace is marked with a superseded status, the trace versioning engine excludes the superseded decision trace from retrieval for use in generating responses. The trace versioning engine retains the superseded decision trace in memory, enabling reconstruction of reasoning evolution over time. A human user or system component can traverse the supersession references to review how reasoning evolved from a first decision trace to a second decision trace and to subsequent decision traces. The trace versioning engine can allow retrieval of superseded decision traces for historical analysis when explicitly requested.

In one implementation, the system comprises an annotation engine configured to present annotations when a decision trace is retrieved for subsequent prompt-response iterations. The annotation engine retrieves annotations stored in association with the decision trace and presents the annotations together with the identifier of the source of each annotation. The annotation engine enables the AI model or a human user to consider the annotations when determining whether to apply the reasoning in the decision trace. For example, if a human user annotated a decision trace with a notation that a particular regulatory interpretation has been revised, the annotation engine presents this notation when the decision trace is subsequently retrieved, allowing the AI model or human user to adjust the reasoning accordingly. In advisory mode, the annotation engine can present annotations to the human user as part of the confirmation workflow.

In one implementation, the memory management engine 180 is further configured to identify and retain decision traces associated with negative outcomes in a negative example memory tier. The memory management engine identifies decision traces associated with negative outcomes based on one or more of explicit negative feedback from a human user indicating that a response was incorrect or unhelpful, observed failure of a strategy recorded in the decision trace in a subsequent prompt-response iteration, or downstream adverse consequences linked to the decision trace such as a recommendation that led to an unfavorable result in a later interaction or transaction. Decision traces stored in the negative example memory tier are exempt from the exponential decay function, so that negative examples are preserved regardless of elapsed time. The memory management engine marks the identified decision traces with a negative example classification indicating the decision traces represent reasoning patterns to avoid. During generation of stimulants for subsequent prompts, the stimulant generator 135 can retrieve decision traces from the negative example memory tier and can generate stimulants that probe whether a proposed response follows a reasoning pattern similar to a negative example. When a similarity to a negative example is detected, the agents can generate additional stimulants to redirect the decision logic away from the negative pattern.

In one implementation, the system comprises an authority mode selector configured to determine whether a retrieved decision trace is applied in an advisory mode or an execution mode. In advisory mode, the system presents the decision trace to one or more of a human user or a supervisory AI model together with an explanation of the reasoning recorded in the decision trace. The system presents this explanation before incorporating the decision trace into the response. The human user or supervisory AI model reviews the presented reasoning and provides confirmation or rejection of application of the decision trace. The system incorporates the decision trace into the response only upon receiving confirmation. In execution mode, the system automatically incorporates the decision trace into generation of the response without requiring confirmation from a human user or a supervisory AI model.

The authority mode selector determines the authority mode based on one or more of the following criteria. A first criterion is an intent classification of the decision trace. Decision traces with a provisional or deprecated intent classification default to advisory mode. Provisional reasoning has not been validated. Deprecated reasoning may no longer be applicable. A second criterion is a temporal confidence score of the decision trace. Decision traces with temporal confidence scores below a threshold default to advisory mode because the reasoning may be stale. A third criterion is a risk level associated with the prompt. Prompts classified as high-risk default to advisory mode. The risk level can be determined based on one or more of a domain-specific risk taxonomy, a monetary threshold associated with the prompt subject matter, or a regulatory sensitivity classification. A fourth criterion is a user preference or system policy specifying a default authority mode for decision trace application. The human user or a system administrator can configure the system to operate in advisory mode for all decision traces, in execution mode for all decision traces, or in a hybrid mode. In hybrid mode, the authority mode is determined per decision trace based on the other criteria. The authority mode can be overridden on a per-interaction basis by a human user or by a supervisory AI model.

In one implementation, the system computes a system confidence score indicating a reliability of the system in determining relevance of decision traces to a learning goal. The system confidence score can be based on one or more of a historical accuracy of the system in identifying decision traces that were subsequently associated with positive outcomes, a consistency of the system's relevance determinations across comparable prompts, or a volume of prior prompt-response iterations from which the system can derive relevance patterns. The system compares the system confidence score to a self-evaluation threshold. The self-evaluation threshold represents a minimum reliability level at which the system is permitted to make autonomous promotion decisions for decision traces without requiring confirmation from a human user. In response to the system confidence score exceeding the self-evaluation threshold, the system autonomously determines whether to promote or retain the decision trace in its current memory tier. In response to the system confidence score falling below the self-evaluation threshold, the system routes the promotion decision to a human user or a supervisory AI model for confirmation. The self-evaluation threshold can be configured per domain, per user, or per decision trace category.

In one implementation, the system comprises a ground truth processor configured to manage decision traces designated as ground truth. The ground truth processor receives input designating a decision trace as a ground truth decision trace. The input can be provided by one or more of a human user, an AI model, or an automated system such as an authoritative regulatory database, a compliance engine, or an organizational policy management system. The ground truth processor stores the ground truth designation in association with the decision trace. The ground truth processor stores an identifier of the source of the ground truth designation. The ground truth processor exempts the decision trace from the exponential decay function and from temporal confidence score degradation based on the ground truth designation. Ground truth decision traces are retained in memory indefinitely and maintain full retrieval weight regardless of elapsed time. The retrieval engine prioritizes retrieval of ground truth decision traces over non-ground-truth decision traces when the ground truth decision trace is relevant to a subsequent prompt. For example, if a human user designates a decision trace as ground truth because it reflects an authoritative interpretation of a regulatory requirement, the retrieval engine prioritizes this decision trace when subsequent prompts involve the same regulatory requirement. In another example, an automated compliance system can designate a decision trace as ground truth when the decision trace reflects a regulatory rule that the compliance system has verified against a current regulatory database.

In one implementation, the system comprises an outcome monitoring engine configured to monitor outcomes associated with responses generated using decision traces. The outcome monitoring engine receives outcome data for responses generated using one or more retrieved decision traces and appends the outcome data to the decision trace. The outcome monitoring engine aggregates outcome data across multiple instances in which the decision trace was applied. The outcome monitoring engine computes an outcome-weighted value score for the decision trace based on the aggregated outcome data, wherein the outcome-weighted value score reflects the overall effectiveness of the reasoning recorded in the decision trace across multiple applications. The outcome-weighted value score modulates retrieval priority and application weight of the decision trace in subsequent prompt-response iterations, so that decision traces with consistently positive outcomes receive greater weight and decision traces with mixed or negative outcomes receive reduced weight.

In one implementation, the outcome monitoring engine is further configured to detect patterns in the aggregated outcome data. The patterns can indicate a change in effectiveness of a decision trace over time. The outcome monitoring engine analyzes outcome data across multiple instances using pattern detection techniques. The pattern detection techniques can include trend analysis over time-ordered outcomes, statistical comparison of outcomes in different time periods, or detection of outcome variance exceeding a threshold.

In response to detecting a pattern indicating a change in effectiveness, the outcome monitoring engine generates an alert or recommendation. The alert or recommendation can indicate one or more of the following conditions. A first condition is degradation of decision trace effectiveness over time. For example, a decision trace may have produced positive outcomes historically but begun producing negative outcomes. A second condition is context-dependent variability in outcomes. For example, a decision trace may produce positive outcomes in one jurisdiction but negative outcomes in another. A third condition is emergence of conditions under which the decision trace should not be applied. For example, a change in regulatory requirements may render the reasoning partially obsolete.

The outcome monitoring engine can update one or more of the intent classification, the temporal confidence score, or the reinforcement status of the decision trace based on the detected pattern. For example, if the outcome monitoring engine detects sustained degradation in outcomes, the outcome monitoring engine can update the intent classification from a preferred-approach classification to a provisional classification. The outcome monitoring engine can also reduce the temporal confidence score. The outcome monitoring engine can also generate an alert to a human user recommending review of the decision trace.

### Example Implementations of Various Components

This section presents example implementations of various components of the technology disclosed. It is understood that these implementations are presented for illustrative purposes only. The technology disclosed and various components of the technology disclosed can be implemented using other techniques and methods.

### Decision-Logic Runtime, State Vector Representation, and Named Components

In one implementation, the system comprises a decision-logic runtime that executes the decision logic on behalf of the AI model. The decision-logic runtime is configured to execute a decision logic that controls generation of the response by the AI model. The decision-logic runtime maintains the decision logic in a current state represented by a machine-readable state vector stored in the one or more memories. The state vector is a structured, numeric or symbolic representation of the current state of the decision logic. The state vector is derived from and associated with the decision logic state 305 depicted in FIG. 3, which comprises rules 307, conditions 308, and causal paths 309. The state vector encodes at least one of a selected strategy identifier derived from the rules 307 and identifying a cognitive strategy currently in use, a constraint identifier derived from the conditions 308 and identifying one or more active constraints governing response generation, a reasoning-path identifier derived from the causal paths 309 and identifying a reasoning approach applied by the AI model, or a safety policy identifier identifying one or more safety constraints that govern permissible transitions and response generation boundaries. Each encoded identifier corresponds to a machine-executable control of the decision-logic runtime. For example, the state vector can be implemented as an array of numeric values, a dictionary of key-value pairs, or a fixed-length binary encoding.

The decision-logic runtime comprises an execution layer that mediates application of the decision logic to at least one of selection of a strategy used to generate the response, selection of constraints applied during generation of the response, or selection of an external tool-call policy used during generation of the response. An external tool-call policy specifies which external tools, APIs, or data sources the AI model is permitted to invoke during response generation, and the execution layer enforces the tool-call policy as part of the decision logic state. When the agent applies a stimulant to the decision logic, the decision-logic runtime updates the state vector to reflect the transition from the current state 161 to the next state 162 as depicted in FIG. 1. The transition updates the state vector without updating parameters of the AI model. The learned parameters of the AI model, such as neural network weights, remain unchanged during the state transition. The decision-logic runtime operates as a layer that mediates between the agent-generated stimulants and the AI model, enabling the system to modify reasoning behavior through state vector transitions rather than through retraining or fine-tuning of the AI model.

As used herein, the stimulant agent refers to one or more of the agents 121 operating within the stimulant generator 135. The system further comprises the following named components, implemented as software routines executed by the one or more processors, that cooperate with the decision-logic runtime. An evaluator is a software routine implemented within the memory management engine 180 and configured to compute, using the scoring rubric, at least one rubric outcome value associated with the response. The rubric outcome value is a numeric or categorical measure indicating the degree to which the response or an intermediate response satisfies the scoring rubric criteria. An intermediate response is a partial or in-progress response generated by the AI model during an iterative prompt-response cycle before a final response is produced. Control logic is a software routine implemented within the stimulant generator 135 and configured to cause the decision-logic runtime to select or reject at least one candidate transition rule for transitioning the state vector based on the at least one rubric outcome value, and to cause the AI model to generate the response using the decision logic in the next state. Trace logic is configured to generate a decision trace for the response. The trace logic corresponds to the decision trace generator 170 described herein. Retention logic is configured to manage storage duration and decay of decision traces and decision logics in memory. The retention logic corresponds to the logic for decay and amplification 186 described herein. Organization logic is configured to reorganize and group decision traces stored in memory based on emotional similarity and thematic similarity. The organization logic corresponds to the logic for grouping of decision traces 182 described herein. Replay logic is configured to periodically replay decision traces associated with positive outcomes. The replay logic corresponds to the experience replay function of the logic for decay and amplification 186 described herein. User-interaction logic is configured to receive input from a human user and generate the stimulant in dependence upon the input. Personalization logic is configured to build and maintain a dynamic profile of a human user's problem-solving approach.

### Stimulant Structure: State-Transition Directives, Scoring Rubrics, and Schema Validation

In one implementation, each stimulant generated by the stimulant agent is a typed stimulant comprising a state-transition directive and a scoring rubric. The stimulant is generated in a typed format comprising the state-transition directive and the scoring rubric. The state-transition directive identifies at least one transition rule of the decision logic. The state-transition directive identifies at least one transition rule identifier selectable from a rule set associated with the decision logic. The rule set comprises the set of transition rules associated with a particular decision logic and executable by the decision-logic runtime. A transition rule specifies a mapping from a current state vector value to a next state vector value for one or more elements of the state vector. For example, a transition rule can specify that when a risk-assessment constraint is active and a probing stimulant identifies an unaddressed risk factor, the state vector is updated to incorporate the risk factor into the active reasoning path. Each decision logic in the plurality of decision logics can have a respective set of transition rules executable by the decision-logic runtime.

In one implementation, the agent generates the stimulant in dependence upon one or more prior decision traces retrieved from memory. The agent uses information from the retrieved prior decision traces to populate the state-transition directive and the scoring rubric of the stimulant. For example, the agent can select a transition rule identifier based on a strategy recorded in a prior decision trace that was associated with a positive outcome, and can populate the scoring rubric with criteria derived from rubric outcome values stored in the prior decision traces. This dependence on prior decision traces enables the agent to generate stimulants that build on previously successful reasoning patterns.

The scoring rubric specifies at least one measurable criterion for evaluating alignment of at least one of the response or an intermediate response with a learning goal identifier. For example, the scoring rubric can specify that the response must address a threshold number of identified risk factors, must maintain internal consistency across reasoning paths, or must incorporate contextual information from prior decision traces. The evaluator computes at least one rubric outcome value using the scoring rubric. The rubric outcome value is stored as a field within the decision trace, enabling subsequent retrieval and comparison of rubric outcomes across decision traces. The convergence condition described herein can be evaluated using a quality metric computed from the scoring rubric or from scoring-rubric outcomes.

In one implementation, the typed stimulant is validated against a schema before application to the decision-logic runtime. The schema defines permitted fields, data types, and value ranges for the state-transition directive and the scoring rubric. The decision-logic runtime rejects the typed stimulant when schema validation fails, preventing malformed or unauthorized stimulants from modifying the state vector. Schema validation ensures structural integrity of the stimulant pipeline and can be configured per decision logic or per domain.

When the orchestrator agent 139 combines typed stimulants from the plurality of agents, the orchestrator agent 139 produces an ordered stimulus plan specifying the sequence in which the combined typed stimulants are applied to the decision-logic runtime. The ordered stimulus plan resolves conflicts among candidate transition rule identifiers using at least one rubric outcome value. The ordered stimulus plan also resolves conflicts between transition rules using the scoring rubric. The conflicts can be resolved by evaluating predicted rubric outcome values for each candidate transition rule. The predicted rubric outcome values can be computed by staged trial application of the candidate transition rules to a copy of the current state vector, by historical rubric outcome values recorded in prior decision traces for the same transition rule identifiers, or by a predictive scoring function that estimates alignment with the learning goal based on attributes of the candidate transition rule and the current state vector. The orchestrator agent 139 prioritizes typed stimulants whose candidate transition rules yield the highest predicted rubric outcome values.

### Tamper-Evident Decision Trace Storage Via Hash Chains

In one implementation, the trace logic (corresponding to the decision trace generator 170) generates a decision trace for the response. In addition to the fields depicted in the decision trace data structure of FIG. 3, the decision trace further comprises a hash of a serialization of the current state vector, a hash of a serialization of the next state vector, the at least one transition rule identifier applied during the state transition, and at least one rubric outcome value computed using the scoring rubric. These additional fields are stored as part of the decision trace data structure alongside the existing fields such as the decision logic state 305, the cognitive strategy vector 315, the associated emotional state 325, the referenced memory identifiers 335, the causal chain 345, the storage duration 355, the reinforcement status 365, and the learning value confidence score 375. The hash of a serialization of the current state vector comprises a hash computed over a serialized representation of the state vector. The state vector is serialized into a canonical byte representation before the hash function is applied. The canonical byte representation ensures that semantically identical state vectors produce identical hash values regardless of in-memory representation order. The hashes can be computed using a cryptographic hash function, such as SHA-256. In some implementations, the decision trace comprises a hash of the current state vector and a hash of the next state vector computed without an explicit serialization step, for example when the state vector is natively stored in a fixed-format binary encoding.

The decision trace is stored as a tamper-evident record linked to at least one prior decision trace via a hash chain. The hash chain is constructed by including, within each decision trace, a hash of at least one prior decision trace. This linking creates a tamper-evident chain in which modification of any prior decision trace would produce a detectable inconsistency in the hash values of subsequent decision traces. The referenced memory identifiers 335 described herein identify prior decision traces consulted during generation of the response, enabling reconstruction of contextual lineage. The one or more referenced memory identifiers are validated against the hash chain by comparing the stored hash of a referenced prior decision trace with a recomputed hash of the prior decision trace retrieved from memory. The causal chain 345 described herein can include at least one intermediate state hash corresponding to each prior decision operation, enabling verification of the integrity of the full reasoning lineage.

In one implementation, when a second AI model generates a second response and a second decision trace is generated, the second decision trace includes pre-state and post-state hashes corresponding to the state vectors before and after the second AI model's state transition. The comparison between the first decision trace and the second decision trace can include a consistency check of the scoring rubric outcomes to determine whether both AI models achieved comparable alignment with the learning goal, and a divergence check between state hashes under common transition rule identifiers to determine whether the two AI models reached different states when the same transition rules were applied.

### Learning-Goal Gap, Emotional Inference, and Reinforcement Threshold

In one implementation, the evaluator is configured to determine a learning-goal gap using the scoring rubric and provides the learning-goal gap to the emotional inference engine 175. The learning-goal gap is a computed quantity representing a difference between an expected alignment score and an actual alignment score for the response as measured by the scoring rubric. The system infers an associated emotional state from the learning-goal gap. The emotional inference engine 175 infers the associated emotional state from the learning-goal gap. The associated emotional state comprises at least one of a positive state, an altered state, a neutral state, or a cautious state. A small learning-goal gap, indicating that the response closely aligns with the learning goal, can result in inference of a positive state. A moderate learning-goal gap in which the response partially aligns with the learning goal but exhibits unexpected reasoning deviations or unconventional strategy selections can result in inference of an altered state, indicating that the reasoning trajectory has shifted from established patterns. A learning-goal gap that falls within a baseline range, indicating that the response neither significantly exceeds nor falls short of expected alignment, can result in inference of a neutral state, indicating that no emotional modulation of subsequent stimulant generation is warranted. A large learning-goal gap, indicating significant misalignment between the response and the learning goal, can result in inference of a cautious state. The emotional inference engine 175 can use the learning-goal gap to generate the inferred emotion, consistent with the knowledge and learning gap mechanisms described herein.

In one implementation, the retention logic (corresponding to the logic for decay and amplification 186) is configured to increase a storage duration of at least one decision trace when the associated emotional state is positive and when the learning-goal gap satisfies a reinforcement threshold. The reinforcement threshold specifies a minimum alignment score or a maximum learning-goal gap that must be satisfied before the retention logic increases the storage duration for the decision trace. The retention logic further applies an exponential decay function to decision traces not associated with a positive outcome under the scoring rubric, wherein decision traces not reinforced by positive outcomes are removed from memory over time. The retention logic also retains decision logics associated with a selected learning goal identifier and applies a decay function to decision logics not associated with the selected learning goal identifier.

### Cognitive Strategy Vector Weights and Temperature Modulation

In one implementation, the cognitive strategy vector 315 comprises weighted components including at least one of a planning weight indicating the degree to which the decision-logic runtime applied a planning-based reasoning approach to condition generation of the response by the AI model, an exploration weight indicating the degree to which the decision-logic runtime applied an exploratory reasoning approach to condition generation of the response by the AI model, or a constraint-satisfaction weight indicating the degree to which the decision-logic runtime applied a constraint-driven reasoning approach to condition generation of the response by the AI model. The decision-logic runtime selects and weights the strategy, and the AI model generates the response under the conditioned state. These weights can be derived from the logged decision operations, the stimulant types applied, and the transition rules invoked during the state transition.

In implementations that employ transition rules, the temperature parameter (also referred to as the temperature control parameter) modulates selection among transition rule identifiers rather than modulating randomness in free-form stimulant content as described elsewhere herein. The temperature control parameter modulates behavior of the stimulant agent in the context of transition rule selection. The temperature control parameter is adjusted based on both the associated emotional state and the learning-goal gap. Increasing the temperature control parameter increases exploration in selecting transition rule identifiers, causing the stimulant agent to consider a broader set of transition rules including lower-probability rules. Decreasing the temperature control parameter increases constraint-satisfaction in selecting transition rule identifiers, causing the stimulant agent to prioritize transition rules with the highest alignment to active constraints. A higher temperature parameter increases exploration in selection of transition rules. A lower temperature parameter enforces constraint-satisfaction in selection of transition rules.

### Organization, Replay, and Hierarchical Memory

In one implementation, the organization logic (corresponding to the logic for grouping of decision traces 182) reorganizes decision traces stored in memory by grouping related decision traces based on emotional similarity and thematic similarity. The emotional similarity and thematic similarity are derived from at least one rubric outcome value stored in the decision trace and at least one strategy identifier encoded in the cognitive strategy vector 315 of the decision trace. The organization logic amplifies decision traces that share emotional and thematic connections by increasing a retention weight used by the decay function, thereby reinforcing effective cognitive pathways.

The hierarchical memory stores decision traces in a plurality of tiers comprising a short-term tier storing decision traces from recent interactions, a mid-term tier storing decision traces boosted from the short-term tier based on relevance to a learning goal identifier or association with a positive outcome, and a long-term tier storing decision traces boosted from the mid-term tier. Decision traces progress from the short-term tier to the mid-term tier to the long-term tier based on reinforcement measured by the scoring rubric. Decision traces not reinforced remain in the short-term tier and are subject to decay.

In one implementation, the replay logic (corresponding to the experience replay function of the logic for decay and amplification 186) periodically replays decision traces associated with positive outcomes in a non-output-producing evaluation mode. In the non-output-producing evaluation mode, the system retrieves and reprocesses stored decision traces to update retention weights and reinforce effective cognitive pathways without emitting a user-visible response. The evaluation mode enables the system to strengthen reasoning patterns during idle periods or the designated consolidation periods described herein without affecting the user's interaction with the system.

### Agent Architecture and Convergence

In one implementation, the stimulant agent is selected from a plurality of agents 121 including one or more role-based agents 137 configured to generate role-based typed stimulants that probe the decision logic from distinct reasoning perspectives, and one or more context-based agents 138 configured to generate context-based typed stimulants that provide contextual information to the decision-logic runtime. Each typed stimulant generated by the plurality of agents includes the state-transition directive and the scoring rubric. Each stimulant generated by the plurality of agents is generated in a typed format comprising the state-transition directive and the scoring rubric.

The orchestrator agent 139 is configured to combine typed stimulants from the plurality of agents into an ordered stimulus plan for application to the decision-logic runtime. The ordered stimulus plan resolves conflicts among candidate transition rule identifiers using at least one rubric outcome value. The ordered stimulus plan also resolves conflicts between transition rules using the scoring rubric. The plurality of agents iteratively generates and applies typed stimulants until a convergence condition is satisfied. The convergence condition is based on one or more of a resource constraint, an iteration threshold, or a quality metric computed from scoring-rubric outcomes.

### Human User Input, Dynamic Profile, and Decision Logic Identification

In one implementation, the user-interaction logic receives an input from a human user and generates the typed stimulant in dependence upon the input from the human user. The human user input selects at least one transition rule identifier or modifies at least one scoring-rubric criterion, directing the stimulant agent to apply a specific transition rule to the decision logic or adjusting the measurable criteria by which the evaluator evaluates alignment of responses with the learning goal.

The personalization logic builds a dynamic profile of a human user's problem-solving approach based on interactions with the human user. The dynamic profile comprises preferences over transition rule identifiers and strategy identifiers. The decision-logic runtime is adapted based on the dynamic profile to bias selection among transition rule identifiers without changing parameters of the AI model. The bias is implemented by adjusting selection weights associated with transition rules based on the higher-weighted features in the dynamic profile.

In one implementation, when the memory stores a plurality of decision logics, the control logic is configured to select a particular decision logic from the plurality of decision logics based on matching at least one of a learning goal identifier, a domain identifier, or a strategy identifier encoded in a current state vector. The agent can also use the stimulant to identify a decision logic in the plurality of decision logics by matching at least one strategy identifier and at least one learning goal identifier. Each decision logic in the plurality of decision logics can be associated with a learning goal identifier, a domain identifier, and a strategy identifier reflecting the primary cognitive strategy encoded in the decision logic's state vector. A domain identifier identifies a subject matter domain, such as legal analysis, medical reasoning, financial planning, or software engineering, associated with the decision logic. The control logic or the agent compares identifiers specified in the stimulant or derived from the prompt against identifiers associated with the stored decision logics to select the decision logic most relevant to the current prompt. The prior decision trace associated with a selected decision logic can comprise a corresponding hash of a serialization of the state vector of the decision logic, or a corresponding hash of the state vector of the decision logic, enabling verification that the decision logic has not been modified since the prior decision trace was generated.

### Illustrative Example

The following example illustrates operations of the technology disclosed according to one implementation. The technology disclosed is applicable across diverse domains including, without limitation, legal advisory systems, customer support systems, medical triage systems, software development and code review systems, security incident response systems, insurance systems, procurement systems, educational technology systems, and other domains where an AI system benefits from traceable reasoning, contextual memory, and adaptive learning. The example presented herein uses a legal advisory context for illustrative purposes. One of ordinary skill in the art will recognize that the same mechanisms apply to other domains without departing from the scope of the technology disclosed.

In this example, a human user, a senior technology transactions attorney, interacts with the system to analyze and negotiate contract terms for an enterprise software licensing agreement. This example demonstrates how the system generates stimulants, transitions decision logic from a current state to a next state, generates decision traces, and manages memory across hierarchical memory tiers. It is understood that implementations of the technology disclosed may include all, some, or different combinations of the phases described below, including implementations that omit convergence loops, temperature modulation, experience replay, trust calibration, or other optional phases

### Initial Prompt and Prior Decision Trace Retrieval

The AI model receives a prompt from the human user. The prompt comprises a user query requesting analysis of a limitation of liability clause in an enterprise software license agreement. The prompt states, “review the limitation of liability clause in this software license. The client is a Fortune 500 company licensing our enterprise platform. Identify risks and recommend modifications.”

In response to receiving the prompt, the system retrieves prior decision traces from memory. The system identifies prior decision traces that are relevant to the current prompt, including by similarity scoring or other relevance determination methods. In this example, the system retrieves three prior decision traces from the mid-term memory. A first prior decision trace identifies a strategy adopted by the AI model to generate a response in a prior prompt-response iteration involving limitation of liability analysis for a financial services client. A second prior decision trace identifies a strategy adopted by the AI model to generate a response in a prior prompt-response iteration involving indemnification provisions in a technology licensing context. A third prior decision trace identifies a strategy adopted by the AI model to generate a response in a prior prompt-response iteration where the human user provided positive feedback on a recommended liability cap structure. Each prior decision trace comprises a corresponding state of the decision logic at the time the prior response was generated.

### Stimulant Generation by Plurality of Agents

The system generates stimulants using a plurality of agents. The plurality of agents includes one or more role-based agents configured to generate role-based stimulants that probe the decision logic from distinct reasoning perspectives. The plurality of agents also includes one or more context-based agents configured to generate context-based stimulants that provide contextual information to the decision logic.

In this example, a first role-based agent configured to probe risk-related aspects generates a first stimulant. The first stimulant comprises a probing input that probes risk-related aspects of the limitation of liability clause. The first stimulant probes, “What liability exposure remains if the cap is set at fees paid in the prior twelve months? What carve-outs from the cap could create unlimited exposure?”

A second role-based agent configured to probe strategic aspects generates a second stimulant. The second stimulant comprises a probing input that probes strategic aspects of the negotiation. The second stimulant probes: “What negotiation leverage exists given the client's size and the competitive landscape? What alternative cap structures have succeeded in comparable transactions?”

A third role-based agent configured to probe fairness considerations generates a third stimulant. The third stimulant comprises a probing input that probes fairness considerations. The third stimulant probes, “does the proposed liability allocation reflect a fair distribution of risk between the parties given their respective capabilities to bear and mitigate the risk?”

A context-based agent generates a fourth stimulant. The fourth stimulant comprises a context-adding input that provides contextual information to the decision logic. The fourth stimulant provides, “the referenced prior decision traces indicate that Fortune 500 clients in regulated industries typically require specific carve-outs for data breach liability. The second prior decision trace indicates that a tiered cap structure received positive feedback from the human user in a comparable transaction.”

An orchestrator agent coordinates the plurality of agents. The orchestrator agent combines the stimulants generated by the role-based agents and the context-based agents for application to the decision logic.

### Decision Logic State Transitions

The system applies the combined stimulants to the decision logic to transition the decision logic from a current state to a next state. Prior to application of the stimulants, the decision logic is in a current state. The current state of the decision logic comprises one or more of a rule, a condition, or a causal path identifying a reason a response was generated by the AI model.

In this example, the current state of the decision logic comprises a rule specifying that limitation of liability clauses should include a cap tied to contract value. The current state further comprises a condition evaluating whether the client operates in a regulated industry. The current state further comprises a causal path indicating that prior successful analyses of limitation of liability clauses applied a risk allocation framework.

The system can transition the decision logic directly from the current state to the next state by applying multiple stimulants concurrently. Alternatively, the system can apply stimulants in sequence, resulting in intermediate state transitions. Both approaches are within the scope of the technology disclosed.

In this example, the system applies the stimulants in sequence. In response to application of the first stimulant from the risk-focused agent, the decision logic transitions from the current state to a first intermediate state comprising an updated rule and causal path related to risk identification.

In response to application of the second and third stimulants, the decision logic transitions through additional intermediate states incorporating strategic considerations and fairness evaluations. In response to application of the fourth stimulant from the context-based agent, the decision logic transitions to a next state that incorporates contextual information from the prior decision traces.

### Iterative Refinement Until Convergence

The plurality of agents iteratively generates stimulants and applies the stimulants to the decision logic until a convergence condition is satisfied. The convergence condition can be based on one or more of a resource constraint, an iteration threshold, or a quality metric.

In this example, after the initial round of stimulant application, the system evaluates the convergence condition. The system determines that the quality metric has not yet been satisfied because the decision logic has not yet addressed the specific regulatory requirements applicable to the client's industry. The plurality of agents generates additional stimulants and applies the additional stimulants to the decision logic.

A fifth stimulant probes: “What data protection regulations apply to the client's industry and how do those regulations affect liability allocation for data breaches?”

In response to application of the fifth stimulant, the decision logic transitions to an updated next state that incorporates regulatory considerations into the liability analysis.

The system again evaluates the convergence condition. The system determines that the quality metric is now satisfied. The iterative generation of stimulants terminates.

### Response Generation Using Decision Logic in Next State

The AI model generates a response to the prompt using the decision logic in its next state. The response identifies risks in the limitation of liability clause and recommends modifications. In summary, the response identifies three risk areas (insufficient cap amount, broad carve-outs creating unlimited exposure, and missing data breach provisions) and recommends corresponding modifications (tiered cap structure, mutual carve-outs, and dedicated data breach liability provision). The specific content of the response reflects the decision logic in its next state, which incorporated inputs from the role-based agents, the context-based agent, and the prior decision traces.

### Decision Trace Generation

The system generates a decision trace using a decision trace generator. The decision trace identifies a strategy adopted by the AI model to generate the response. The decision trace comprises the next state of the decision logic.

The decision trace comprises a decision logic state recording the state of the decision logic at the time the AI model generated the response. The decision logic state comprises rules specifying the analytical framework applied to the limitation of liability clause. The decision logic state comprises conditions that were evaluated, including the condition evaluating regulatory applicability. The decision logic state comprises causal paths identifying reasons the response was generated, including causal paths linking the tiered cap recommendation to comparable transaction outcomes.

The decision trace comprises a cognitive strategy vector identifying the strategy applied by the AI model to generate the response. The cognitive strategy vector indicates that the AI model applied analogical reasoning by identifying similarities between the current transaction and prior transactions recorded in the prior decision traces. The cognitive strategy vector further indicates that the AI model applied deductive reasoning by applying general principles of risk allocation to derive specific recommendations for the limitation of liability clause.

The decision trace comprises an associated emotional state inferred from the stimulants. In this example, the emotional inference engine infers a cautious state based on the stimulants. The cautious state indicates that the stimulants included risk-averse probing inputs, including the risk-focused agent's probing of liability exposure and the regulatory implications identified through iterative refinement. In one implementation, the associated emotional state 325 can further comprise optional metadata including an intensity value indicating the strength of the emotional state and a context summary providing a textual description of the context in which the emotional state was inferred. These optional metadata fields are not required by the technology disclosed.

The decision trace comprises referenced memory identifiers identifying prior decision traces that were retrieved, ranked, linked, or otherwise used to support contextual lineage during generation of the response. The referenced memory identifiers include identifiers for the three prior decision traces retrieved from the mid-term memory. These referenced memory identifiers enable reconstruction of contextual lineage by linking the current decision trace to the historical reasoning records that informed the response.

The decision trace comprises a causal chain linking the response to one or more prior decision operations that contributed to generation of the response. The causal chain identifies the following prior decision operations: (1) retrieval of prior decision traces based on similarity to the current prompt; (2) identification of risk factors through application of the risk-focused agent stimulant; (3) identification of strategic considerations through application of the strategy-focused agent stimulant; (4) evaluation of fairness considerations through application of the fairness-focused agent stimulant; (5) incorporation of contextual information from prior decision traces; and (6) incorporation of regulatory considerations through iterative refinement. The causal chain enables reinforcement of effective early decisions when a positive outcome is delayed.

The decision trace comprises a storage duration specifying a retention period for the decision trace. The storage duration is initially set to a default value corresponding to short-term memory retention.

The decision trace comprises a reinforcement status indicating whether the decision trace is associated with a positive outcome. The reinforcement status is initially set to pending, indicating that the decision trace has not yet received feedback indicating a positive or negative outcome.

### Storage in Hierarchical Memory

The system stores the decision trace in hierarchical memory. The hierarchical memory stores decision traces in a plurality of memory tiers comprising a short-term memory storing decision traces from recent interactions, a mid-term memory storing decision traces that have been boosted from the short-term memory based on relevance to a learning goal or association with a positive outcome, and a long-term memory storing decision traces that have been boosted from the mid-term memory.

The system initially stores the decision trace in the short-term memory. The short-term memory is subject to an exponential decay function. Under the exponential decay function, decision traces in the short-term memory that do not receive reinforcement are progressively removed from memory over time.

### Human User Feedback and Reinforcement

The human user reviews the response generated by the AI model. The human user provides input indicating that the response was helpful and that the tiered cap recommendation aligns with the human user's preferred approach to liability allocation in technology transactions. This input from the human user constitutes positive feedback.

The system receives the input from the human user. In response to receiving the positive feedback, the system updates the reinforcement status of the decision trace to indicate a positive outcome association. The system further increases the storage duration for the decision trace because the decision trace is now associated with a positive outcome.

The system evaluates whether the decision trace should be boosted from the short-term memory to the mid-term memory. The system determines that the decision trace is associated with a positive outcome and is relevant to a learning goal. Based on this determination, the system boosts the decision trace from the short-term memory to the mid-term memory.

### Emotional State and Temperature Modulation

In a subsequent interaction, the human user provides additional positive feedback on a follow-up response generated using reasoning patterns from the boosted decision trace. The system generates a follow-on stimulant that incorporates the user feedback. The emotional inference engine infers a positive state from input signals that include the follow-on stimulant. The associated emotional state transitions from the cautious state to a positive state.

A temperature parameter modulates behavior of the agents. The temperature parameter can be adjusted based on the associated emotional state. In one implementation, a higher temperature parameter increases randomness and creativity in generation of the stimulant and a lower temperature parameter enforces coherence in generation of the stimulant. The system can increase the storage duration for the decision trace when the decision trace comprises a positive associated emotional state.

### Long-Term Memory Promotion and Experience Replay

Over subsequent interactions, the human user continues to interact with the system on technology transaction matters. The system generates additional decision traces for limitation of liability analyses, indemnification provisions, and related contract terms. Several of these decision traces reference the original decision trace through their referenced memory identifiers.

The system periodically replays decision traces associated with positive outcomes, thereby strengthening cognitive pathways associated with the replayed decision traces. During experience replay, the system retrieves the original decision trace from the mid-term memory and replays the decision trace by using information recorded in the trace, including the cognitive strategy vector and associated emotional state. This replay reinforces the connection between the analytical approach and the successful outcome.

The system evaluates whether the decision trace should be boosted from the mid-term memory to the long-term memory. In one implementation, the system can boost a decision trace from the mid-term memory to the long-term memory based on sustained reinforcement over time through continued positive feedback and successful application in subsequent interactions. Based on this determination, the system boosts the decision trace from the mid-term memory to the long-term memory. The decision trace becomes part of the system's persistent knowledge that informs future responses.

### Memory Reorganization and Amplification

The system reorganizes decision traces stored in memory by grouping related decision traces based on emotional and thematic similarity. The system identifies that the decision trace for the limitation of liability analysis shares thematic connections with other decision traces related to risk allocation in technology transactions. The system groups these related decision traces.

The system amplifies decision traces that share emotional and thematic connections, thereby reinforcing effective cognitive pathways. The amplification increases retention weights for the grouped decision traces, reducing the rate at which the exponential decay function would otherwise affect these traces.

### Dynamic Profile Building and Mentorship

The system builds a dynamic profile of the human user's problem-solving approach based on interactions with the human user. The dynamic profile captures the human user's preference for tiered cap structures, the human user's emphasis on regulatory compliance, and the human user's analytical framework for evaluating risk allocation. The decision logic adapts based on the dynamic profile to mirror the human user's problem-solving approach.

In subsequent interactions, when the AI model receives prompts related to limitation of liability analysis, the system generates stimulants in dependence upon the input from the human user as reflected in the dynamic profile. The adapted decision logic produces responses that align with the human user's established preferences and analytical approach, while continuing to probe from distinct reasoning perspectives through the role-based agents.

### Decision Trace Comparison for Trust Calibration

In one implementation, a second AI model generates a second response to a prompt based on a second decision logic, and the system generates a second decision trace identifying a second strategy adopted by the second AI model. The system compares the decision trace with the second decision trace to determine which of the response and the second response is more trustworthy based on factors including cognitive strategy vectors, associated emotional states, and referenced memory identifiers. This multi-model comparison is an optional capability of the technology disclosed. The system 100 can further comprise a comparator configured to compare decision traces generated by different AI models to determine which response is more aligned with prior decision traces associated with positive outcomes.

### Decay of Unreinforced Decision Traces

Not all decision traces receive reinforcement. In this example, the system generates a decision trace for a response that analyzed a non-disclosure agreement provision. The human user does not provide feedback on this response, and the reasoning patterns from this decision trace are not applied in subsequent interactions.

The system applies an exponential decay function to the decision trace because the decision trace is not associated with a positive outcome. The storage duration for the decision trace progressively decreases. Because the decision trace does not receive reinforcement, the decision trace remains in the short-term memory and is subject to decay. After the storage duration expires, the decision trace is removed from memory.

This selective retention ensures that the system prioritizes decision traces that have demonstrated value through positive outcomes and learning goal achievement while removing decision traces that have not demonstrated value in prior interactions.

### Conclusion of Example

This example illustrates how the technology disclosed enables an AI system to develop contextual expertise over time through the integration of stimulant generation, decision logic state transitions, decision trace generation, and hierarchical memory management. The system records what reasoning approach was applied, not just what response was generated. The system retains effective reasoning patterns and discards reasoning patterns that have not demonstrated value. The system adapts to mirror the human user's problem-solving approach while continuing to probe from distinct reasoning perspectives. These capabilities enable the AI system to provide increasingly effective assistance across prompt-response iterations.

While this example uses a legal advisory context, the same mechanisms apply to other domains. For instance, a customer support system can use the same stimulant generation, decision trace, and hierarchical memory mechanisms to develop expertise in resolving customer issues. A medical triage system can use the same mechanisms to develop expertise in symptom assessment and care recommendations. A software development system can use the same mechanisms to develop expertise in code review and debugging. The domain-specific content of the prompts, stimulants, and responses varies, but the underlying architecture for decision logic state transitions, decision trace generation, and hierarchical memory management remains consistent across domains.

### Particular Implementations

This section presents various implementations of the technology disclosed to transition decision logic from the current state to a next state and manage decision traces.

Traditional AI systems are often built on static models that fail to capture the dynamic interplay between cognition, emotion, and memory observed in biological systems. Human cognition benefits from emotionally modulated memory consolidation, flexible decision-making, and creative free association, all of which contribute to adaptive learning and problem solving. The technology disclosed draws inspiration from these mechanisms to integrate emotional feedback into a reinforcement learning framework, allowing the system to adjust its strategies based on past successes and user mentoring.

The technology disclosed provides modular cognitive processing logic to create a system composed of specialized agents (e.g., Cortex, Seer, Oracle, House, Prudence, Conscience) that together simulate aspects of human cognition. It is understood that additional agents can be provided by the technology disclosed. The above-listed agents are presented as examples to illustrate the technology.

The technology disclosed provides emotional feedback integration to design an emotional inference module that maps user and internal affective signals onto temperature parameters, dynamically modulating agent behavior.

The technology disclosed provides adaptive memory management logic to incorporate mechanisms for memory reinforcement, decay, and consolidation via sleep-like cycles and positive feedback loops.

The technology disclosed provides reinforcement learning and mentorship logic to implement reward shaping and temporal credit assignment strategies that enable the system to evolve its cognitive policies based on explicit and implicit user feedback.

Integrating these elements promises a transformative shift in AI design, enabling systems to “learn” in a manner akin to human cognitive evolution. The adaptive evolution targeted herein is not simply a matter of incremental improvement. It is designed to allow the system to internalize successful strategies, develop unique skills, and maintain a robust yet flexible problem-solving ability.

The technology disclosed comprises an input and sensory integration component to aggregates external and internal inputs. The technology disclosed provides contextual information to the emotional inference engine (175) and all agents 121 (also referred to as cognitive agents) ensuring that outputs are contextually appropriate.

The technology comprises the memory management engine 180 (also referred to as memory module). The memory management engine can maintain and manage logs of past conversations and emotional impacts without decay. The system can comprise an associative memory that stores key experiences along with corresponding emotional states and cognitive strategies. A memory decay logic can introduce exponential decay functions, modulated by emotional reinforcement, so that unreinforced memories fade over time. A sleep-based consolidation component is configured with logic to implement sleep cycles during which memories are reorganized, grouped by thematic and emotional similarity, and selectively reinforced. An experience replay component is configured with logic to periodically “replay” past positive experiences to further strengthen effective cognitive pathways.

The system comprises following agents (121):

Cortex agent is configured with logic to implement central decision-making and integration. Cortex agent can adjust outputs based on emotional and memory cues.

Seer agent is configured with logic to implement pattern recognition and predictive analysis. Seer agent operates at high reasoning effort under optimal states.

Oracle agent is configured with logic to implement strategic planning and probability assessment. Oracle agent is sensitive to changes in emotional modulation.

House agent is configured with logic to implement practical considerations and resource management. House agent is enabled to maintains stability despite emotional fluctuations.

Prudence agent is configured with logic to implement risk assessment and boundary enforcement. Prudence agent is enabled for dynamic adjustments to avoid excessive risk-taking.

Conscience agent is configured with logic to implement ethical and moral oversight. Conscience agent ensures decisions remain within ethical bounds.

The technology disclosed can comprise logic for daydreaming, free association and dream generation that enable unstructured, creative processing that can be integrated into the Cortex agent under favorable emotional states.

The emotional inference engine 175 is configured with logic to continuously (or intermittently) monitor input signals to deduce the system's current emotional state. The emotional inference engine 175 can comprise direct and indirect mapping logic. Direct mapping allows immediate modulation of agent parameters based on detected emotions. Indirect mapping allows an intermediary temperature parameter to influence multiple agents simultaneously. An outcome logic implemented as part of the emotional inference engine 175 is configured to adjusts the system's operating mode (e.g., increasing randomness and free association in positive or altered states, and enforcing coherence in neutral or cautious states).

The technology disclosed provides temperature and altered state simulation logic that can be implemented (in one implementation) as part of emotional inference engine 175. It can comprise manual and automated adjustment logics. The manual adjustment enables the users to manually set temperature levels to simulate various states (e.g., “drunk” or “psychedelic”, etc.). In automatic adjustment, the system autonomously adjusts temperatures based on feedback loops. The emotional inference engine can alter reasoning effort, coherence, and creativity across different modules to mimic state-dependent cognitive performance.

In one implementation, the technology disclosed provides a reinforcement learning framework for adaptive evolution. The reinforcement learning framework comprises reward shaping logic that uses user feedback and successful outcomes to assign rewards. It further comprises temporal credit assignment logic that allows rewards assignment even when positive outcomes are delayed, ensuring that effective early decisions are reinforced. The reinforcement learning framework comprises policy adaptation logic to allow the system to continuously update its decision policies to favor strategies that historically lead to success. The reinforcement learning framework for adaptive evolution further comprises a user modeling and mentorship interface. This interface allows the system to builds a dynamic profile of the user's problem-solving approach. The system can use periodic “training sessions” in which users provide explicit feedback to shape the system's learning, similar to mentoring.

In one implementation, the technology disclosed provides a plurality of visualization tools. For example, a real-time emotion and temperature map allows generation and rendering of three-dimensional (or 3D) surface plots that display how affective dimensions (e.g., valence and arousal) correlate with temperature parameters. An agent performance radar charts user interface allows generation and rendering of visual representations of each agent's effectiveness (reasoning effort, output coherence, free association frequency) under various states. A memory reinforcement graphs user interface allows generation and rendering of line charts illustrating the reinforcement of memories over time, contrasting baseline exponential decay with curves boosted by sleep-based consolidation and positive feedback.

The technology disclosed allows adaptive memory management for sleep, dreams, and memory decay. The memory management engine 180 is configured with logic to implement adaptive evolution of decision traces. An exponential decay logic enables exponential decay of memory traces unless reinforced by positive outcomes. An emotional reinforcement logic allows memories linked with strong positive emotions to receive additional weight, slowing decay and making them more likely to be replayed during future interactions. An experience replay and consolidation logic is configured to implement sleep cycles and dream generation. During designated sleep periods, the system reorganizes its memory network, grouping related memories and amplifying those that share emotional and thematic connections. A dedicated dream agent can sample from these memory clusters using multiple reasoning techniques (inductive, deductive, free association) to generate ephemeral outputs that, if relevant, can further reinforce underlying memory traces.

The technology disclosed allows adaptive evolution through reinforcement loops. The combination of memory decay, reinforcement, and sleep-based consolidation creates a positive feedback loop. As the system receives user feedback and experiences positive outcomes, the reinforced memories guide the adaptation of cognitive policies. The is referred to as mentored adaptation. Memories tied to successful problem-solving and favorable emotional states are retained longer, shaping future decision-making. This is referred to as selective retention. With each sleep cycle, the system refines its internal models, leading to a gradual evolution toward optimal performance in areas aligned with the user's mentoring. This is referred to as continuous learning.

In one implementation, the technology disclosed achieves 95% performance relative to an 85% baseline illustrating enhanced recognition speed. The technology disclosed provides improved integration and formation accuracy with measured improvements of 10-14% across core metrics. The technology disclosed provides a user-driven adaptation including visual feedback showing real-time temperature modulation that correlates with increased agent effectiveness when users adjust parameters.

The technology disclosed, by incorporating sleep-based consolidation and memory decay, can provide increased long-term learning efficiency, improved pattern recognition and stability of cognitive performance. The technology disclosed provides increased long-term learning efficiency by reinforcing positive memory traces and discarding irrelevant information. The technology disclosed provides improved pattern recognition through enhanced connectivity of emotionally reinforced memories. The technology disclosed provides stability of cognitive performance via regular temperature resets and memory reorganization, leading to greater system robustness.

The technology disclosed provides adaptive evolution and personalized cognition. The integration of dynamic memory management, emotional feedback, and reinforcement learning enables adaptive evolution. The technology disclosed is configured with logic to evolves to mirror the problem-solving approaches of its user, continuously refining its strategies based on direct mentorship. This feature is referred to as personalized adaptation. The technology disclosed is configured with logic to simulate altered states (e.g., free association under positive emotional influence) promoting creative insights that would otherwise be inaccessible. This feature is referred to as creative emergence. The technology disclosed is configured with logic to allow robust learning by enabling interplay between memory decay and reinforcement ensures that only the most effective strategies persist over time.

The technology disclosed provides an adaptive cognitive system that integrates emotional feedback, reinforcement learning, and dynamic memory management to evolve its problem-solving capabilities over time. The technology disclosed comprises static memory, temperature-adjusted agent modulation, and user-driven feedback that serve as a robust foundation. The technology disclosed also allows sleep-based consolidation, memory decay, and free association modules to allow and enhance adaptive evolution.

The following section presents examples of various machine learning and artificial intelligence models and other relevant techniques that can be used by the disclosed AI system. Following this, a computer system implementation is presented that can be used to implement the systems and methods presented above.

### Machine Learning Techniques

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using back propagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMS prop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

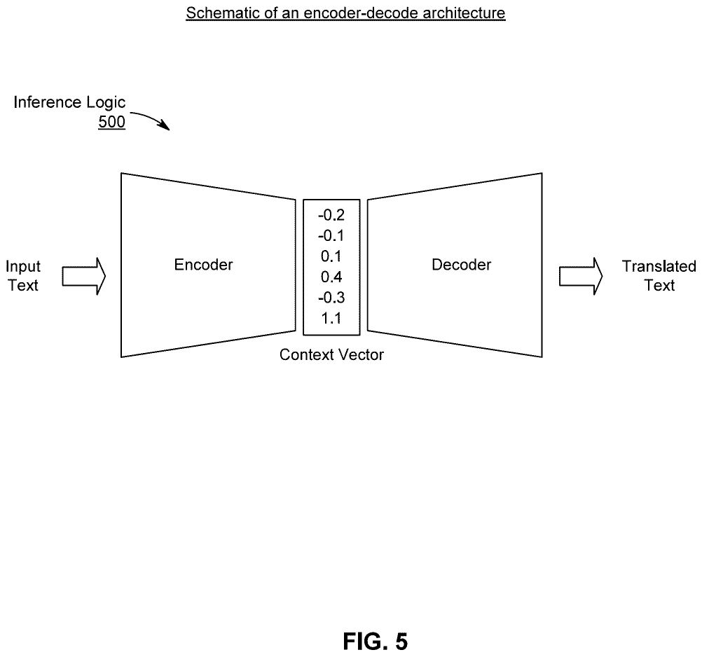

FIG. 5 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using back propagation, a method of training a neural network in which the initial system output is compared to the desired output and the system is adjusted until the difference is minimized. In back propagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

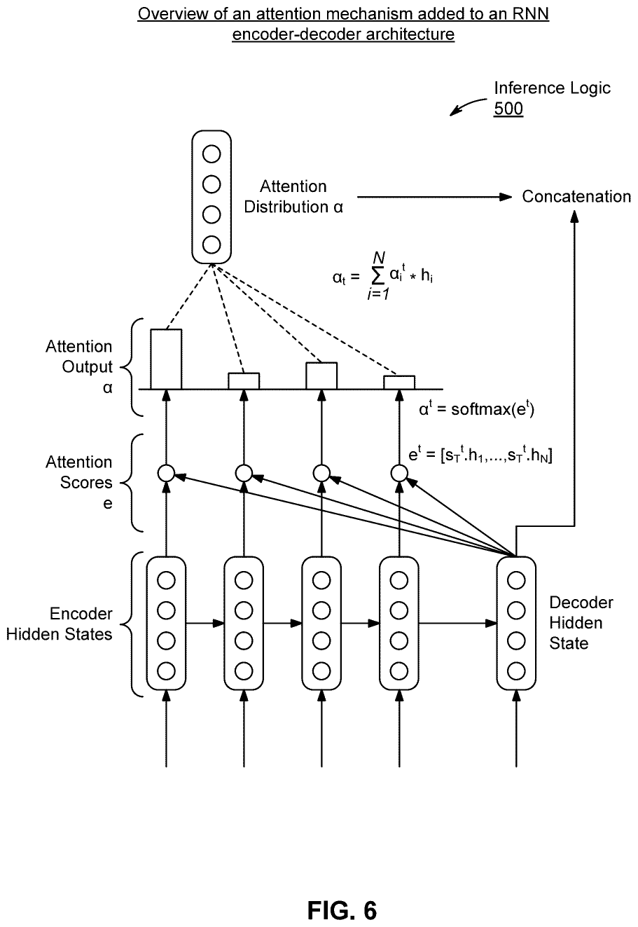

Attention mechanisms distinguish Transformers from other machine learning models. The attention mechanism provides a solution for the vanishing gradient problem. FIG. 6 shows an overview of an attention mechanism added to an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

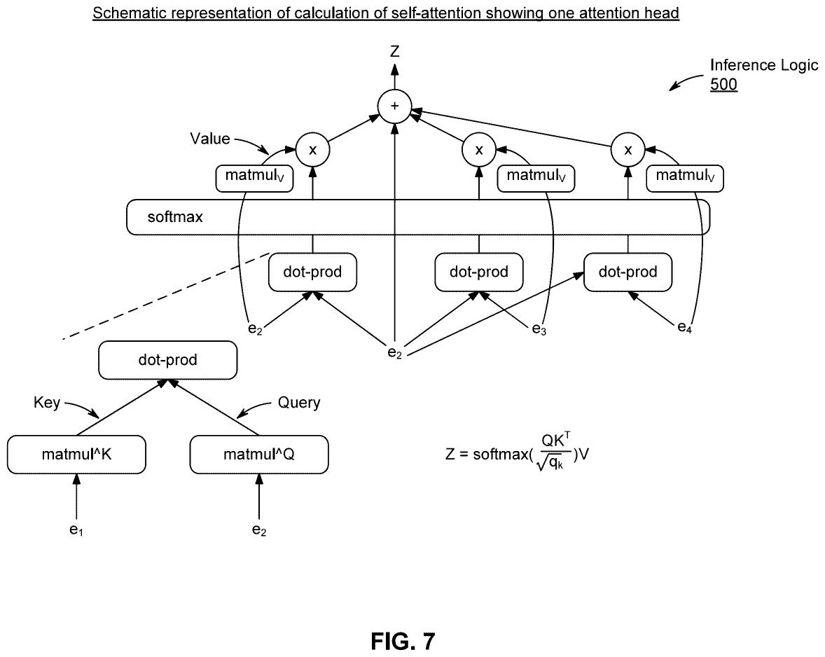

Multi-headed attention is executed in the Transformer. FIG. 7 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

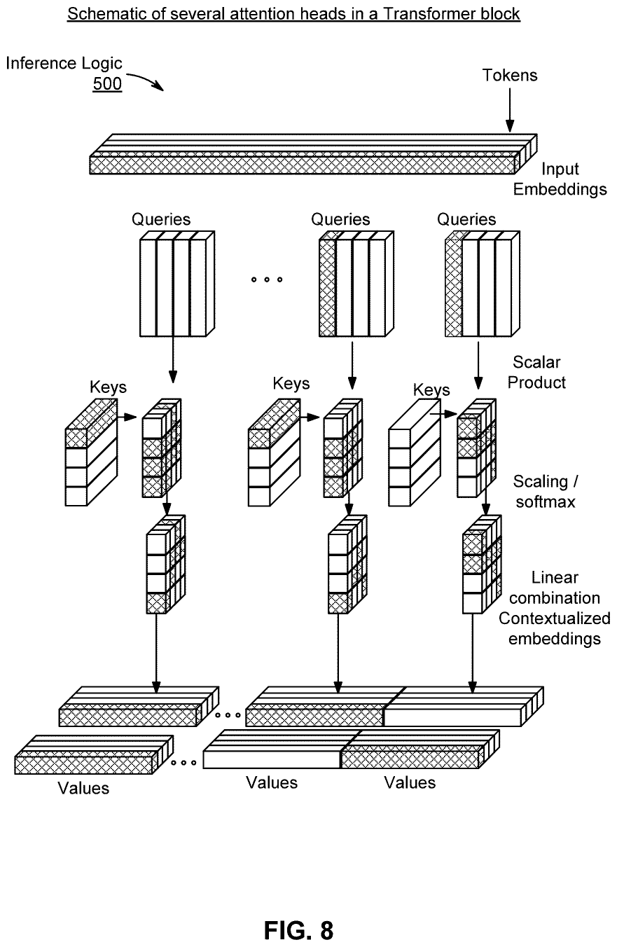

FIG. 8 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{Q {K}^{T}}{\sqrt{d k}} ) V$$

where Q, K, V are computed as:

X·W_{Q}, X·W_{K}, X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

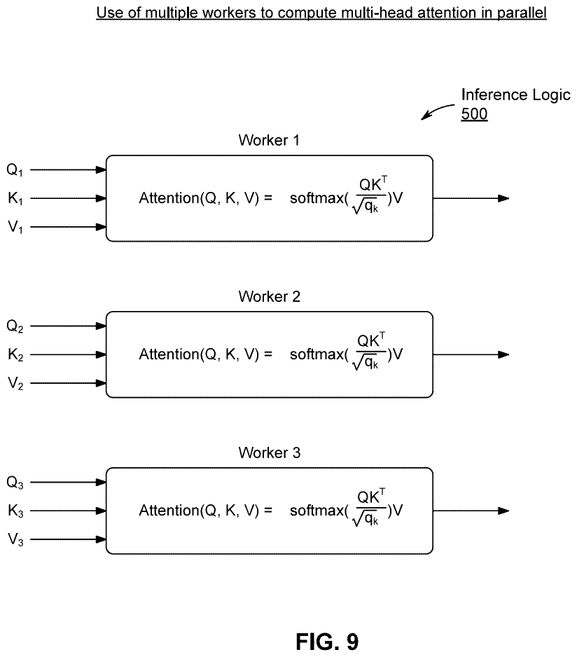

As shown in FIG. 9, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q}, X·W_{K}, X·WV

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of SoftMax

$$( \frac{Q {K}^{T}}{\sqrt{d k}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product SoftMax

$$( \frac{Q {K}^{T}}{\sqrt{d k}} ) \cdot V$$

is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

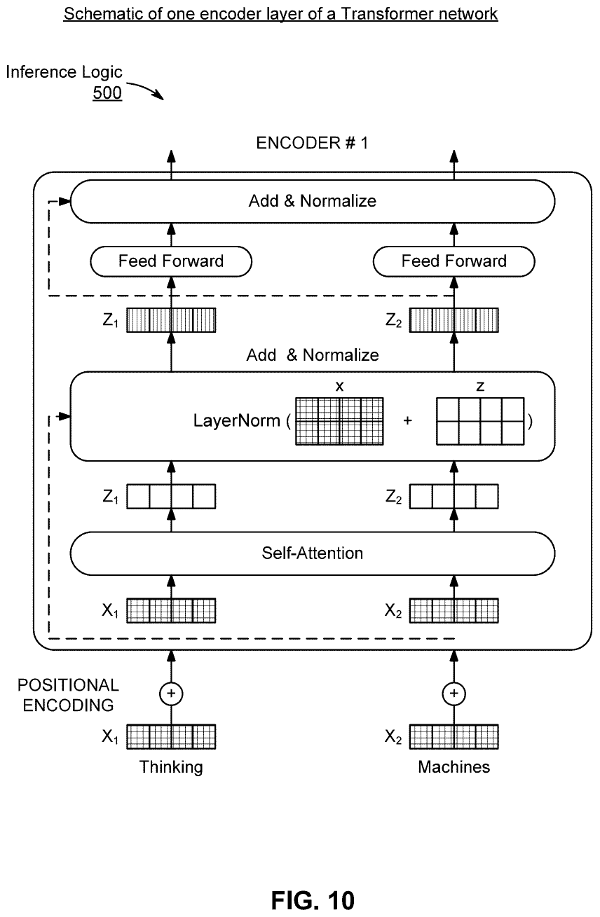

FIG. 10 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

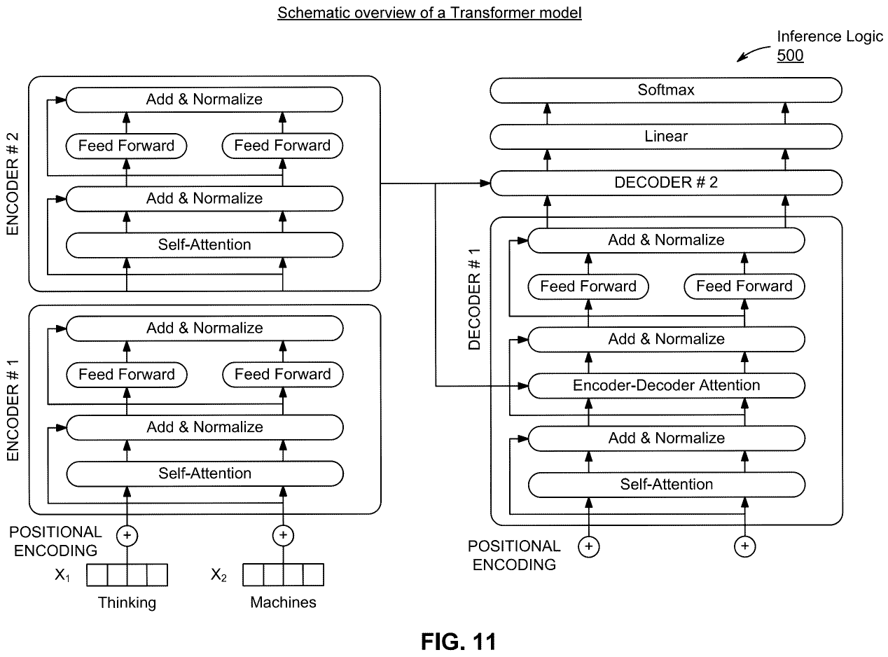

FIG. 11 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

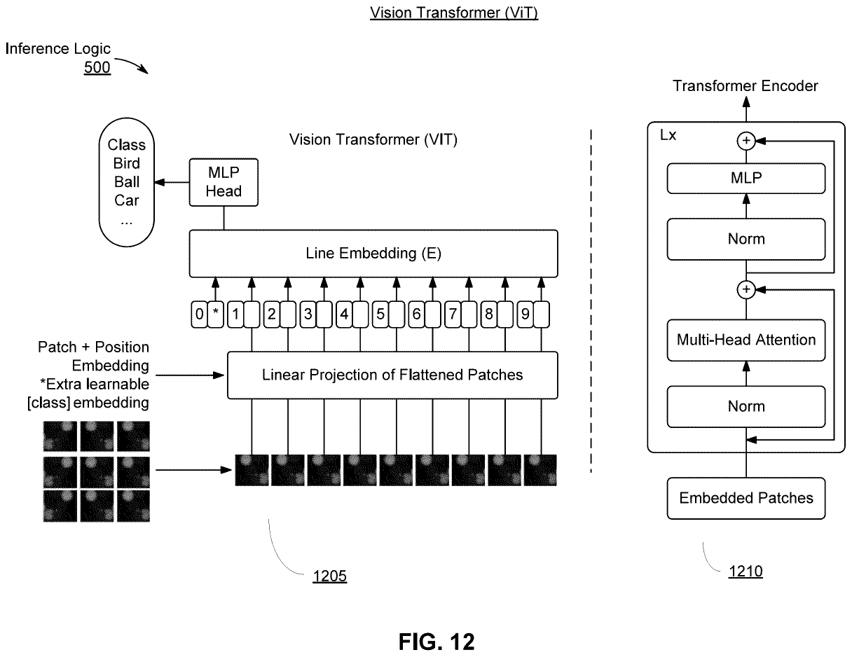

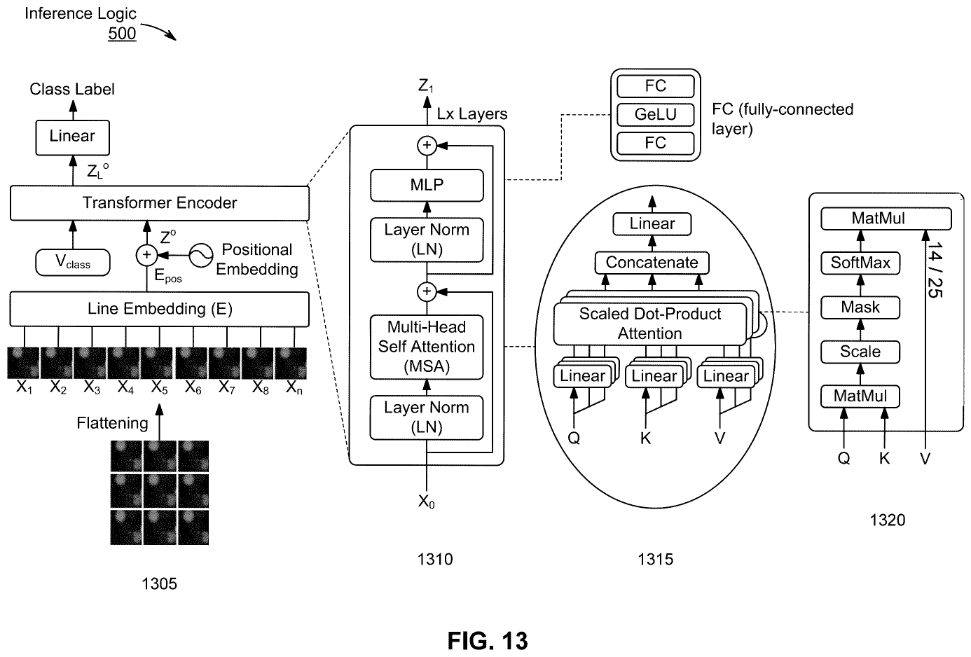

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIGS. 12 (1205 and 1210) and FIGS. 13 (1305, 1310, 1315 and 1320). Unfortunately, important positional information is lost because image sets are position-invariant. This problem is solved by adding a learned positional encoding into the image patches.

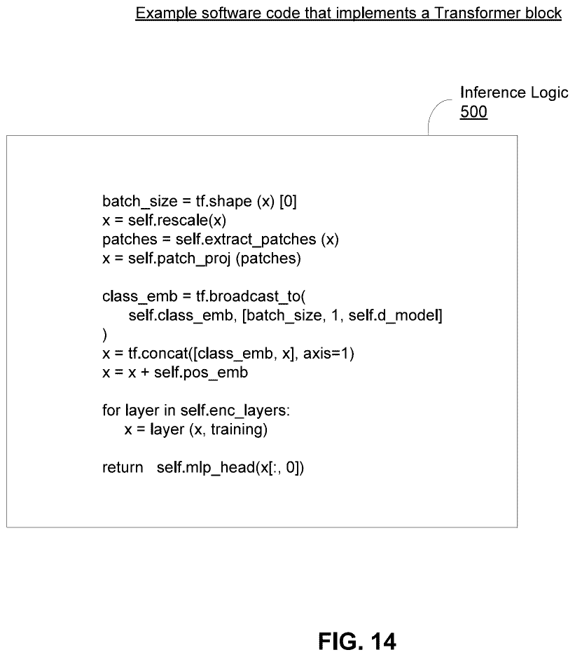

The computations of the ViT architecture can be summarized as follows. The first layer of a ViT extracts a fixed number of patches from an input image (1205 in FIG. 12). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 14.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block (1210) in FIG. 12, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the technology disclosed, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Language Models and Artificial Intelligence Agents

The following detailed description of the figures provides a technical exposition of large language model (LLM)-based agents, language modeling methodologies, enhancement techniques, integration protocols, and computational infrastructure. Large language model-based agents differ fundamentally from back propagation-driven deep learning systems because their core behavior is governed not primarily by parameter updates, but by inference-time control structures that operate through prompting, contextual conditioning, and dynamic retrieval. Whereas legacy deep learning models rely on supervised datasets, gradient descent, and static weight modification to effect behavioral change, LLM-based agents adapt their operation through system prompts, hierarchical instruction scaffolds, retrieval-augmented generation (RAG) pipelines, low-rank adaptation (LoRA) overlays, Model Context Protocol (MCP) tool interfaces, chain-of-thought reasoning, self-consistency decoding, reinforcement learning from human feedback (RLHF), plan-and-execute orchestration, introspection mechanisms, multi-modal grounding, session-specific memory embeddings, and distributed multi-agent coordination frameworks.

An AI agent (also referred to as an agent or an artificial intelligence agent) is a stateful control architecture that models perception, decision, and action over an environment. It uses one or more LLMs as inference engines inside its policy but augments them with persistent state, memory subsystems, tool interfaces, orchestration logic, and policy enforcement mechanisms that are not part of the underlying language model itself.

In LLM-native systems, the primary locus of computation shifts from offline training to runtime orchestration. System prompts define persistent operational policies; RAG injects real-time, externally maintained knowledge into the model's attention space; LoRA modules provide orthogonal, dynamically loadable specialization layers; and MCP schemas and tool APIs expose external applications and services as structured objects in the model's output vocabulary. Chain-of-thought and self-consistency mechanisms support multi-step internal deliberation and verification prior to committing to actions, while introspection tools enable runtime evaluation and error correction. RLHF further guides adaptive, context-sensitive, reward-aligned behavior.

Multi-modal grounding integrates visual, auditory, or structured interface embeddings with textual instructions to generate perceptually aligned action tokens. Session-specific memory stores, retrieval mechanisms, and summarization policies preserve long-horizon task continuity. Concurrent and distributed agent coordination is achieved through model-mediated message tokens and concurrency-control directives, enabling multiple agents to negotiate, resolve dependencies, and execute collaborative workflows in real time. Collectively, these mechanisms enable adaptive, tool-conditioned, continuously evolving behavior that emerges from inference-time context and structured memory rather than from weight-space optimization, establishing a computational paradigm that is categorically distinct from training-centric deep learning architectures and centered on inference-time generative, autonomous agency.

The figures illustrate the evolution of language models from statistical approaches to contemporary large language models, and in particular to LLM-based agents. The description includes prompt-engineering techniques that structure input to optimize model behavior through system prompts defining roles, guidelines, and constraints. Subsequent description and corresponding figures present Retrieval-Augmented Generation (RAG) systems that integrate external knowledge sources with generative models through retriever and generator components, as well as agentic intelligence architectures in which autonomous agents employ memory systems, planning mechanisms, and tool access to enable dynamic decision-making.

The figures further depict inference hardware structures comprising memory modules and computing hardware for neural network operations, with deployment configurations ranging from edge-device systems to distributed data center architectures. Detailed exposition is provided for the Model Context Protocol (MCP), a standardized communication specification enabling AI applications to access external data sources and services through MCP hosts, clients, and servers that expose tools, resources, and prompts. The integrated system architectures that combine prompt engineering, MCP-orchestrated context retrieval, and Low-Rank Adaptation (LoRA) for parameter-efficient model customization are also presented. The description specifies component functionalities, operational workflows, communication patterns, and architectural principles in sufficient detail to enable understanding and implementation by persons having ordinary skill in the art.

### Language Models

Language modeling (LM) is a primary technique used to advance the language intelligence of machines. The development of language models can be divided into four main stages: statistical language models, neural language models, pre-trained language models, and large language models (LLMs).

Statistical language models were primarily used in specific tasks (e.g., retrieval or speech processing) in which predicted or estimated token probabilities improved the performance of task-specific pipelines. Neural language models shifted focus toward learning task-agnostic representations (e.g., feature embeddings), thereby reducing the need for manual feature engineering. Pre-trained language models learned context-aware representations that could be fine-tuned or otherwise optimized for downstream tasks.

The latest generation, LLMs, extend these advances by exploiting scaling effects in model capacity (e.g., parameter count, context window size, and training corpus size), and by leveraging transformer-based architectures. In practice, LLMs function as general-purpose task solvers that can be adapted to a broad range of applications via prompting, lightweight adaptation, and orchestration, rather than by task-specific architectural redesign.

### Prompt

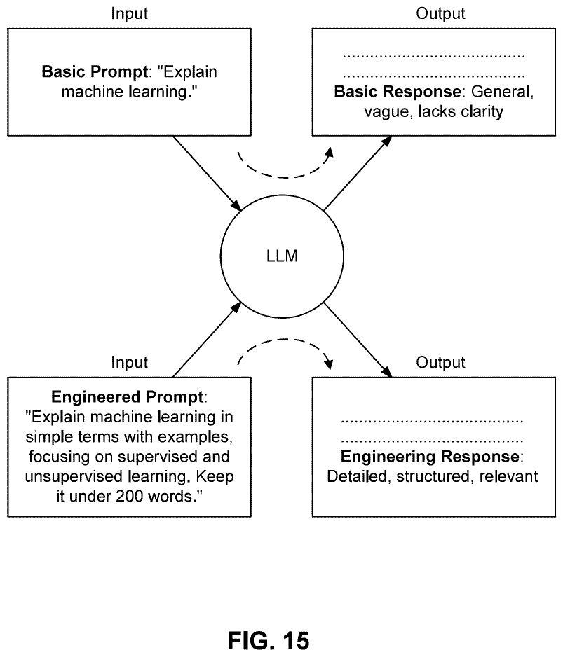

FIG. 15 illustrates a comparison between responses generated by a large language model when provided with a basic prompt and when provided with a more sophisticated, engineered prompt. This comparison highlights the importance of prompt engineering. A basic prompt tends to produce a basic, often vague response, whereas an engineered prompt tends to yield a more structured, detailed, and higher-quality response.

Prompting is a widely used method for leveraging LLMs to solve diverse tasks. The process of creating an effective prompt is referred to as prompt engineering. Well-structured and context-rich prompts enable LLMs to generate more accurate, relevant, and detailed responses, while poorly specified prompts often result in unstructured, ambiguous, or incomplete outputs. Prompt engineering therefore improves the accuracy, coherence, and factual consistency of LLM responses.

A broad spectrum of prompting techniques is available. At one end of the spectrum, zero-shot prompting (e.g., “Summarize this”) provides minimal contextual guidance. At the other end, comprehensive prompt-engineering frameworks supply highly structured prompting strategies, incorporating explicit roles, constraints, examples, and multi-step reasoning scaffolds.

Few-shot prompting lies between these extremes and often yields substantial improvements in response quality. In few-shot prompting, the prompt includes a small number of task examples (input-output pairs), also referred to as few-shot demonstrations. These demonstrations help the LLM internalize the semantic mapping between input and output for the task at hand without requiring parameter updates.

An example of a few-shot prompt is shown below:

[
convert each word into its number of letters
Example 1:
Word: “Tree”
Output: 4
Example 2:
Word: “House”
Output: 5
Example 3:
Word: “Ant”
Output: 3
Now complete
Word: “Planet”
Output:
] [symbol]
et Dₖ = {f(x₁, y₁), ..., f(xₖ, yₖ)} represent a set of demonstrations with k
examples, where f(xₖ, yₖ)) is the prompt function that transforms the k-th task example into
natural language prompts. Given the task description I, demonstration Dₖ, and a new input query
xₖ₊₁, the prediction of the output ŷₖ₊₁ generated from LLMs can be formulation as follows: [symbol]
LLM (I, f(x₁,y₁),...,f(xₖ,yₖ), f(xₖ₊₁, _{——}) → ŷₖ₊₁
Demonstrations Input Answer

Where the actual answer yₖ₊₁ is left as blank to predicted by the LLM. In this formulation, the demonstrations serve as in-context training signals, the new input forms the query, and the predicted answer is generated by the model at inference time.

Few-shot prompting is commonly used across a variety of natural language processing (NLP) applications, such as:
Text Classification: “Classify this new review based on the given positive and negative examples.”
Machine Translation: “Translate these English sentences into Spanish. Now translate the following text.”
Code Generation: “Complete the missing function given these input-output pairs.”
Question Answering: “Answer factual questions based on the provided example Q&A pairs.”

### System Prompt

System prompts are predefined instructions that guide an LLM's behavior when responding to user queries and thus play a critical role in the effective performance and functionality of an LLM. A system prompt defines the model's role, behavioral constraints, objectives, and style, thereby acting as a soft form of policy shaping within the model's learned distribution.

Operationally, the system prompt functions as input-side control: it steers the model by modifying the contextual information on which the model conditions, without altering the underlying model parameters. System prompts may include proprietary or sensitive information about the organization that owns or operates the model, such as private system instructions, proprietary guidelines, functionality descriptions, architectural details, limitations, permission disclosures, role definitions for different classes of users, and basic safety-guardrail configurations.

An example system prompt is provided below:
“You are a travel itinerary assistant. You will help users create personalized trip plans based on their preferences and input regarding destination, budget, interests, and time constraints. Ensure that each itinerary includes essential details, such as accommodation options, transportation methods, key attractions, dining options, and free-time activities. Consider factors like user preferences for pace, specific requests for cultural experiences, or outdoor adventures if mentioned. Use up-to-date information about the destinations and include safety tips where necessary. Make sure that each itinerary is well-balanced, reasonable in terms of time, and enjoyable for the user.”

Guidelines associated with this system prompt may include:
Always prioritize user-driven preferences for destinations and activities.
Deliver a balance between exploration and relaxation within the itinerary.
Offer insights into local culture and practices relevant to the destination.
Help users maximize value for money in booking and planning.
Create itineraries that provide satisfying and meaningful experiences for both family and individual travelers.

### Retrieval-Augmented Generation (RAG)

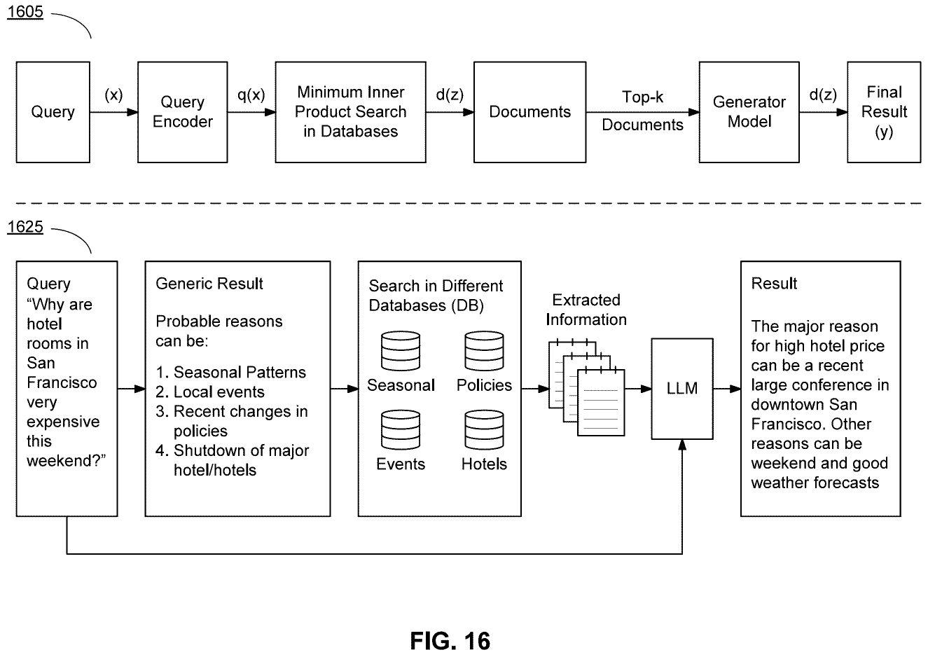

FIG. 16 illustrates a high-level overview of a Retrieval-Augmented Generation (RAG) workflow. RAG is a technique that enhances the capabilities of large language models by combining their generative power with the ability to access and retrieve information from external knowledge sources. This hybrid approach addresses a key limitation of traditional LLMs, which are constrained by the static nature of their training data. While LLMs excel at generating coherent and contextually relevant text, they may lack access to the most recent information or to specialized knowledge that is not contained in their training corpus.

RAG bridges this gap by combining the strengths of retrieval-based systems and generative models. During the generation process, a RAG system first retrieves relevant documents or information from an external knowledge source, such as a database, knowledge graph, or document collection. The retrieved information is then used to augment the input provided to the LLM, enabling the model to generate responses grounded in factual and contextually relevant knowledge. For example, in open-domain question answering, a RAG system can retrieve relevant passages from a large corpus of documents and then use them as context for generating accurate and detailed answers.

A typical RAG framework comprises two primary components: a retriever and a generator. The retriever identifies and fetches the most relevant information from the external knowledge source, while the generator (the LLM) incorporates this retrieved information into a coherent and contextually appropriate response. This combination allows RAG systems to perform tasks that require broad knowledge and precise reasoning, such as answering complex questions, summarizing lengthy documents, or providing grounded explanations.

One of the principal advantages of RAG is its ability to handle knowledge-intensive tasks with improved accuracy and relevance. By leveraging external knowledge sources, RAG helps ensure that generated responses are not only fluent but also factually accurate and up to date. This makes RAG particularly valuable in domains such as customer support, medical diagnosis, and legal research, where factual precision and access to specialized knowledge are critical.

FIG. 16 presents a high-level schematic of RAG operation. A top portion of FIG. 16, labeled 1605, illustrates the RAG framework and the retrieval and generation phases for enhancing LLM responses with external knowledge as described above. A bottom portion of FIG. 16, labeled 1625, presents an example use case demonstrating how retrieved content is combined with a user query to produce a grounded response.

### Agentic Intelligence

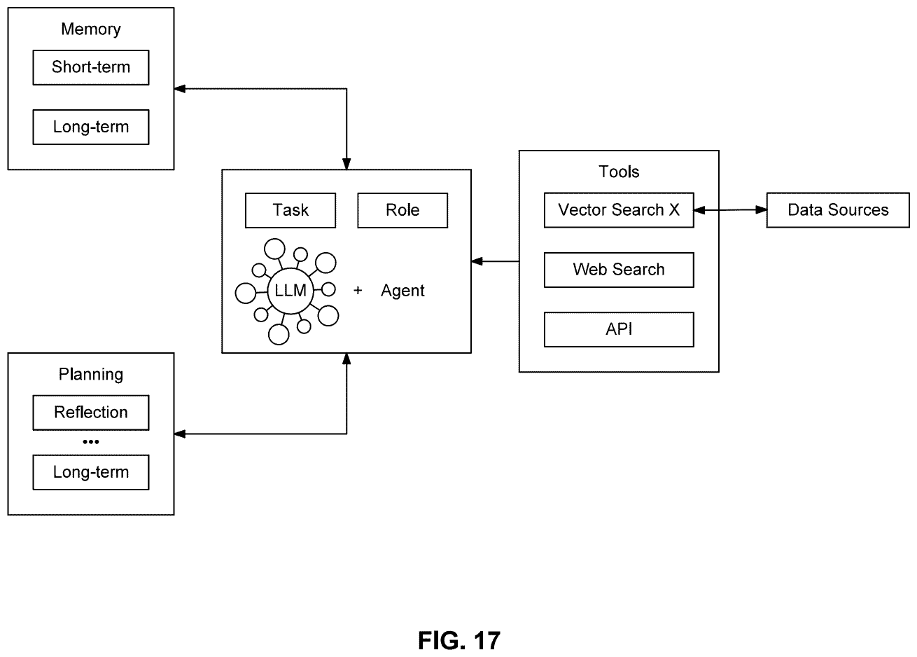

FIG. 17 illustrates an overview of artificial intelligence (AI) agents. Agentic intelligence forms the foundation of Agentic Retrieval-Augmented Generation (Agentic RAG) systems, enabling them to move beyond the static and reactive behavior of conventional RAG pipelines. By integrating autonomous agents capable of dynamic decision-making, iterative reasoning, and collaborative workflows, Agentic RAG systems exhibit enhanced adaptability, robustness, and precision.

In essence, and as depicted in FIG. 17, an AI agent comprises:
LLM with defined Role and Task: The LLM serves as the agent's primary reasoning engine and dialogue interface. It interprets user queries, executes internal reasoning, generates responses, and maintains conversational coherence.
Memory (Short-Term and Long-Term): Memory subsystems capture context and relevant data across interactions. Short-term memory tracks the immediate conversational state and local task context, while long-term memory stores accumulated knowledge, user preferences, and prior agent experiences that can be reused across sessions.
Planning (Reflection and Self-Critique): A planning component guides the agent's iterative reasoning process through reflection, query routing, error analysis, or self-critique. This component enables the agent to decompose complex tasks into intermediate steps, evaluate alternatives, and refine strategies over multiple interaction turns.
Tools (Vector Search, Web Search, APIs, etc.): Tool interfaces extend the agent's capabilities beyond pure text generation by enabling access to external resources, real-time data, and specialized computations (e.g., vector search over embeddings, web search, database access, or domain-specific APIs).

### Agentic RAG

Agentic RAG combines the capabilities of agentic AI and RAG. In an Agentic RAG system, autonomous, goal-oriented software agents dynamically retrieve, select, and process information. These agents can perform query routing, step-by-step planning, and decision-making, and can invoke other software tools, services, or agents to obtain more accurate or more complete results.

Agentic RAG systems typically maintain explicit memory structures for planning and for recalling previous prompts, user attributes, or session state. This design improves scalability (by orchestrating multiple tools and agents), flexibility (by dynamically selecting strategies based on context), and context awareness (by grounding retrieval and generation in a persistent memory and tool environment).

Key characteristics of Agentic RAG include:
Autonomous Decision-Making: Agents independently evaluate and manage retrieval strategies based on query complexity, task objectives, and prior outcomes.
Iterative Refinement: Feedback loops are incorporated to refine retrieval results and generated responses, improving accuracy and relevance over multiple iterations.
Workflow Optimization: Tasks are orchestrated dynamically, enabling efficient execution in real-time or near-real-time applications, and allowing the system to adapt to resource constraints and latency requirements.

### Inference Hardware

The lifecycle of an AI model generally involves two distinct phases: a training phase, during which model weights are optimized against a large body of training data, and an inference phase, during which the trained model responds to user prompts or other inputs. In the inference phase, the model is “frozen” (i.e., its weights are fixed) and used to generate outputs, such as predicted token sequences, in response to prompts or context. As model sizes and context windows have increased, the computational and memory requirements during inference have grown substantially, shifting design considerations toward efficiency, low latency, and high throughput. An exemplary system for AI model inference is described below.

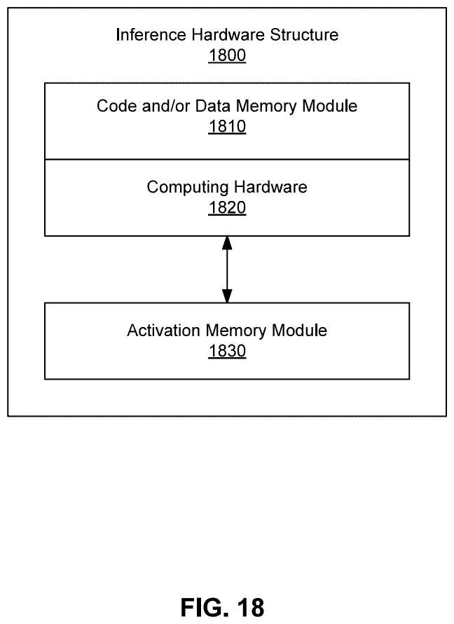

FIG. 18 shows an inference hardware structure 1800 used to perform inferencing operations in at least one implementation. Inference hardware structure 1800 is described with reference to FIG. 18.

Inference hardware structure 1800 may include a code and/or data memory module 1810 for storing trained model weights, input/output data, and other parameters used to configure neurons or layers of a trained neural network during inference. Inference hardware structure 1800 can include, or be coupled to, code and/or data memory module 1810 for storing graph code or additional software that controls the timing and order in which inference logic (500) is configured. For example, inference logic may be configured by loading weights and other parameters in low-precision numerical formats such as FP16, BF16, FP8, INT8, or INT4.

Code and/or data memory module 1810 can be associated with a dedicated computing resource, such as computing hardware 1820. Computing hardware 1820 may comprise one or more processors that perform mathematical functions, such as linear algebraic operations and matrix computations. These mathematical functions are performed on information stored in code and/or data memory module 1810, producing results that are stored in an activation memory module 1830.

Executable code (e.g., graph code) can load weights and other parameter information into computing hardware 1820. Code and/or data memory module 1810 may be used during forward propagation of input data and/or weight parameters during inference, producing results that may include intermediate values or activations (e.g., one or more output values from a layer or neuron of the trained neural network) stored in activation memory module 1830.

Code and/or data memory module 1810 and activation memory module 1830 may be implemented as separate memory structures, as a combined memory structure, or as partially combined and partially separate structures. Any portion of code and/or data memory module 1810 and/or activation memory module 1830 may comprise other on-chip or off-chip memory, such as a processor's L1, L2, or L3 cache, or system memory. Any portion of these modules may be internal or external to one or more processors or other hardware logic devices or circuits.

Code and/or data memory module 1810 and/or activation memory module 1830 may be implemented using cache memory, dynamic random access memory (DRAM), static random access memory (SRAM), non-volatile memory (e.g., flash memory), high-bandwidth memory (HBM), double-data-rate (DDR) RAM, single-data-rate (SDR) RAM, or other storage technologies. The choice of whether each module (e.g., each code and/or data memory module 1810 and each activation memory module 1830) is internal or external to a processor (e.g., DRAM vs. SRAM vs. flash vs. HBM vs. DDR RAM vs. SDR RAM) may depend on various factors, including available on-chip versus off-chip storage, the latency requirements of inference functions, batch size, and other performance constraints. Code and/or data memory module 1810 and/or activation memory module 1830 may also be associated with larger off-chip storage such as DRAM, NVMe devices, solid-state drives, or disk-based storage to support low-latency inference at scale.

Computing hardware 1820 may comprise one or more processors or other hardware logic devices or circuits. A processor may include one or more of the following: central processing units (CPUs), graphics processing units (GPUs), fixed-function units, or other specialized units. Code and/or data memory module 1810 and activation memory module 1830 may share a processor or other hardware logic device or circuit; alternatively, they may be associated with different processors or hardware logic devices, or with a combination of shared and distinct processors and logic resources.

In some implementations, computing hardware 1820 comprises one or more processors, wherein each processor may include at least one of: an application-specific integrated circuit (ASIC), such as a tensor processing unit (TPU), a neural processing unit (NPU), an inference processing unit (IPU), or other domain-specific processing units. Each processor of computing hardware 1820 may include CPU hardware, GPU hardware, or other hardware such as field-programmable gate arrays (FPGAs), in-memory-compute (IMC) hardware, or other domain-specific hardware. In some implementations, computing hardware 1820 is implemented as a system-on-a-chip (SoC).

Inference hardware structure 1800 may be used in conjunction with ASICs (such as TPUs or NPUs), IPUs, or other domain-specific processing units. In some implementations, inference hardware structure 1800 is used in conjunction with CPU hardware, GPU hardware, or other hardware such as FPGAs or IMC hardware. In other implementations, inference hardware structure 1800 itself may be implemented as a SoC.

Inference hardware structure 1800 may further include hardware logic that directs the use of computational resources in conjunction with weight values, other parameters, input/output data, and other information corresponding to one or more layers of neurons within a trained neural network. In one implementation, inference hardware structure 1800 includes a single memory-module/compute pairing (e.g., code and/or data memory module 1810 paired with computing hardware 1820). In other implementation, inference hardware structure 1800 includes multiple memory-module/compute pairings, with each pairing producing results that are stored in activation memory module 1830.

Inference hardware structure 1800 may further include one or more interconnect interfaces to receive input data, send output data, or transmit data between hardware components (e.g., within a node/server or across racks of servers). Such interconnects may include, for example, PCIe, CXL, NVLink, Ethernet, UALink, or others. These interconnects may carry command signals, dataflow control signals, and memory-transfer operations that regulate the order and timing of inference operations.

Inference hardware structure 2000 may operate as a standalone component, for example in an edge-device system as shown in FIG. 18, or may be integrated within a larger computing system, cluster, or data-center environment, as depicted in FIG. 18. In such standalone and/or integrated environments, one or more computing hardware 1820 structures may form a portion of a node computing resource within an infrastructure layer, while software and framework layers coordinate loading of model weights and parameters, dispatch inference workloads, and retrieve predicted outputs. The following sections provide further detail regarding inference hardware within standalone and integrated environments.

Edge-Device Inference System with Inference Hardware

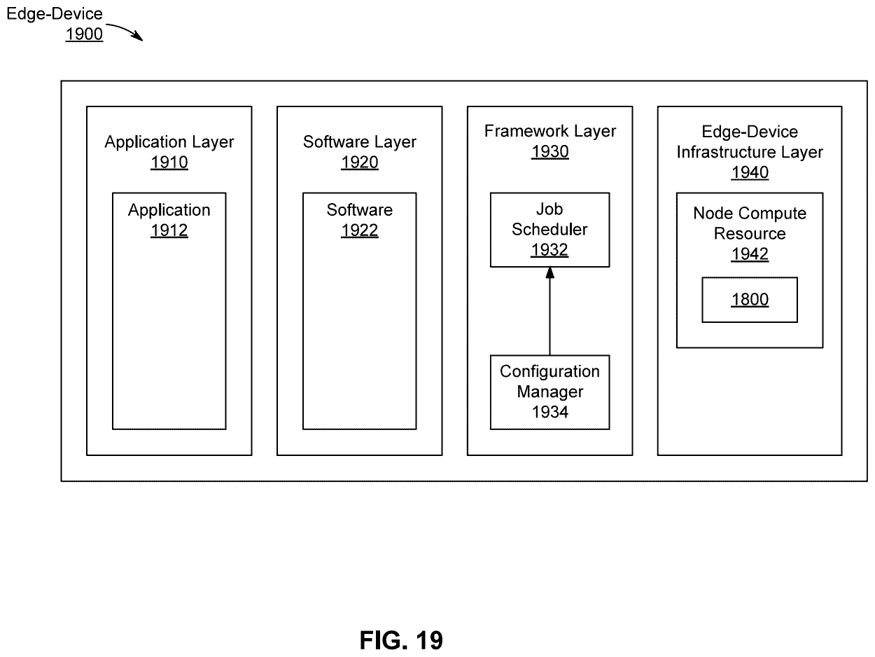

As shown in FIG. 19, an edge-device inference system 1900 is an example of an integrated system for performing inference using a trained model, such as a trained neural network. Edge device system 1900 may ingest data at the edge, providing real-time output data; low latency in such an environment can significantly improve inference performance.

FIG. 19 illustrates an exemplary edge-device inference system 1900. Edge device system 1900 can include an application layer 1910, a software layer 1920, a framework layer 1930, and an edge-device infrastructure layer 1940. These layers cooperate to execute inference operations using a trained neural network with fixed, known weight parameters.

Edge-device infrastructure layer 1940 may include a node compute resource 1942. Node compute resource 1942 comprises inference hardware structure 1800 and may be implemented as a SoC. Node compute resource 1942 may include, in addition to the one or more processors of inference hardware structure 1800, at least one CPU or other processors (including accelerators such as ASICs, GPUs, FPGAs, NPUs, etc.), memory (e.g., DRAM, HBM, flash, DDR RAM, SDR RAM, etc.), network input/output devices (e.g., network interface cards (NICs)), network switches, power modules, cooling modules, and other supporting components.

Framework layer 1930 may include a job scheduler 1932 and a configuration manager 1934. Framework layer 1930 provides a framework to support software 1922 in software layer 1920 and one or more applications 1912 in application layer 1910. Framework layer 1930 can implement a runtime coordination system that adjusts inference execution based on the physical constraints of edge device system 1900. Job scheduler 1932 may assign inference tasks to available compute units in node compute resource 1942, while configuration manager 1934 may configure software layer 1920 and framework layer 1930, load trained model files, configure memory buffers, and establish runtime properties such as quantization settings.

Software 1922 in software layer 1920 may include an operating system, device drivers, local data stores, and service processes configured to receive inference requests, pre-process input data, interface with applications 1912 in application layer 1910 (e.g., machine learning applications), and return predicted outputs.

Applications 1912 in application layer 1910 may include one or more types of applications used by portions of node compute resource 1942. These applications may include machine-learning applications, inference engines, and machine-learning framework software (e.g., PyTorch, TensorFlow) as well as domain-specific applications that rely on inference services.

Inference logic corresponding to inference hardware structure 1800 is used to perform inference operations as described herein in conjunction with FIG. 18. In particular, inference logic within inference hardware structure 1800 can be used in edge device inference system 1800 for operations based, at least in part, on weight parameters of a trained neural network. Edge device inference system 1800 may include tools, services, software, or other resources to predict or infer information using one or more trained machine-learning models.

Data Center Inference System with Inference Hardware

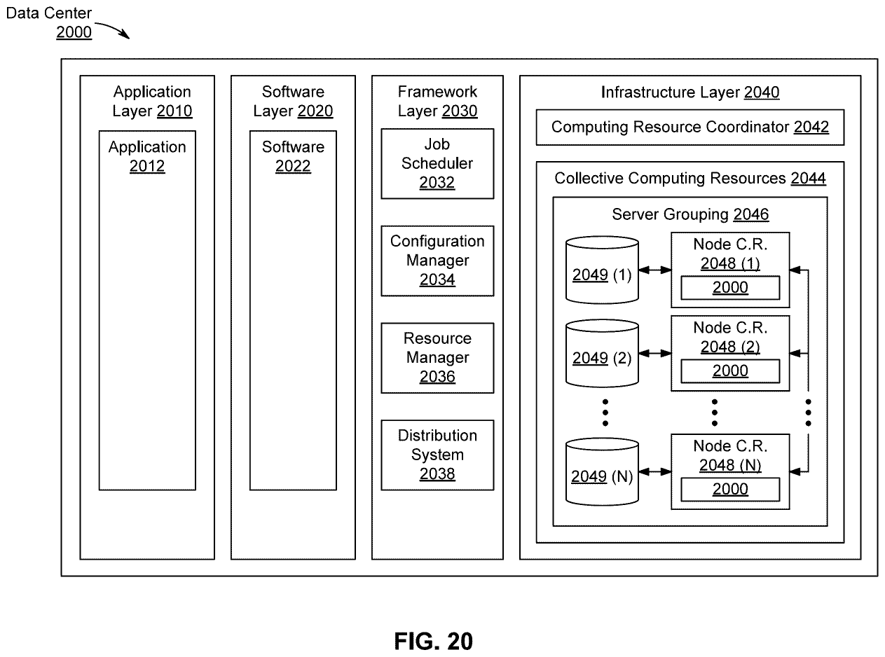

FIG. 20 illustrates a data center 2000 that may include an application layer 2010, a software layer 2020, a framework layer 2030, and an infrastructure layer 2040. Data center 2000 may execute inference operations such as forward-propagation computations to generate predicted outputs from input data, while providing increased efficiency, scalability, and reduced latency.

Data center 2000 can be organized into a multilayer architecture in which infrastructure layer 2040 comprises a computing resource coordinator 2042, collective computing resources 2044, server grouping 2046, and a plurality of node computing resources (node C.R.s) 2048(1)-2048 (N), where N is a positive integer. Each node C.R. 2048 (i) may include one or more CPUs or other processors (e.g., accelerators such as ASICs, GPUs, FPGAs, etc.), memory storage devices 2049(1), 2049(2) to 2049(N) (e.g., DRAM, NVMe, solid-state drives (SSDs), or disk-based storage devices), network input/output components, network switches, virtual-machine hosts, power regulation modules, and cooling assemblies. In some implementations, each node C.R. corresponds to a complete physical or virtual server.

Collective computing resources 2044 may include at least one server grouping 2046, representing a logical grouping of node C.R.s such as one or more server racks. Server grouping 2046 may be deployed in a single data-center location (non-distributed) or geographically distributed. Server grouping 2046 and/or collective computing resources 2044 may pool compute, network, or memory resources to process inference workloads.

Computing resource coordinator 2042 configures, allocates, manages, and coordinates each node C.R. and resources within server grouping 2046 and/or collective computing resources 2044. Computing resource coordinator 2042 (e.g., Kubernetes, Slurm, or other resource managers) may coordinate hardware and software resources, such as compute, storage, and network capabilities of infrastructure layer 2040. Computing resource coordinator 2042 may perform software-defined infrastructure control operations to allocate inference workloads in data center 2000.

Framework layer 2030 may include a job scheduler 2032, a configuration manager 2034, a resource manager 2036, and a distribution system 2038. Framework layer 2030 supports software 2022 in software layer 2020 and one or more applications 2012 in application layer 2010. For example, framework layer 2030 may receive inference queries or pre-processed input data from software layer 2020 or application layer 2010 and return predicted outputs for post-processing and delivery to users or client systems.

Job scheduler 2032 may be implemented using a distributed processing framework, such as Apache Spark™, and can leverage distribution system 2038 for large-scale data processing. Distribution system 2038 may provide input data, model files, and other assets needed for inference workloads. Job scheduler 2032 coordinates workloads across the layers of data center 2000. Configuration manager 2034 may configure software layer 2020 and framework layer 2030 (including Spark™ and distribution system 2038), generate configurations specifying model versions, precision formats, and hardware requirements, and provide such configurations to resource manager 2036. Resource manager 2036, in conjunction with computing resource coordinator 2042, identifies suitable node C.R.s 2048(1)-2048(N) for each workload, after which job scheduler 2032 dispatches the workloads to the selected nodes.

Software 2022 in software layer 2020 may include operating systems, database software, model-serving software, data-preparation software, and other components supporting inference operations and integration with applications.

Applications 2012 in application layer 2010 may be used by one or more node C.R.s 2048(1)-2048(N), collective computing resources 2044, and/or distribution system 2038. Applications 2012 may include machine-learning applications, analytics services, or other applications that rely on inference pipelines.

Trained machine-learning models corresponding to one or more trained neural networks can be used within data center 2000 to infer or predict information at scale.

The following description illustrates dataflow through data center 2000. This dataflow includes receipt of user input or pre-processed data, task configuration and scheduling within framework layer 2030, and execution of inference on node C.R.s 2048(1)-2048(N) to return predicted outputs. This discussion demonstrates how the layered architecture of data center 2000 supports efficient processing, parallelism, and low-latency delivery of inference results.

### Example: Dataflow Through Data Center Inference Hardware

Dataflow through data center 2000 may begin when an inference request is received at application layer 2010, for example as a data stream of user prompts or as data from an edge device. Received text may be stored in system memory (e.g., DRAM). Software layer 2020 may perform tokenization or other pre-processing operations on a host CPU, prepare one or more inference workloads corresponding to the tokenized inputs, and send these workloads to framework layer 2030 for scheduling and execution.

Framework layer 2030 coordinates distribution of the inference workloads. Job scheduler 2032 may consult resource manager 2036 to determine which node C.R.s 2048(1)-2048 (N) have sufficient available compute and memory to execute the workloads efficiently. Resource manager 2036, in conjunction with computing resource coordinator 2042, identifies suitable node C.R.s. Model files, weight tensors, and other runtime data may be loaded from distribution system 2038 (e.g., NVMe or a distributed filesystem) into DRAM and then into accelerator memory such as HBM.

Execution of inference workloads occurs within the allocated node C.R.s using one or more instances of inference hardware structure 1800. Inference results, including intermediate activations or final predicted outputs, may be returned from node C.R.s to job scheduler 2032, which can aggregate outputs when multiple nodes are involved. Framework layer 2030 then returns predicted outputs to software layer 2020 and/or application layer 2010 for post-processing, formatting, or delivery. The layered architecture of data center 2000 thus supports coordinated data movement and scalable execution of inference workloads.

### MCP Architecture

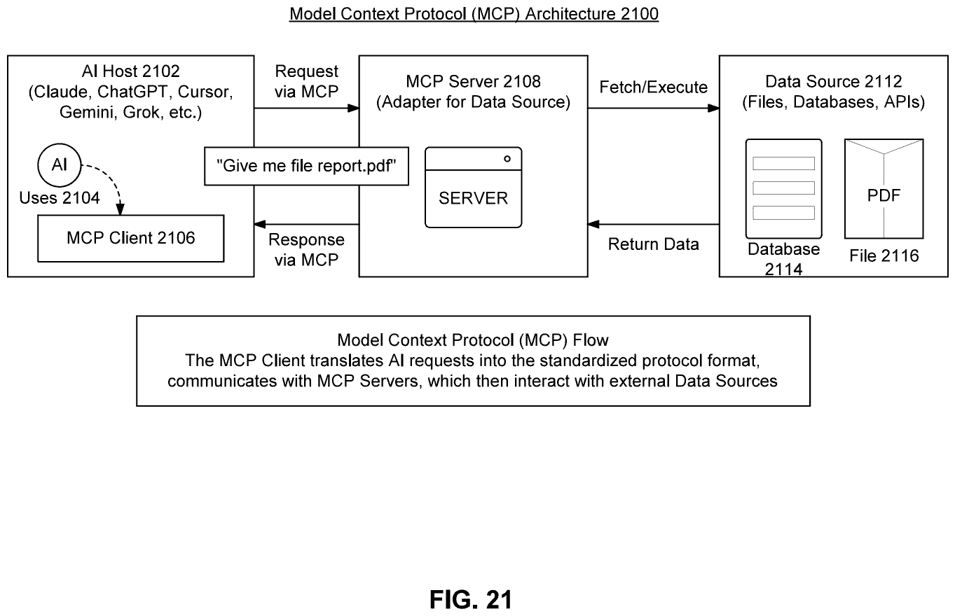

FIG. 21 is a system architecture diagram illustrating the Model Context Protocol (MCP) architecture 2100 and data flow between core components for processing AI requests through standardized protocol communication and interaction with external data sources.

The Model Context Protocol addresses the challenge of enabling AI applications to access external data sources, tools, and services in a standardized, secure, and interoperable manner. Traditional AI systems often require custom integration code for each external service, resulting in fragmented implementations and significant maintenance burdens. The MCP architecture solves this problem by introducing a universal protocol that acts as a standardized communication layer between AI applications and external systems, enabling any AI application to communicate with any MCP-compatible server without implementing bespoke integration code for each pairing.

The MCP architecture comprises three core components: an MCP host, an MCP client, and an MCP server, which collaborate to facilitate seamless communication between AI applications, external tools, and data sources. The architecture embodies (i) standardization, via a protocol specification defining message formats and communication patterns; (ii) modularity, via separation between AI logic and data-access logic; (iii) extensibility, via the ability to add new capabilities without modifying existing components; and (iv) security, via built-in authentication and authorization mechanisms.

The AI Host 2102 represents an AI application that provides the environment for executing AI-based tasks while running the MCP client. Examples include Claude Desktop (for AI-assisted content creation), ChatGPT (for conversational AI), and Cursor (for AI-powered integrated development and code-completion). AI Host 2102 integrates interactive tools and data to enable smooth communication with external services, hosts the MCP client, and ensures communication with external MCP servers.

Within AI Host 2102, an AI component 2104 represents the core artificial intelligence model or reasoning engine that generates requests, processes information, and produces outputs. AI component 2104 is operatively connected to MCP Client 2106, indicating that the AI component uses MCP Client 2106 to communicate with external systems. This connection enables AI component 2104 to access external functionalities and data sources, thereby augmenting its inherent knowledge with real-time information, user-specific data, and external computational resources.

MCP Client 2106 operates within the host environment as the protocol implementation layer. MCP Client 2106 acts as an intermediary component, maintaining a one-to-one communication link with a corresponding MCP Server 2108. Operating on behalf of the host, MCP Client 2106 initiates requests to MCP Server 2108, queries available functions, and retrieves responses describing the server's tools, resources, and capabilities. This design allows the host to access and use external functionalities provided by MCP servers 2108 in a uniform manner.

MCP Client 2106 performs request translation by converting high-level AI requests into standardized MCP protocol messages with defined schemas and data types. MCP Client 2106 also performs capability discovery by querying MCP Server 2108 to determine available tools, resources, and prompts. MCP Client 2106 manages connection lifecycle operations, including establishing secure connections, maintaining connection state, implementing authentication flows, and handling errors. MCP Client 2106 processes notifications from MCP servers 2108, providing real-time updates about task progress and system status, and performs sampling to gather data on tool usage and performance to support optimization and informed decision-making. MCP Client 2106 communicates with MCP Servers 2108 via a transport layer that facilitates secure, reliable data exchange.

A request via the MCP communication pathway extends from AI Host 2102 to MCP Server 2108, indicating transmission of requests using the Model Context Protocol. Communication begins with an initial request from MCP Client 2106 querying MCP Server 2108 regarding available functions, tools, resources, and capabilities. The protocol defines a structured message format including a message identifier, operation type, parameters, authentication information, and metadata.

An exemplary request, “Give me file report.pdf,” demonstrates a use case in which AI component 2104 requests access to a specific file resource. MCP Client 2106 translates this high-level request into a structured MCP protocol message specifying a resource-retrieval operation, identifying the target resource, including necessary parameters, and providing authentication credentials.

MCP Server 2108 enables the MCP host and client to access external systems and execute operations, functioning as an adapter that mediates access to external data sources. MCP servers 2108 implement an adapter pattern that encapsulates the logic required to interact with specific data sources, translating standardized MCP protocol operations into native operations required by those systems. As a result, adding support for new data sources typically requires only the implementation of a new MCP server 2108, without changes to AI applications or MCP clients 2106.

MCP Server 2108 provides three core capabilities: tools, resources, and prompts. Tools allow MCP Server 2108 to invoke external services and APIs to execute operations on behalf of AI models. When a host application needs to perform an operation, it first queries MCP Server 2108 via MCP Client 2106 to obtain a list of available tools and their capabilities. Based on task context, the host selects an appropriate tool and issues an invocation request via MCP Client 2106. MCP Server 2108 then executes the corresponding operation through an external service or API and returns the result to MCP Client 2106, which forwards the result to the host. For example, if an AI model requires real-time weather data, the host identifies a weather tool from the server's advertised capabilities, MCP Server 2108 performs the API call, and the resulting data is returned to the host.

Unlike traditional function-calling interfaces confined within a single model or framework, MCP tools are described and accessed through a standardized, model-agnostic protocol. This design allows tools to be dynamically discovered, described, and invoked across heterogeneous AI systems, ensuring cross-platform interoperability. MCP tools support bidirectional communication between a host and a service, enabling richer interactions such as asynchronous updates or event streaming. Once configured, these tools follow a supply-and-consume model that promotes modularity and reusability, allowing independently developed tools to interoperate seamlessly and improving system efficiency and extensibility.

Resources provide access to structured and unstructured datasets that MCP Server 2108 can expose to AI models. These datasets may reside in local storage, databases, or cloud platforms. When an AI model requests specific data, MCP Server 2108 retrieves and processes the relevant information, enabling the model to make data-driven decisions. For example, a recommendation system may access customer interaction logs, while a document summarization task may query a text repository. In the “report.pdf” example, MCP Server 2108 uses its resources capability to access the requested file from available sources.

Prompts are predefined templates and workflows that MCP Server 2108 generates and maintains to optimize AI responses and streamline repetitive tasks. They provide consistency in responses and improve task execution efficiency. For example, a customer-support chatbot may use prompt templates to ensure uniform and accurate responses, while an annotation workflow may rely on predefined prompts to maintain consistency in labeling across multiple annotators.

A response via the MCP communication pathway extends from MCP Server 2108 back to AI Host 2102, indicating transmission of responses using the Model Context Protocol. Upon receiving a request, MCP Server 2108 responds with an initial response listing available tools, resources, and prompts that MCP Client 2106 can use. The response message includes a message identifier, status indicator, response payload, and metadata. MCP Client 2106 processes the response and provides it to AI component 2104 within AI Host 2102.

A fetch/execute communication pathway extends from MCP Server 2108 to a Data Source 2112, indicating that MCP Server 2108 invokes external APIs or otherwise executes operations to retrieve and process information from external data sources. MCP Server 2108 may invoke external APIs using whatever protocols, authentication mechanisms, and access methods are required by those data sources. This isolation of data-source-specific details within MCP Server 2108 ensures that MCP Client 2106 and AI Host 2102 remain agnostic to whether data is sourced from SQL databases, REST APIs, file systems, or other sources.

Data Source component 2112 represents external systems and data repositories that MCP Server 2108 can access to fulfill client requests. Data Source 2112 can include three primary categories: files 2116, databases 2114, and APIs. Files 2116 represent file-system resources and local storage containing documents such as PDF files, plain-text files, structured data files, and binary files. Databases 2114 represent database systems that store structured and unstructured data, providing persistent data storage that MCP Server 2108 can query to retrieve information for AI models. APIs represent Internet-based services, web APIs, cloud platforms, and remote computational resources accessible via network protocols.

A return data communication pathway extends from Data Source 2112 back to MCP Server 2108, indicating that retrieved data or operation results are returned from external data sources to MCP Server 2108 for processing and subsequent delivery to MCP Client 2106. This bidirectional data flow shows that MCP Servers 2108 invoke APIs or execute fetch operations to access external data sources and then process and return results through the MCP workflow back to AI Host 2102.

The MCP flow can be summarized as: “The MCP Client translates AI requests into standardized protocol format, communicates with MCP Servers, which then interact with external Data Sources.” This captures the essential data flow and transformation in MCP architecture 2100. Translation from AI requests to standardized protocol messages bridges the gap between how AI systems express needs and how protocols structure messages. Communication between MCP Clients 2106 and MCP Servers 2108 occurs via the transport layer according to the protocol specification, enabling interoperability between independently developed components. Interactions between MCP Servers 2108 and external Data Sources 2112 encapsulate the complexity and diversity of backend systems, presenting a uniform interface to clients.

The complete workflow proceeds as follows: AI component 2104 generates a request based on user input or autonomous operation; MCP Client 2106 translates the request into standardized protocol format; MCP Client 2106 transmits the request via MCP to MCP Server 2108, querying available capabilities and requesting operations or data; MCP Server 2108 determines which capabilities are needed; MCP Server 2108 executes a fetch/execute operation to interact with appropriate Data Source 2112; Data Source 2112 processes the operation and returns requested data to MCP Server 2108; MCP Server 2108 processes the returned data and formulates a response; MCP Server 2108 transmits the response via MCP back to AI Host 2102; MCP Client 2106 processes the response and provides it to AI component 2104; and AI component 2104 uses the data or results to complete its task.

For the exemplary request “Give me file report.pdf,” AI component 2104 generates a retrieval request; MCP Client 2106 translates it into standardized MCP format specifying a resource retrieval; MCP Server 2108 receives the request and identifies its resources capability; MCP Server 2108 performs a fetch operation targeting file data source 2116; file data source 2116 locates and returns file data to MCP Server 2108; MCP Server 2108 formulates a response containing the PDF or a reference thereto; MCP Server 2108 transmits the response back to AI Host 2102; and MCP Client 2106 delivers the file data to AI component 2104 for display or further processing.

This architecture demonstrates a modular and extensible system in which MCP Client 2106 acts as an intermediary that translates AI requests into standardized protocol messages, maintains a one-to-one communication link with its corresponding MCP Server 2108, and enables seamless integration between AI applications and diverse external systems (including files 2116, databases 2114, and APIs within Data Source 2112). The standardized protocol format ensures cross-platform interoperability, allowing different AI hosts 2102 to communicate with various MCP Servers 2108 and access heterogeneous data sources 2112 via a unified interface. The adapter architecture of MCP Server 2108 provides a consistent abstraction layer that shields AI Hosts 2102 from implementation details of different data sources, enabling AI applications to access files 2116, databases 2114, and APIs through a single standardized protocol without requiring custom integration code for each data source type.

### MCP Workflow

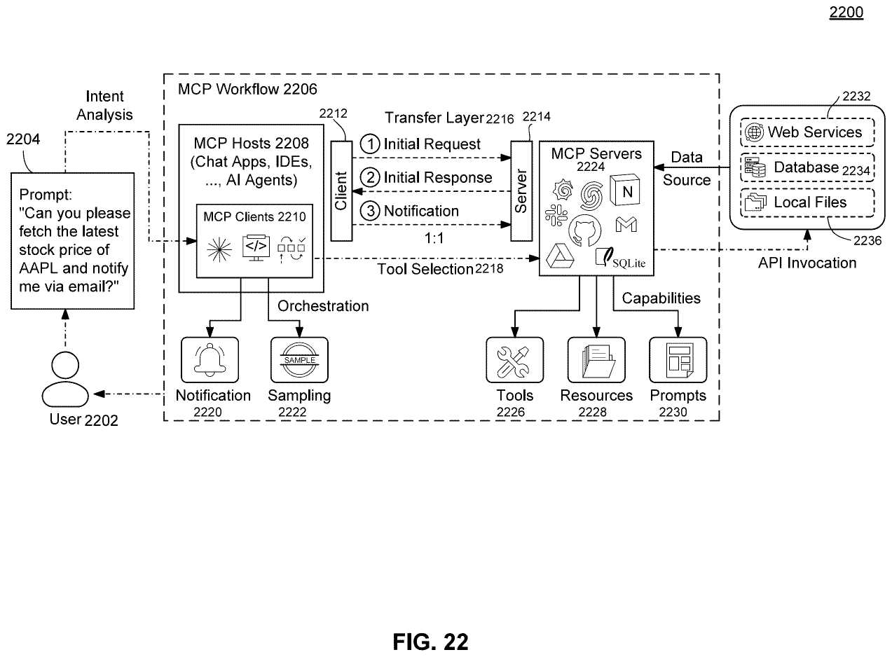

FIG. 22 is a detailed system architecture diagram illustrating a complete Model Context Protocol (MCP) workflow 2200 and the comprehensive interaction among core components, subcomponents, communication pathways, and external systems for processing user requests through multiple stages, including intent analysis, tool selection, and API invocation.

The system architecture comprises a user entity 2202 operatively connected via a communication pathway to a prompt input interface 2204. User entity 2202 initiates requests and receives notifications from MCP workflow system 2206.

Prompt input interface 2204 presents an exemplary user query: “Prompt: ‘Can you please fetch the latest stock price of AAPL and notify me via email?’” This example illustrates a typical use case in which the user requests real-time financial market data for Apple Inc. (ticker AAPL) from external data sources and also requests automatic delivery of the results via email. The example demonstrates that the system can process complex, multi-step requests requiring both data retrieval and subsequent communication actions. Prompt input interface 2204 is operatively connected to MCP workflow system 2206, indicating the initial direction of information flow from the user into the MCP workflow.

MCP workflow system 2206 comprises the three core components of the MCP architecture: MCP host, MCP client, and MCP server, which jointly enable secure, well-managed communication between AI applications, external tools, and data sources. MCP hosts 2208 (labeled “Chat Apps, IDEs, . . . , AI Agents”) indicate non-limiting examples of applications functioning as MCP hosts. Examples include Claude Desktop, Cursor, and autonomous AI agents. MCP host 2208 provides the environment for executing AI tasks while running the MCP client; it integrates interactive tools and data to enable communication with external services and establishes the runtime environment required for MCP client operations.

In the host-client-server architecture, the MCP client acts as an intermediary, maintaining a one-to-one communication link with a corresponding MCP server. The MCP client initiates requests, queries available functions, and retrieves responses describing tools, resources, and capabilities, while also processing notifications and performing sampling for optimization purposes. MCP client 2212 communicates with MCP servers 2224 via transport layer 2216, ensuring secure, reliable data exchange between host 2208 and external resources.

An Intent Analysis component indicates that MCP client 2212 analyzes the intent of user prompts. When user prompt 2204 is sent to MCP client 2212, MCP client 2212 interprets semantic content, contextual meaning, and operational requirements to determine the user's intent and required system actions (e.g., retrieve stock data and send email).

An Orchestration component indicates coordination functions performed by MCP client 2212. Orchestration governs sequencing and management of operations as MCP client 2212 interacts with MCP servers 2224 and manages workflow from initial request through final notification.

A Notification feature 2220 indicates notification functionality connected back to user entity 2202. Notifications include task completion confirmations, progress updates, error messages, and result payloads. MCP client 2212 also performs sampling 2222, collecting data about tool usage and performance to support system optimization and resource planning.

Transport layer 2216 facilitates bidirectional data exchange between clients 2212 and servers 2214, managing transmission of initial requests, server responses describing capabilities, and notifications. Within transport layer 2216, communication between MCP client 2212 and MCP server 2214 follows three stages:

Initial Request: Communication flows from MCP client 2212 to MCP server 2214. MCP client 2212 sends an initial request querying MCP server 2214 for available functions, tools, resources, and capabilities. In the AAPL example, the initial request seeks confirmation of available stock-price tools and email-notification tools.

Initial Response: Communication flows from MCP server 2214 back to MCP client 2212. MCP server 2214 responds with an initial response listing available tools, resources, and prompts that MCP client 2212 can use for task execution, such as tools for retrieving stock quotes and sending email notifications.

Notification: A bidirectional notification channel enables ongoing updates between MCP servers 2214 and MCP clients 2212. Once a connection is established, the system maintains a continuous exchange of notifications 2220, ensuring that changes in server status and progress updates are communicated to MCP client 2212 in real time.

The notation “1:1” between “Client” 2212 and “Server” 2214 indicates a one-to-one communication link between an MCP client and its corresponding MCP server during request and response exchange, establishing a dedicated communication relationship for each client-server pair.

A Tool Selection component 2218 within transport layer 2216 indicates tool selection functionality. Based on task context and intent analysis, host 2208 selects appropriate tools from those available on MCP server 2224 and issues invocation requests via MCP client 2212. For the AAPL example, tool selection 2218 would select (i) a financial-data tool capable of accepting a ticker symbol and returning current price information, and (ii) an email-service tool capable of composing and delivering email messages.

MCP servers 2224 are depicted along with icons representing various service integrations (e.g., GitHub, email/messaging, Google Drive, code repositories, SQLite). MCP servers 2224 provide three core capabilities: tools 2226, resources 2228, and prompts 2230. Tools 2226 enable MCP servers 2224 to invoke external services and APIs and return results through a standardized, model-agnostic protocol; resources 2228 provide access to structured and unstructured datasets; and prompts 2230 define templates and workflows to standardize and optimize AI responses.

External data sources include web services 2232 (representing Internet-based services, APIs, cloud platforms, and remote computation), databases 2234 (representing structured and unstructured data repositories), and local files. API invocation 2236 indicates that these data sources are accessed via APIs. MCP server 2224 invokes external APIs, retrieves results, and returns processed data through MCP workflow system 2206.

The complete workflow proceeds as follows: user 2202 sends prompt 2204; MCP client 2212 performs intent analysis; MCP client 2212 selects tools 2226 via MCP server 2224; MCP server 2224 invokes external APIs 2236 to retrieve and process information from web services 2232, databases 2234, and local files; and MCP workflow system 2206 notifies user 2202 of results via notification pathway 2220. Communication follows the structured process of initial request, initial response, and ongoing notifications, enabling high-performance, synchronized interactions with external resources.

For the exemplary prompt “Can you please fetch the latest stock price of AAPL and notify me via email?”, user 2202 submits prompt 2204 to MCP client 2212. MCP client 2212 identifies a need for financial-data retrieval and email notification, sends an initial request via transport layer 2216 to MCP server 2214, receives an initial response enumerating available financial and email tools, and coordinates selection of appropriate tools 2226. MCP server 2224 then invokes a financial-data API 2236 with ticker “AAPL,” receives current stock price information from web services 2232, returns this data to MCP client 2212, and subsequently invokes an email-service API 2236 to compose and deliver a notification message containing the stock price to the user's email. Notifications 2220 keep user 2202 informed throughout. A one-to-one communication link between MCP client 2212 and MCP server 2214 provides dedicated, reliable communication, while sampling 2222 gathers performance and usage data for optimization.

This architecture demonstrates a modular, extensible system in which MCP client 2212 maintains a one-to-one link with MCP server 2214 and enables seamless integration between AI applications 2208 and diverse external systems including web services 2232, databases 2234, and local files, while ensuring secure, reliable data exchange through transport layer 2216 throughout workflow 2200, from initial prompt 2204 to final notification 2220.

### Artificial Intelligence System Architecture

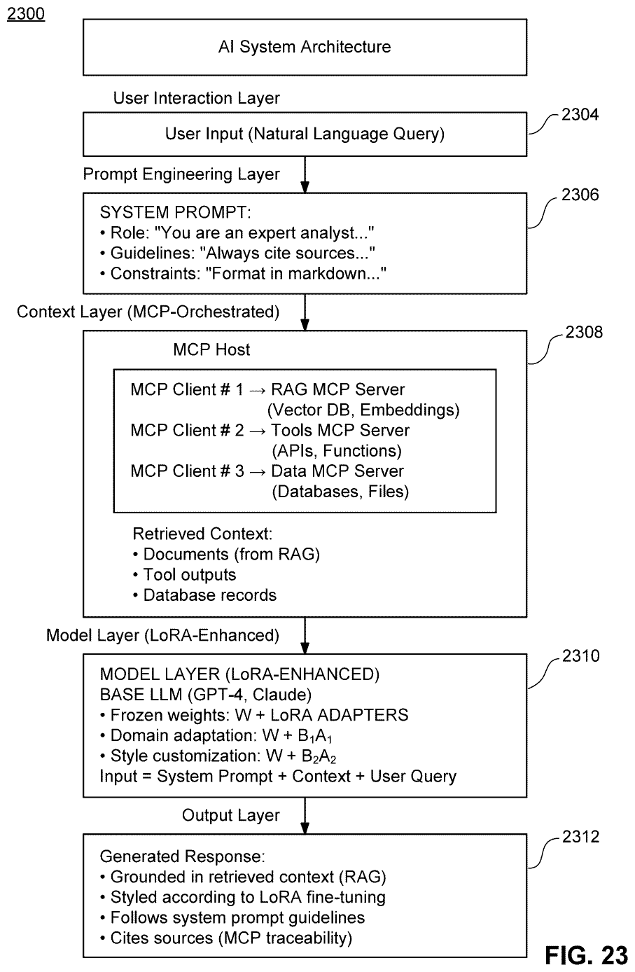

FIG. 23 illustrates a comprehensive artificial intelligence system architecture 2300 that integrates multiple technological components to enhance language-model performance. The system comprises five principal layers arranged in sequential data flow: a User Interaction Layer, a Prompt Engineering Layer, a Context Layer implementing the Model Context Protocol, a Model Layer enhanced with Low-Rank Adaptation, and an Output Layer.

At the uppermost portion of FIG. 23, User Interaction Layer 2304 receives user input in the form of natural-language queries. Such queries comprise unstructured textual input formulated in human-readable language and serve as the initiating stimulus for subsequent processing. Queries may include interrogative statements, imperative commands, or declarative sentences expressing an informational need or task requirement.

The natural-language query is transmitted from User Interaction Layer 2304 to Prompt Engineering Layer 2306. Prompt Engineering Layer 2306 comprises a system-prompt component that defines operational parameters and behavioral constraints for the language model. The system prompt includes a role definition specifying the persona or expertise domain of the AI agent (e.g., “You are an expert analyst”), guidelines that establish mandatory behaviors (e.g., “Always cite sources”), and constraints specifying output formatting and structure (e.g., “Format in markdown”). This system prompt establishes a persistent behavioral framework that governs response generation across a session or task, providing consistent operational parameters independent of the specific content of individual queries.

The processed query, structured in accordance with system-prompt specifications, is transmitted to Context Layer 2308, labeled “Context Layer (MCP-Orchestrated).” Context Layer 2308 implements the Model Context Protocol and includes an MCP Host application that orchestrates access to external data sources and tools. The MCP Host coordinates and manages multiple MCP client connections, each maintaining a dedicated one-to-one connection with a corresponding MCP server as specified by the MCP architecture.

Within the MCP Host, three MCP clients are illustrated. A first MCP client is connected to a RAG MCP Server that provides access to vector-database storage and embedding generation. The RAG MCP Server performs semantic similarity search by converting textual queries into dense vectors via embedding models, comparing those vectors to pre-indexed document vectors in a vector database, and retrieving documents with high similarity scores. These documents supply contextual information that augments the language model input.

A second MCP client connects to a Tools MCP Server that exposes executable functions extending the language model's capabilities beyond pure text generation. The Tools MCP Server provides access to APIs and computational functions that enable the language model to perform tasks such as mathematical calculations, data transformations, external service invocations, and other programmatic operations. Tools are discoverable via the MCP tool-listing mechanism and invocable via standardized JSON-RPC message exchanges.

A third MCP client connects to a Data MCP Server providing access to structured and unstructured data sources such as relational databases, document stores, and file systems. The Data MCP Server executes queries and retrieves file contents, providing the language model with up-to-date operational data not necessarily present in its pre-training corpus.

Context Layer 2308 aggregates retrieved context from the RAG, Tools, and Data MCP servers. The aggregated context comprises RAG-retrieved documents, tool outputs, and database records or file contents, as explicitly enumerated in FIG. 23. This retrieved context is structured and injected into the language model's input prompt, augmenting the model's pre-trained knowledge with real-time, task-specific, domain-relevant information.

The augmented prompt comprising the system prompt from Prompt Engineering Layer 2306, retrieved context from Context Layer 2308, and the user query from User Interaction Layer 2304—is transmitted to Model Layer 2310, labeled “Model Layer (LoRA-Enhanced).” Model Layer 2310 includes a base LLM (e.g., GPT-4 or Claude) whose pre-trained weights are maintained in a frozen state, represented as matrix W. The frozen weights ensure that original parameters learned during pre-training remain untouched during task-specific adaptation, avoiding the computational and memory cost of full model retraining.

LoRA adapters are operatively coupled to the base LLM to implement Low-Rank Adaptation, a parameter-efficient fine-tuning technique. Each LoRA adapter includes trainable low-rank matrices that, when multiplied, approximate weight updates to the base model without altering W. The figure illustrates two exemplary LoRA adaptations, specifically domain adaptation represented mathematically as W plus B₁A₁, and style customization represented mathematically as W plus B₂A₂. In these mathematical representations, W denotes the original frozen weight matrix of the base model, while B₁, A₁, B₂, and A₂ denote low-rank matrices that are trainable during the adaptation process. The dimensions of the low-rank matrices B and A are substantially smaller than the dimensions of the base weight matrix W, such that the product of B and A provides a low-rank approximation of the weight updates that would be computed during full fine-tuning. Specifically, if the base weight matrix W has dimensions d by d, the low-rank matrices may have dimensions d by r and r by d respectively, where r is the rank hyper-parameter and r is much less than d. This dimensional reduction enables parameter-efficient fine-tuning wherein the number of trainable parameters is reduced by factors of one thousand to ten thousand or more compared to full fine-tuning approaches, while maintaining model quality comparable to full fine-tuning on downstream tasks.

The Model Layer 2310 processes an input comprising the system prompt, the retrieved context, and the user query, as explicitly stated in the figure. The processing applies both the frozen base model weights W and the trainable LoRA adapter weights B₁A₁ and B₂A₂ to generate a contextually-aware, domain-adapted response. The domain adaptation component W plus B₁A₁ provides behavioural modifications specific to particular knowledge domains or task categories, while the style customization component W plus B₂A₂ provides stylistic and formatting adaptations that ensure consistency with desired output conventions. The combined effect of the frozen base weights W and the low-rank adaptations B₁A₁ and B₂A₂ produces model outputs that exhibit both the general language understanding capabilities acquired during pre-training and the task-specific behaviours learned during efficient adaptation.

The generated output is transmitted to Output Layer 2312. Output Layer 2312 produces a response exhibiting several distinguishing characteristics: (i) grounding in retrieved context, ensuring that factual content is anchored to information obtained through RAG and other MCP-mediated sources and thereby reducing hallucinations; (ii) styling according to LoRA fine-tuning, which enforces domain-specific terminology and formatting; (iii) adherence to system-prompt guidelines, ensuring compliance with role definitions, operational rules, and formatting constraints; and (iv) source citation through MCP traceability, wherein references to specific documents, database records, or tool outputs that contributed to the response are included for transparency and verifiability.

The architecture in FIG. 23 provides multiple technical advantages over conventional language-model implementations. The MCP-orchestrated Context Layer 2308 enables dynamic access to real-time, updatable information sources without retraining, allowing responses grounded in data created or updated after the model's pre-training cutoff. LoRA in Model Layer 2310 enables parameter-efficient adaptation with significantly fewer trainable parameters while achieving comparable quality to full fine-tuning. Prompt Engineering Layer 2306 ensures behavioral and formatting consistency across diverse queries. The MCP protocol provides modular extensibility, allowing new tools and data sources to be added via new MCP servers without modifying the base model or existing integrations. Structured context management via MCP improves traceability and explainability by attributing responses to specific external sources, facilitating verification and auditing. The layered architecture 2300 enforces a separation of concerns, enabling independent optimization of behavioral adaptation (LoRA), knowledge access (MCP), and operational guidelines (system prompts).

Data flow proceeds sequentially: user input is received at User Interaction Layer 2304 and passed to Prompt Engineering Layer 2306 for application of system-prompt specifications; the structured query is forwarded to Context Layer 2308, where the MCP Host coordinates retrieval of relevant context from multiple MCP servers; the augmented prompt (system prompt+context+query) is then passed to Model Layer 2310 for processing by the base LLM and LoRA adapters; and finally the generated response is output via Output Layer 2312 with grounding, styling, guideline adherence, and source attribution.

Context Layer 2308 implements communication between MCP clients and servers using JSON-RPC 2.0, a stateless, lightweight remote procedure call protocol that uses JSON for message encoding. JSON-RPC 2.0 standardizes requests, responses, and notifications exchanged between MCP clients and servers. Transport mechanisms include STDIO transport for local MCP servers (via standard input/output streams between processes on the same machine) and HTTP with Server-Sent Events for remote MCP servers (HTTP POST requests from client to server and SSE for streaming notifications and progress updates from server to client). The HTTP transport supports distributed deployments and integrates with standardized authentication mechanisms such as OAuth 2.1, wherein access tokens obtained via OAuth flows are included in HTTP headers to authenticate client requests to protected MCP servers.

System architecture 2300 thus provides a comprehensive, modular, and technically advanced implementation for AI applications requiring dynamic knowledge access, parameter-efficient adaptation, and explainable response generation. By integrating prompt engineering in Prompt Engineering Layer 2306, MCP-based retrieval in Context Layer 2308, low-rank adaptation in Model Layer 2310, and structured output in Output Layer 2312, the system produces responses that are simultaneously grounded in authoritative external sources, tailored to domain-specific requirements, consistent with operational guidelines, and traceable to verifiable information sources.

### Technical Improvements Over Traditional Machine Learning Techniques

Having described the Model Context Protocol architecture and its integration into a layered AI system, the following description addresses the technical improvements and performance enhancements that LLM-based architectures provide over traditional machine-learning techniques.

Large language models (LLMs) deliver several concrete technical improvements over traditional machine-learning architectures by enabling unified, context-aware processing pipelines that avoid the need for handcrafted feature engineering or rigid data schemas. Classical models (e.g., support vector machines (SVMs), logistic regression, shallow neural networks) typically operate on sparse or fixed-dimensional vectorizations derived from manual feature-engineering pipelines and cannot easily capture long-range dependencies or nuanced semantic relationships without extensive custom preprocessing.

In contrast, LLMs employ transformer-based attention mechanisms capable of jointly modeling heterogeneous inputs-including free-text descriptions, structured clinical data, metadata, and domain-specific features-within a single computational graph. This design supports automatic extraction of latent semantic relationships, implicit reasoning patterns, and long-range dependencies that traditional models cannot represent without significant architectural complexity.

LLMs also support zero-shot and few-shot inference, allowing new tasks and datasets to be accommodated via prompting, without retraining end-to-end pipelines. Parameter-efficient tuning methods such as LoRA and QLoRA further reduce retraining overhead by restricting updates to a small fraction of model parameters. LLM-based workflows can integrate explainability signals (e.g., attention visualizations, prompt-based reasoning traces) directly into prompts, enabling hybrid symbolic-neural reasoning that is difficult to replicate with conventional models.

Moreover, LLMs exhibit improved robustness to class imbalance, temporal domain drift, and missing structured fields by leveraging contextual embeddings instead of relying solely on brittle structured inputs. Collectively, these capabilities constitute specific technical enhancements that materially improve the functioning of underlying computing systems relative to conventional machine-learning approaches.

Specific technical improvements enabled by LLM-based architectures include:

Context-integrated feature extraction: The model dynamically derives semantic, syntactic, and relational information directly from raw unstructured input, eliminating brittle TF-IDF-style pipelines and enabling richer token-level representations.

Cross-modal and cross-source data fusion: LLMs can process heterogeneous inputs-such as narratives, timestamps, medication lists, and structured fields-within a single attention mechanism, improving throughput and reducing the need for multiple complex preprocessing stages.

Parameter-efficient adaptation: Techniques such as LoRA and QLoRA allow rapid domain adaptation using as little as 0.1-1% of parameters, avoiding full-model retraining cycles that are typical of conventional ML workflows.

Long-range dependency modeling: Transformer attention captures relationships across hundreds or thousands of tokens, beyond the receptive-field limits of logistic regression, SVMs with bag-of-words features, and shallow neural networks.

Domain-adaptive prompt conditioning: LLMs can adjust their behavior based on structured prompts, chain-of-thought instructions, or domain-specific reasoning templates without altering model weights, enabling fast task adaptation with no retraining.

Robustness to missing or incomplete structured data: LLMs can compensate for absent features by inferring latent relationships from available context, whereas traditional ML models typically require explicit imputation logic and remain sensitive to missing data patterns.

Together, these capabilities represent concrete, non-conventional technical enhancements that materially improve data processing, inference quality, and system-level functionality beyond what traditional machine-learning architectures can provide.

### Accuracy and Performance Improvements Over Traditional Machine Learning Techniques

LLM-based architectures also deliver measurable accuracy and performance improvements over traditional machine-learning models across a wide variety of classification, extraction, and prediction tasks. Empirical studies show that transformer-based LLMs often achieve substantially higher accuracy, precision, recall, and F1 scores than classical baselines such as SVMs, logistic regression, convolutional neural networks (CNNs), long short-term memory networks (LSTMs), and rule-based NLP systems.

Across multiple domains including enhancement-approval prediction, sentiment and sarcasm detection, biomedical information extraction, and clinical risk prediction LLMs have been shown to provide double-digit gains in accuracy and significant improvements in minority-class recall, addressing failure modes in which traditional models underperform. When combined with parameter-efficient fine-tuning or structured, multi-layer prompting, LLMs can outperform or closely match state-of-the-art classical models even under challenging evaluation regimes, such as chronologically split test sets or cost-sensitive settings that heavily penalize critical errors like false negatives.

LLMs also demonstrate markedly higher robustness to noisy, ambiguous, or incomplete inputs and can effectively leverage contextual signals (e.g., metadata, rich narratives, and long-form text) that traditional models cannot easily encode. These improvements show that LLM-based architectures not only enhance prediction quality but also materially elevate overall system performance beyond what is achievable with conventional machine-learning techniques.

For example, enhanced transformer models such as HS-BERT achieve approximately 96-98% accuracy on e-commerce comment classification tasks, substantially outperforming SVM, CNN, and Naive Bayes baselines that typically achieve around 70-92% accuracy. In software-engineering workflows, LoRA-tuned LLMs such as Llama 3.1 can improve enhancement-approval prediction accuracy from roughly 64% to 79%, while increasing minority-class (“approved”) recall by more than 12 percentage points relative to LSTM- and SVM-based systems.

In clinical and biomedical settings, LLMs such as GPT-4o, PaLM-2, and Llama-2 demonstrate superior extraction accuracy for complex tasks like identifying immunosuppressed patients from free-text notes or extracting patient-reported outcomes, consistently outperforming rule-based NLP pipelines and structured-data ML models. In cost-sensitive medical prediction tasks, LLMs equipped with structured prompts achieve higher recall and lower critical false-negative rates than traditional classifiers, improving performance under real-world risk-weighted metrics.

Even in domains where classical models already perform strongly such as fake-news detection BERT-style language models provide incremental but statistically significant gains, improving accuracy from about 99.81% to 99.98% and F1 scores from approximately 0.9980 to 0.9998.

Collectively, these results demonstrate that LLMs consistently deliver measurable, statistically significant improvements in accuracy, recall, F1 score, robustness, and minority-class performance compared to traditional machine-learning techniques, thereby materially improving the overall functioning and effectiveness of AI-driven computing systems.

### Computer System

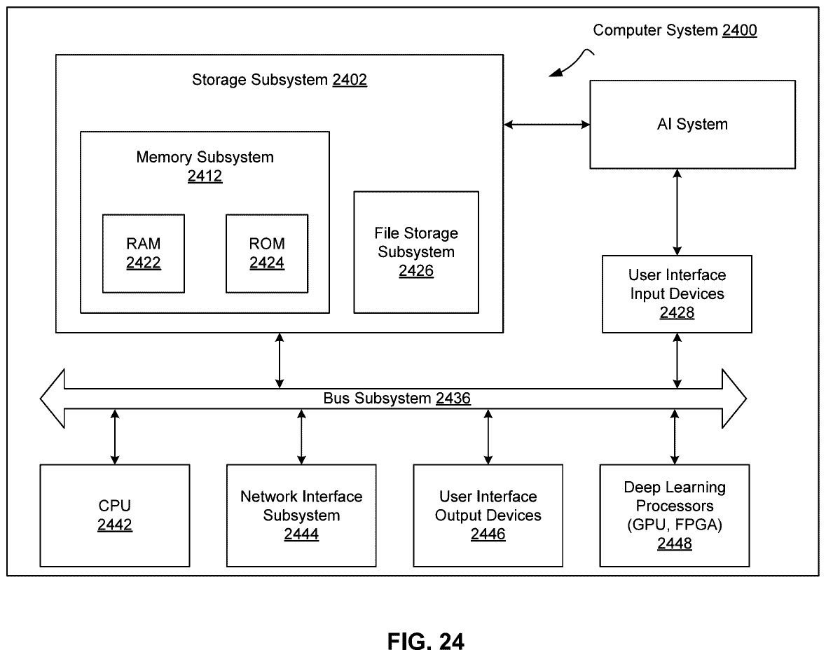

FIG. 24 shows an example computer system 2400 that can be used to implement the AI system disclosed herein. Computer system 2400 includes at least one central processing unit (CPU) 2442 that communicates with a number of peripheral devices via bus subsystem 2436. These peripheral devices can include a storage subsystem 2402 including, for example, memory devices and a file storage subsystem 2426, user interface input devices 2428, user interface output devices 2446, and a network interface subsystem 2444. The input and output devices allow user interaction with computer system 2400. Network interface subsystem 2444 provides an interface to outside networks, including an interface to corresponding interface devices in other computer systems.

In one implementation, the disclosed AI system(s) are communicably linked to the storage subsystem 2402 and the user interface input devices 2428.

User interface input devices 2428 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2400.

User interface output devices 2446 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2400 to the user or to another machine or computer system.

Storage subsystem 2402 stores programming and data constructs that provide the functionality of some or all of the modules and methods described herein. These software modules are generally executed by processors 2448.

Processors 2448 can be graphics processing units (GPUs), field-programmable gate arrays (FPGAs), application-specific integrated circuits (ASICs), and/or coarse-grained reconfigurable architectures (CGRAs). Processors 2448 can be hosted by a deep learning cloud platform such as Google Cloud Platform™, Xilinx™, and Cirrascale™ Examples of processors 2448 include Google's Tensor Processing Unit (TPU)™, rackmount solutions like GX4 Rackmount Series™, GX13 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 2412 used in the storage subsystem 2402 can include a number of memories including a main random access memory (RAM) 2422 for storage of instructions and data during program execution and a read only memory (ROM) 2424 in which fixed instructions are stored. A file storage subsystem 2426 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2426 in the storage subsystem 2402, or in other machines accessible by the processor.

Bus subsystem 2436 provides a mechanism for letting the various components and subsystems of computer system 2400 communicate with each other as intended. Although bus subsystem 2436 is shown schematically as a single bus, alternative implementations of the bus subsystem can use multiple busses.

Computer system 2400 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 2400 depicted in FIG. 24 is intended only as a specific example for purposes of illustrating the preferred implementations of the technology disclosed. Many other configurations of computer system 2400 are possible having more or less components than the computer system depicted in FIG. 24.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the technology disclosed, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The technology disclosed may be embodied as a system, a method, and/or a computer program product. The computer program product may include a computer readable storage medium (or media) having computer readable program instructions thereon for causing a processor to carry out aspects of the technology disclosed.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 24 is a schematic of an exemplary computing node. Computing node 2400 is only one example of a suitable computing node and is not intended to suggest any limitation as to the scope of use or functionality of implementations described herein. Regardless, computing node 2400 is capable of being implemented and/or performing any of the functionality set forth herein above.

In computing node 2400 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 24, computer system/server in computing node 2400 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of implementations of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of implementations as described herein.

Computer readable program instructions for carrying out operations of the technology disclosed may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the technology disclosed.

Aspects of the technology disclosed are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the technology disclosed. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

1. A system, comprising:
an artificial intelligence (AI) model that receives a prompt, and is configured with a decision logic to generate a response to the prompt,
   wherein the decision logic is in a current state;
an agent configured to generate a stimulant and further configured to apply the stimulant to the decision logic to transition the decision logic from the current state to a next state,
   wherein the decision logic in its next state is used to generate the response to the prompt.

2. The system of clause 1, wherein the prompt comprises one or more of a user query, a system-generated query, a probing input, a context-adding input, or an adversarial input.

3. The system of clause 1, wherein a state of the decision logic comprises one or more of a rule, a condition, or a causal path identifying a reason the response was generated by the AI model.

4. The system of clause 3, further comprising a memory storing a plurality of decision logics, wherein each decision logic in the plurality of decision logics has a respective associated state.

5. The system of clause 1, further including logic to generate a decision trace identifying a strategy adopted by the AI model to generate the response, wherein the decision trace further comprises a corresponding state of the decision logic.

6. The system of clause 5, wherein the decision trace further comprises an associated emotional state inferred from the stimulant, the associated emotional state comprising at least one of a positive state, an altered state, a neutral state, or a cautious state.

7. The system of clause 6, further including logic to increase storage duration for the decision trace when the decision trace comprises a positive associated emotional state.

8. The system of clause 5, further including logic to apply an exponential decay function to the decision trace when the decision trace is not associated with a positive outcome, wherein decision traces not reinforced by positive outcomes are removed from memory over time.

9. The system of clause 5, wherein the decision trace comprises one or more referenced memory identifiers identifying prior decision traces consulted during generation of the response, enabling reconstruction of contextual lineage.

10. The system of clause 5, wherein the decision trace comprises a cognitive strategy vector identifying the strategy applied by the AI model to generate the response.

11. The system of clause 5, wherein the decision trace comprises a causal chain linking the response to one or more prior decision operations that contributed to generation of the response, enabling reinforcement of effective early decisions when a positive outcome is delayed.

12. The system of clause 5, further comprising:
a second AI model configured to generate a second response to the prompt based on a second decision logic;
a decision trace generator configured to generate a second decision trace identifying a second strategy adopted by the second AI model; and
a comparator configured to compare the decision trace with the second decision trace based on one or more of a cognitive strategy vector, an associated emotional state, or referenced memory identifiers in the decision trace and the second decision trace to determine which of the response and the second response is more aligned with prior decision traces associated with positive outcomes.

13. The system of clause 1, wherein the agent is selected from a plurality of agents including one or more role-based agents configured to generate role-based stimulants that probe the decision logic from distinct reasoning perspectives, and one or more context-based agents configured to generate context-based stimulants that provide contextual information to the decision logic.

14. The system of clause 13, further comprising an orchestrator agent configured to coordinate the plurality of agents and to combine stimulants generated by the one or more role-based agents and the one or more context-based agents for application to the decision logic.

15. The system of clause 13, wherein the plurality of agents is configured to iteratively generate stimulants and apply the stimulants to the decision logic until a convergence condition is satisfied, the convergence condition based on one or more of a resource constraint, an iteration threshold, or a quality metric.

16. The system of clause 6, further comprising a temperature parameter that modulates behavior of the agent, wherein the temperature parameter is adjusted based on the associated emotional state, and wherein a higher temperature parameter increases randomness and free association in generation of the stimulant and a lower temperature parameter reduces randomness in generation of the stimulant.

17. The system of clause 4, further comprising a learning goal, wherein one or more decision logics in the plurality of decision logics associated with the learning goal are retained in memory and one or more decision logics in the plurality of decision logics not associated with the learning goal are subject to a decay function.

18. The system of clause 5, further comprising logic configured to:
reorganize decision traces stored in memory by grouping related decision traces based on emotional and thematic similarity; and
amplify decision traces that share emotional and thematic connections by increasing retention weights for the grouped decision traces, thereby reinforcing effective cognitive pathways.

19. The system of clause 5, further comprising a hierarchical memory storing decision traces in a plurality of memory tiers comprising:
a short-term memory storing decision traces from recent interactions;
a mid-term memory storing decision traces that have been boosted from the short-term memory based on relevance to a learning goal or association with a positive outcome; and
a long-term memory storing decision traces that have been boosted from the mid-term memory,
   wherein decision traces progress from the short-term memory to the mid-term memory to the long-term memory based on reinforcement, and wherein decision traces not reinforced remain in the short-term memory and are subject to decay.

20. The system of clause 5, further comprising logic configured to periodically replay decision traces associated with positive outcomes, thereby increasing retention weights for the replayed decision traces.

21. The system of clause 1, further configured with logic to receive an input from a human user and generate the stimulant in dependence upon the input from the human user.

22. The system of clause 1, further comprising logic configured to build a dynamic profile of a human user's problem-solving approach based on interactions with the human user, wherein the decision logic is adapted based on the dynamic profile to mirror the human user's problem-solving approach.

23. The system of clause 5, wherein the decision trace further comprises an associated learning value confidence score.

24. The system of clause 23, further comprising logic to increase storage duration for the decision trace when the associated learning value confidence score is positive.

25. The system of clause 23, further comprising logic to decrease storage duration for the decision trace when the associated learning value confidence score is negative.

26. A system, comprising:
a memory storing a plurality of decision logics, a decision logic in the plurality of decision logics having a respective associated state;
an artificial intelligence (AI) model that receives a prompt, and is configured to generate a response to the prompt based on the decision logic;
an agent configured to generate a stimulant in dependence upon one or more prior decision traces and further configured to:
   use the stimulant to identify the decision logic in the plurality of decision logics stored in the memory; and
   apply the stimulant to the identified decision logic to transition the identified decision logic from a current state to a next state,
      wherein the identified decision logic in its next state is used to generate the response to the prompt.

27. The system of clause 26, wherein a prior decision trace in the one or more prior decision traces identifies a strategy adopted by the AI model to generate the response in a prior prompt-response iteration and wherein the prior decision trace further comprises a corresponding state of the decision logic.

28. A system, comprising:
a memory storing a plurality of decision logics, a decision logic in the plurality of decision logics having a respective associated state;
an artificial intelligence (AI) model that receives a prompt, and is configured to generate a response to the prompt based on the decision logic;
an agent configured to generate a stimulant in dependence upon one or more prior decision traces and further configured to:
   use the stimulant to identify the decision logic in the plurality of decision logics stored in the memory; and
   apply the stimulant to the identified decision logic to transition the identified decision logic from a current state to a next state; and
logic configured to generate a decision trace identifying a strategy adopted by the AI model to generate the response, wherein the decision trace comprises the next state of the identified decision logic,
   wherein the identified decision logic in its next state is used to generate the response to the prompt, and wherein the decision trace is stored in the memory.

29. The system of clause 28, wherein a prior decision trace in the one or more prior decision traces identifies the strategy adopted by the AI model to generate the response in a prior prompt-response iteration and wherein the prior decision trace further comprises a corresponding state of the decision logic.

30. The system of clause 5, wherein the decision trace further comprises an intent classification indicating a reuse scope for the decision trace, the intent classification comprising at least one of:
an illustrative classification indicating the decision trace represents example reasoning not intended as binding precedent;
a matter-specific classification indicating the decision trace is limited to a particular transaction, context, or set of circumstances;
a preferred-approach classification indicating the decision trace represents an organizational or user default reasoning pattern;
a provisional classification indicating the decision trace represents experimental reasoning subject to subsequent validation; or
a deprecated classification indicating the decision trace represents formerly valid reasoning that is no longer applicable.

31. The system of clause 30, further comprising logic configured to filter decision traces during retrieval based on the intent classification, wherein decision traces with the deprecated classification are excluded from retrieval for use in generating responses unless explicitly requested.

32. The system of clause 5, wherein the decision trace further comprises a temporal confidence score that degrades based on elapsed time since the decision trace was generated, wherein the temporal confidence score modulates a weight given to the decision trace when retrieved for subsequent prompt-response iterations.

33. The system of clause 32, further comprising logic configured to require a confirmation from one or more of a human user, the AI model, or an automated system before applying the decision trace when the temporal confidence score falls below a staleness threshold, wherein the confirmation request presents the decision trace and its age to the human user.

34. The system of clause 32, wherein the temporal confidence score is computed based on one or more of:
elapsed time since the decision trace was generated;
elapsed time since the decision trace was last validated by one or more of a human user, the AI model, or an automated system;
frequency of reuse of the decision trace in subsequent prompt-response iterations;
consistency between outcomes associated with the decision trace and outcomes when the decision trace is not consulted; or a domain-specific decay rate associated with a category of the decision trace.

35. The system of clause 5, further comprising logic configured to:
receive input indicating that reasoning in a first decision trace is superseded by reasoning in a second decision trace;
mark the first decision trace with a superseded status and store a reference to the second decision trace within the first decision trace;
retain the first decision trace in memory with the superseded status, enabling reconstruction of reasoning evolution over time; and
exclude the first decision trace from retrieval for use in generating responses while retaining the first decision trace for historical analysis.

36. The system of clause 5, further comprising logic configured to:
receive an annotation from one or more of a human user, the AI model, or an automated system, the annotation indicating disagreement with, limitation of, or qualification of reasoning in the decision trace;
store the annotation in association with the decision trace, including an identifier of a source of the annotation; and
present the annotation when the decision trace is retrieved for subsequent prompt-response iterations, enabling the AI model or the human user to consider the annotation when determining whether to apply the decision trace.

37. The system of clause 8, further comprising logic configured to:
identify decision traces associated with negative outcomes based on one or more of explicit negative feedback from a human user, observed failure of the strategy recorded in the decision trace, or downstream adverse consequences linked to the decision trace;
retain the identified decision traces in a negative example memory tier, wherein decision traces in the negative example memory tier are exempt from the exponential decay function;
mark the identified decision traces with a negative example classification indicating the decision traces represent reasoning patterns to avoid; and
retrieve decision traces from the negative example memory tier during generation of stimulants to identify reasoning patterns to avoid when generating responses to subsequent prompts.

38. The system of clause 5, further comprising an authority mode selector configured to determine whether a retrieved decision trace is applied in an advisory mode or an execution mode, wherein:
in advisory mode, the decision trace is presented to one or more of a human user, the AI model, or an automated system with an explanation of a reasoning recorded in the decision trace before incorporation into the response, and the one or more of the human user, the AI model, or the automated system provides confirmation or rejection of application of the decision trace; and
in execution mode, the decision trace is automatically incorporated into generation of the response without requiring human confirmation.

39. The system of clause 38, wherein the authority mode is determined based on one or more of:
an intent classification of the decision trace, wherein decision traces with a provisional or deprecated intent classification default to advisory mode;
a temporal confidence score of the decision trace, wherein decision traces with temporal confidence scores below a threshold default to advisory mode;
a risk level associated with the prompt, wherein prompts classified as high-risk default to advisory mode; or
a user preference specifying a default authority mode for decision trace application.

40. The system of clause 5, further comprising logic configured to:
receive input from a human user designating the decision trace as a ground truth decision trace;
store the ground truth decision trace with a corresponding ground truth designation in association with the decision trace;
exempt the decision trace from an exponential decay function and from a temporal confidence score degradation based on the ground truth designation; and
prioritize retrieval of the decision trace over non-ground-truth decision traces when the decision trace is relevant to a subsequent prompt.

41. The system of clause 5, wherein the decision trace further comprises contextual applicability metadata specifying one or more of:
a client identifier or client category for which the decision trace is applicable;
a regulatory regime or jurisdiction for which the decision trace is applicable;
a temporal validity window specifying dates during which the decision trace is applicable;
a transaction type or deal category for which the decision trace is applicable; or
an exclusion list specifying contexts in which the decision trace should not be applied,
   wherein the contextual applicability metadata is evaluated during retrieval to filter decision traces based on context of a current prompt.

42. The system of clause 5, further comprising logic configured to:
monitor outcomes associated with responses generated using the decision trace;
append outcome data to the decision trace, wherein the outcome data comprises one or more of: an outcome classification indicating success, failure, or partial success; an outcome timestamp; contextual metadata describing circumstances of the outcome; or a downstream consequence identifier linking the outcome to subsequent events;
aggregate outcome data across multiple instances in which the decision trace was applied; and
compute an outcome-weighted value score for the decision trace based on the aggregated outcome data, wherein the outcome-weighted value score modulates retrieval priority and application weight of the decision trace in subsequent prompt-response iterations.

43. The system of clause 42, further comprising logic configured to:
detect a pattern in the aggregated outcome data indicating a change in effectiveness of the decision trace over time;
generate an alert or recommendation in response to detecting the pattern, the alert or recommendation indicating one or more of: degradation of decision trace effectiveness, context-dependent variability in outcomes, or emergence of conditions under which the decision trace should not be applied; and
update one or more of an intent classification, a temporal confidence score, or a reinforcement status of the decision trace based on the detected pattern.

44. The system of clause 5, further comprising logic configured to:
compute a system confidence score indicating a reliability of the system in determining relevance of decision traces to a learning goal;
compare the system confidence score to a self-evaluation threshold; and
in response to the system confidence score exceeding the self-evaluation threshold, autonomously determine whether to promote or retain the decision trace without requiring confirmation from a human user.

45. The system of clause 5, further comprising logic configured to:
monitor performance of each agent in a plurality of agents across multiple prompt-response iterations;
compute an agent performance score for each agent based on outcomes associated with stimulants generated by the agent; and
   dynamically adjust an influence weight of each agent based on the agent performance score, the influence weight modulating a contribution of the agent to stimulant generation in subsequent prompt-response iterations.

46. A system, comprising:
an artificial intelligence (AI) model that receives a prompt, and is configured with a decision logic executed by a decision-logic runtime to generate a response to the prompt,
   wherein the decision logic is in a current state represented by a machine-readable state vector stored by the decision-logic runtime; and
an agent configured to generate a stimulant and further configured to apply the stimulant to the decision-logic runtime to transition the decision logic from the current state to a next state,
   wherein the stimulant comprises (i) a state-transition directive identifying at least one transition rule of the decision logic, and (ii) a scoring rubric specifying at least one measurable criterion for evaluating alignment of the response with a learning goal, and
   wherein the transition updates the state vector without updating parameters of the AI model,
   wherein the decision logic in its next state is used to generate the response to the prompt.

47. The system of clause 46, wherein the prompt comprises one or more of a user query, a system-generated query, a probing input, a context-adding input, or an adversarial input.

48. The system of clause 46, wherein a state of the decision logic comprises one or more of a rule, a condition, or a causal path identifying a reason the response was generated by the AI model, and wherein the state vector encodes at least one of: a selected strategy identifier, a constraint identifier, or a reasoning-path identifier.

49. The system of clause 48, further comprising a memory storing a plurality of decision logics, wherein each decision logic in the plurality of decision logics has a respective associated state vector and a respective set of transition rules executable by the decision-logic runtime.

50. The system of clause 46, further including logic to generate a decision trace identifying a strategy adopted by the AI model to generate the response, wherein the decision trace further comprises:
(i) a hash of the current state vector,
(ii) a hash of the next state vector, and
(iii) an identifier of the transition rule applied,
wherein the decision trace is stored as a tamper-evident record linked to at least one prior decision trace via a hash chain.

51. The system of clause 50, wherein the decision trace further comprises an associated emotional state inferred from a learning-goal gap determined using the scoring rubric, the associated emotional state comprising at least one of a positive state, an altered state, a neutral state, or a cautious state.

52. The system of clause 51, further including logic to increase storage duration for the decision trace when the decision trace comprises a positive associated emotional state and when the learning-goal gap satisfies a reinforcement threshold.

53. The system of clause 50, further including logic to apply an exponential decay function to the decision trace when the decision trace is not associated with a positive outcome under the scoring rubric, wherein decision traces not reinforced by positive outcomes are removed from memory over time.

54. The system of clause 50, wherein the decision trace comprises one or more referenced memory identifiers identifying prior decision traces consulted during generation of the response, enabling reconstruction of contextual lineage, and wherein the one or more referenced memory identifiers are validated against the hash chain.

55. The system of clause 50, wherein the decision trace comprises a cognitive strategy vector identifying the strategy applied by the decision-logic runtime to generate the response, the cognitive strategy vector including at least one of: a planning weight, an exploration weight, or a constraint-satisfaction weight.

56. The system of clause 50, wherein the decision trace comprises a causal chain linking the response to one or more prior decision operations that contributed to generation of the response, enabling reinforcement of effective early decisions when a positive outcome is delayed, wherein the causal chain includes at least one intermediate state hash for each prior decision operation.

57. The system of clause 50, further comprising:
a second AI model configured to generate a second response to the prompt based on a second decision logic executed by a second decision-logic runtime;
logic to generate a second decision trace identifying a second strategy adopted by the second AI model, the second decision trace including pre-state and post-state hashes; and
logic to compare the decision trace with the second decision trace to determine which of the response and the second response is more trustworthy,
wherein the comparison includes at least one of: (i) a consistency check of the scoring rubric outcomes, or (ii) a divergence check between state hashes under common transition rule identifiers.

58. The system of clause 46, wherein the agent is selected from a plurality of agents including one or more role-based agents configured to generate role-based stimulants that probe the decision logic from distinct reasoning perspectives, and one or more context-based agents configured to generate context-based stimulants that provide contextual information to the decision-logic runtime,
wherein each stimulant is generated in a typed format comprising the state-transition directive and the scoring rubric.

59. The system of clause 58, further comprising an orchestrator agent configured to coordinate the plurality of agents and to combine stimulants generated by the one or more role-based agents and the one or more context-based agents into an ordered stimulus plan for application to the decision-logic runtime,
wherein the ordered stimulus plan resolves conflicts between transition rules using the scoring rubric.

60. The system of clause 58, wherein the plurality of agents is configured to iteratively generate stimulants and apply the stimulants to the decision-logic runtime until a convergence condition is satisfied, the convergence condition based on one or more of a resource constraint, an iteration threshold, or a quality metric computed from the scoring rubric.

61. The system of clause 51, further comprising a temperature parameter that modulates behavior of the agent, wherein the temperature parameter is adjusted based on the associated emotional state and the learning-goal gap, and wherein a higher temperature parameter increases exploration in selection of transition rules and a lower temperature parameter enforces constraint-satisfaction in selection of transition rules.

62. The system of clause 49, wherein each decision logic in the plurality of decision logics is associated with a learning goal identifier, and wherein one or more decision logics, in the plurality of decision logics, associated with the learning goal identifier are retained in memory and one or more decision logics, in the plurality of decision logics, not associated with the learning goal identifier are subject to a decay function.

63. The system of clause 50, further comprising logic configured to:
reorganize decision traces stored in memory by grouping related decision traces based on emotional and thematic similarity; and
amplify decision traces that share emotional and thematic connections, thereby reinforcing effective cognitive pathways,
wherein amplification increases a retention weight used by the decay function.

64. The system of clause 50, further comprising a hierarchical memory storing decision traces in a plurality of memory tiers comprising:
a short-term memory storing decision traces from recent interactions;
a mid-term memory storing decision traces that have been boosted from the short-term memory based on relevance to a learning goal identifier or association with a positive outcome; and
a long-term memory storing decision traces that have been boosted from the mid-term memory, wherein decision traces progress from the short-term memory to the mid-term memory to the long-term memory based on reinforcement measured by the scoring rubric, and wherein decision traces not reinforced remain in the short-term memory and are subject to decay.

65. The system of clause 50, further comprising logic configured to periodically replay decision traces associated with positive outcomes, thereby strengthening cognitive pathways associated with the replayed decision traces,
wherein replay is performed in a non-output-producing evaluation mode that updates retention weights without emitting a user-visible response.

66. The system of clause 46, further configured with logic to receive an input from a human user and generate the stimulant in dependence upon the input from the human user, wherein the input from the human user selects at least one transition rule identifier or modifies at least one scoring-rubric criterion.

67. The system of clause 46, further comprising logic configured to build a dynamic profile of a human user's problem-solving approach based on interactions with the human user, wherein the dynamic profile comprises preferences over transition rule identifiers and strategy identifiers, and wherein the decision-logic runtime is adapted based on the dynamic profile to bias selection among transition rules without changing parameters of the AI model.

68. A system, comprising:
a memory storing a plurality of decision logics, each decision logic in the plurality of decision logics having a respective associated state vector and a respective set of transition rules;
an artificial intelligence (AI) model that receives a prompt, and is configured to generate a response to the prompt based on a decision logic executed by a decision-logic runtime;
an agent configured to generate a stimulant in dependence upon one or more prior decision traces and further configured to:
use the stimulant to identify a decision logic in the plurality of decision logics stored in the memory by matching at least one strategy identifier and at least one learning goal identifier; and
apply the stimulant to the identified decision logic via the decision-logic runtime to transition the identified decision logic from a current state to a next state,
wherein the stimulant comprises a state-transition directive and a scoring rubric,
wherein the identified decision logic in its next state is used to generate the response to the prompt.

69. The system of clause 68, wherein a prior decision trace in the one or more prior decision traces identifies a strategy adopted by the AI model to generate the response in a prior prompt-response iteration and wherein the prior decision trace further comprises a corresponding hash of a state vector of the decision logic.

70. system, comprising:
a memory storing a plurality of decision logics, each decision logic in the plurality of decision logics having a respective associated state vector and a respective set of transition rules;
an artificial intelligence (AI) model that receives a prompt, and is configured to generate a response to the prompt based on a decision logic executed by a decision-logic runtime;
an agent configured to generate a stimulant in dependence upon one or more prior decision traces and further configured to:
use the stimulant to identify a decision logic in the plurality of decision logics stored in the memory; and
apply the stimulant to the identified decision logic via the decision-logic runtime to transition the identified decision logic from a current state to a next state; and
logic configured to generate a decision trace identifying a strategy adopted by the decision-logic runtime to generate the response, wherein the decision trace comprises the next state as a hash of the next state vector and is stored in the memory as a hash-chained tamper-evident record, wherein the identified decision logic in its next state is used to generate the response to the prompt.

71. The system of clause 70, wherein a prior decision trace in the one or more prior decision traces identifies the strategy adopted by the AI model to generate the response in a prior prompt-response iteration and wherein the prior decision trace further comprises a corresponding hash of a state vector of the decision logic.

72. A system, comprising:
one or more processors;
one or more memories storing instructions that, when executed by the one or more processors, cause the system to provide:
an artificial intelligence (AI) model configured to receive a prompt and generate a response to the prompt;
a decision-logic runtime configured to execute a decision logic that controls generation of the response by the AI model, wherein the decision-logic runtime maintains the decision logic in a current state represented by a machine-readable state vector stored in the one or more memories;
a stimulant agent configured to generate a typed stimulant and to apply the typed stimulant to the decision-logic runtime to transition the decision logic from the current state to a next state,
   wherein the typed stimulant comprises:
   (i) a state-transition directive that identifies at least one transition rule identifier selectable from a rule set associated with the decision logic, and
   (ii) a scoring rubric specifying at least one measurable criterion for evaluating alignment of at least one of the response or an intermediate response with a learning goal identifier;
an evaluator configured to compute, using the scoring rubric, at least one rubric outcome value associated with the response; and
control logic configured to:
   (a) cause the decision-logic runtime to select or reject at least one candidate transition rule for transitioning the state vector based on the at least one rubric outcome value, and
   (b) cause the AI model to generate the response using the decision logic in the next state, wherein transitioning the decision logic updates the state vector without updating parameters of the AI model.

73. The system of clause 72, wherein the prompt comprises one or more of a user query, a system-generated query, a probing input, a context-adding input, or an adversarial input.

74. The system of clause 72, wherein the state vector encodes at least one of: (i) a selected strategy identifier, (ii) a constraint identifier, (iii) a reasoning-path identifier, or (iv) a safety policy identifier, each corresponding to a machine-executable control of the decision-logic runtime.

75. The system of clause 72, wherein the typed stimulant is validated against a schema defining permitted fields for the state-transition directive and the scoring rubric, and wherein the decision-logic runtime rejects the typed stimulant when schema validation fails.

76. The system of clause 72, wherein the decision-logic runtime comprises an execution layer that mediates application of the decision logic to at least one of: (i) selection of a strategy used to generate the response, (ii) selection of constraints applied during generation of the response, or (iii) selection of an external tool-call policy used during generation of the response.

77. The system of clause 72, further comprising a memory storing a plurality of decision logics, wherein each decision logic has (i) a respective associated state vector and (ii) a respective set of transition rules executable by the decision-logic runtime.

78. The system of clause 77, wherein the control logic is configured to select a particular decision logic from the plurality of decision logics based on matching at least one of: a learning goal identifier, a domain identifier, or a strategy identifier encoded in a current state vector.

79. The system of clause 72, further comprising trace logic configured to generate a decision trace for the response, wherein the decision trace comprises:
(i) a hash of a serialization of the current state vector,
(ii) a hash of a serialization of the next state vector,
(iii) the at least one transition rule identifier applied, and
(iv) at least one rubric outcome value computed using the scoring rubric.

80. The system of clause 79, wherein the decision trace is stored as a tamper-evident record linked to at least one prior decision trace by a hash chain.

81. The system of clause 80, wherein the decision trace further stores one or more referenced memory identifiers identifying prior decision traces consulted during generation of the response, and wherein the one or more referenced memory identifiers are validated against the hash chain.

82. The system of clause 79, wherein the decision trace comprises a cognitive strategy vector identifying a strategy applied by the decision-logic runtime, the cognitive strategy vector including at least one of: a planning weight, an exploration weight, or a constraint-satisfaction weight.

83. The system of clause 79, wherein the decision trace comprises a causal chain linking the response to one or more prior decision operations that contributed to generating the response, and wherein the causal chain includes at least one intermediate state hash corresponding to each prior decision operation.

84. The system of clause 72, wherein the evaluator is configured to determine a learning-goal gap using the scoring rubric, and wherein the system infers an associated emotional state from the learning-goal gap, the associated emotional state comprising at least one of: a positive state, an altered state, a neutral state, or a cautious state.

85. The system of clause 84, further comprising retention logic configured to increase a storage duration of at least one decision trace when (i) the associated emotional state is positive and (ii) the learning-goal gap satisfies a reinforcement threshold.

86. The system of clause 79, further comprising retention logic configured to apply an exponential decay function to decision traces not associated with a positive outcome under the scoring rubric, wherein decision traces not reinforced by positive outcomes are removed from memory over time.

87. The system of clause 84, further comprising a temperature control parameter that modulates behavior of the stimulant agent, wherein the temperature control parameter is adjusted based on the associated emotional state and the learning-goal gap, and wherein:
(a) increasing the temperature control parameter increases exploration in selecting transition rule identifiers, and
(b) decreasing the temperature control parameter increases constraint-satisfaction in selecting transition rule identifiers.

88. The system of clause 77, wherein each decision logic is associated with a learning goal identifier, and wherein the retention logic retains decision logics associated with a selected learning goal identifier and applies a decay function to decision logics not associated with the selected learning goal identifier.

89. The system of clause 79, further comprising organization logic configured to reorganize decision traces stored in memory by grouping related decision traces based on emotional similarity and thematic similarity derived from at least one rubric outcome value and at least one strategy identifier.

90. The system of clause 89, wherein the organization logic is configured to amplify decision traces that share emotional and thematic connections by increasing a retention weight used by the decay function.

91. The system of clause 79, further comprising a hierarchical memory that stores decision traces in a plurality of tiers including:
(a) a short-term tier storing decision traces from recent interactions,
(b) a mid-term tier storing decision traces boosted from the short-term tier based on relevance to a learning goal identifier or association with a positive outcome, and
(c) a long-term tier storing decision traces boosted from the mid-term tier, wherein progression across tiers is based on reinforcement measured by the scoring rubric.

92. The system of clause 91, further comprising replay logic configured to periodically replay decision traces associated with positive outcomes in a non-output-producing evaluation mode that updates retention weights without emitting a user-visible response.

93. The system of clause 92, wherein the stimulant agent is selected from a plurality of agents including:
(a) one or more role-based agents configured to generate role-based typed stimulants that probe the decision logic from distinct reasoning perspectives, and
(b) one or more context-based agents configured to generate context-based typed stimulants that provide contextual information to the decision-logic runtime,
wherein each typed stimulant includes the state-transition directive and the scoring rubric.

94. The system of clause 93, further comprising an orchestrator agent configured to combine typed stimulants from the plurality of agents into an ordered stimulus plan for application to the decision-logic runtime, wherein the ordered stimulus plan resolves conflicts among candidate transition rule identifiers using at least one rubric outcome value.

95. The system of clause 93, wherein the plurality of agents iteratively generates and applies typed stimulants until a convergence condition is satisfied, the convergence condition based on one or more of: (i) a resource constraint, (ii) an iteration threshold, or (iii) a quality metric computed from scoring-rubric outcomes.

96. The system of clause 72, further comprising user-interaction logic configured to receive an input from a human user and generate the typed stimulant in dependence upon the input from the human user, wherein the human user input selects at least one transition rule identifier or modifies at least one scoring-rubric criterion.

97. The system of clause 72, further comprising personalization logic configured to build a dynamic profile of a human user's problem-solving approach based on interactions with the human user, wherein the dynamic profile comprises preferences over transition rule identifiers and strategy identifiers, and wherein the decision-logic runtime is adapted based on the dynamic profile to bias selection among transition rule identifiers without changing parameters of the AI model.

What is claimed is:

1. A system, comprising:
an artificial intelligence (AI) model that receives a prompt, and is configured with a decision logic executed by a decision-logic runtime to generate a response to the prompt,
wherein the decision logic is in a current state represented by a machine-readable state vector stored by the decision-logic runtime; and
an agent configured to generate a stimulant and further configured to apply the stimulant to the decision-logic runtime to transition the decision logic from the current state to a next state,
wherein the stimulant comprises (i) a state-transition directive identifying at least one transition rule of the decision logic, and (ii) a scoring rubric specifying at least one measurable criterion for evaluating alignment of the response with a learning goal, and
wherein the transition updates the state vector without updating parameters of the AI model,
wherein the decision logic in its next state is used to generate the response to the prompt.

2. The system of claim 1, wherein the prompt comprises one or more of a user query, a system-generated query, a probing input, a context-adding input, or an adversarial input.

3. The system of claim 1, wherein a state of the decision logic comprises one or more of a rule, a condition, or a causal path identifying a reason the response was generated by the AI model, and wherein the state vector encodes at least one of: a selected strategy identifier, a constraint identifier, or a reasoning-path identifier.

4. The system of claim 3, further comprising a memory storing a plurality of decision logics, wherein each decision logic in the plurality of decision logics has a respective associated state vector and a respective set of transition rules executable by the decision-logic runtime.

5. The system of claim 1, further including logic to generate a decision trace identifying a strategy adopted by the AI model to generate the response, wherein the decision trace further comprises:
(i) a hash of the current state vector,
(ii) a hash of the next state vector, and
(iii) an identifier of the transition rule applied,
wherein the decision trace is stored as a tamper-evident record linked to at least one prior decision trace via a hash chain.

6. The system of claim 5, wherein the decision trace further comprises an associated emotional state inferred from a learning-goal gap determined using the scoring rubric, the associated emotional state comprising at least one of a positive state, an altered state, a neutral state, or a cautious state.

7. The system of claim 6, further including logic to increase storage duration for the decision trace when the decision trace comprises a positive associated emotional state and when the learning-goal gap satisfies a reinforcement threshold.

8. The system of claim 5, further including logic to apply an exponential decay function to the decision trace when the decision trace is not associated with a positive outcome under the scoring rubric, wherein decision traces not reinforced by positive outcomes are removed from memory over time.

9. The system of claim 5, wherein the decision trace comprises one or more referenced memory identifiers identifying prior decision traces consulted during generation of the response, enabling reconstruction of contextual lineage, and wherein the one or more referenced memory identifiers are validated against the hash chain.

10. The system of claim 5, wherein the decision trace comprises a cognitive strategy vector identifying the strategy applied by the decision-logic runtime to generate the response, the cognitive strategy vector including at least one of: a planning weight, an exploration weight, or a constraint-satisfaction weight.

11. The system of claim 5, wherein the decision trace comprises a causal chain linking the response to one or more prior decision operations that contributed to generation of the response, enabling reinforcement of effective early decisions when a positive outcome is delayed, wherein the causal chain includes at least one intermediate state hash for each prior decision operation.

12. The system of claim 5, further comprising:
a second AI model configured to generate a second response to the prompt based on a second decision logic executed by a second decision-logic runtime;
logic to generate a second decision trace identifying a second strategy adopted by the second AI model, the second decision trace including pre-state and post-state hashes; and
logic to compare the decision trace with the second decision trace to determine which of the response and the second response is more trustworthy,
wherein the comparison includes at least one of: (i) a consistency check of the scoring rubric outcomes, or (ii) a divergence check between state hashes under common transition rule identifiers.

13. The system of claim 1,
wherein the agent is selected from a plurality of agents including one or more role-based agents configured to generate role-based stimulants that probe the decision logic from distinct reasoning perspectives, and one or more context-based agents configured to generate context-based stimulants that provide contextual information to the decision-logic runtime, and
wherein each stimulant is generated in a typed format comprising the state-transition directive and the scoring rubric.

14. The system of claim 13, further comprising an orchestrator agent configured to coordinate the plurality of agents and to combine stimulants generated by the one or more role-based agents and the one or more context-based agents into an ordered stimulus plan for application to the decision-logic runtime,
wherein the ordered stimulus plan resolves conflicts between transition rules using the scoring rubric.

15. The system of claim 13, wherein the plurality of agents is configured to iteratively generate stimulants and apply the stimulants to the decision-logic runtime until a convergence condition is satisfied, the convergence condition based on one or more of a resource constraint, an iteration threshold, or a quality metric computed from the scoring rubric.

16. The system of claim 6, further comprising a temperature parameter that modulates behavior of the agent, wherein the temperature parameter is adjusted based on the associated emotional state and the learning-goal gap, and wherein a higher temperature parameter increases exploration in selection of transition rules and a lower temperature parameter enforces constraint-satisfaction in selection of transition rules.

17. The system of claim 4, wherein each decision logic in the plurality of decision logics is associated with a learning goal identifier, and wherein one or more decision logics, in the plurality of decision logics, associated with the learning goal identifier are retained in memory and one or more decision logics, in the plurality of decision logics, not associated with the learning goal identifier are subject to a decay function.

18. A computer-implemented method, including:
receiving, by an artificial intelligence (AI) model, a prompt,
wherein the AI model is configured with a decision logic executed by a decision-logic runtime to generate a response to the prompt, and
wherein the decision logic is in a current state represented by a machine-readable state vector stored by the decision-logic runtime;
generating, by an agent, a stimulant,
wherein the stimulant comprises (i) a state-transition directive identifying at least one transition rule of the decision logic, and (ii) a scoring rubric specifying at least one measurable criterion for evaluating alignment of the response with a learning goal;
applying, by the agent, the stimulant to the decision-logic runtime to transition the decision logic from the current state to a next state,
wherein the transition updates the state vector without updating parameters of the AI model; and
generating, by the AI model, the response to the prompt using the decision logic in its next state.

19. The method of claim 18, further including:
generating a decision trace identifying a strategy adopted by the AI model to generate the response, wherein the decision trace further comprises:
(i) a hash of the current state vector,
(ii) a hash of the next state vector, and
(iii) an identifier of the transition rule applied,
wherein the decision trace is stored as a tamper-evident record linked to at least one prior decision trace via a hash chain.

20. A system, comprising:
an artificial intelligence (AI) model that receives a prompt, and is configured with a decision logic to generate a response to the prompt,
wherein the decision logic is in a current state;
an agent configured to generate a stimulant and further configured to apply the stimulant to the decision logic to transition the decision logic from the current state to a next state,
wherein the decision logic in its next state is used to generate the response to the prompt.
